(19) United States
(12) Patent Application Publication
(10) Pub. No.: US 2019/0297126 A1
(43) Pub. Date: Sep. 26, 2019

(54) CONFERENCE FACILITATION METHOD AND APPARATUS

(71) Applicant: Steelcase Inc., Grand Rapids, MI (US)

(72) Inventors: Francis G. Graziano, Grand Rapids, MI (US); Mark T. Greiner, Caledonia, MI (US); Steven Douglas Miller, Caledonia, MI (US); Julie J. Barnhart-Hoffman, Grand Rapids, MI (US)

(21) Appl. No.: 16/441,789

(22) Filed: Jun. 14, 2019

Related U.S. Application Data
(63) Continuation of application No. 14/499,950, filed on Sep. 29, 2014, now abandoned.
(60) Provisional application No. 61/884,228, filed on Sep. 30, 2013.
(60) Provisional application No. 61/985,785, filed on Apr. 29, 2014.

(51) Int. Cl. H04L 29/06; G06F 16/955

(52) U.S. Cl. CPC H04L 65/403; G06F 16/955

(57) ABSTRACT

A system for providing guidance to collaboration participants in a collaboration space, the system comprising facilitator database storing characterizing rules for assessing conditions of a collaborative activity; a monitor associated with the collaboration space, the monitor configured to obtain information associated with the collaboration space that is indicative of conditions related to a collaborative activity performed within the collaborative space; a status device; and a processor linked to the facilitator database, the monitor and the status device, the processor programmed to perform the steps of: obtaining information from the monitor; accessing the characterizing rules; comparing the obtained information to the characterizing rules to assess conditions related to the collaborative activity; and based on the comparison, controlling the status device to indicate conditions of the collaborative activity.

### CROSS-REFERENCE TO RELATED APPLICATIONS

This application is a continuation of U.S. patent application Ser. No. 14/488,950, filed on Sep. 29, 2014, which claims priority to U.S. provisional patent application No. 61/985,785, filed on Apr. 29, 2014, and also claims priority to U.S. provisional patent application No. 61/884,228, filed on Sep. 30, 2013, all of which are incorporated herein by reference in their entirety.

### STATEMENT REGARDING FEDERALLY SPONSORED RESEARCH OR DEVELOPMENT

Not applicable.

### BACKGROUND OF THE INVENTION

The field of the invention is collaboration spaces and supporting systems, and more specifically a collaboration workspace and system designed to augment or enhance collaborative activities by automatically obtaining and analyzing information from a collaboration space to identify perceived conditions and, based on the perceived conditions, select a related activity designed to drive the collaborative activity forward or designed to augment or enhance the activity.

A conferencing industry has developed that provides spaces, products and services to companies or groups of people to help facilitate collaborative activities. Regarding conferencing spaces, people have been gathering in large spaces for thousands of years to facilitate collaboration. In the past few hundred years most conference spaces have taken the form of a space defined by privacy walls of some type and including comfortable chairs arranged around one or more conference tables. More recently projectors and large display screens have been added to some conference spaces so that conferees in the space can share information with each other. Specialized presentation software such as Power Point by Microsoft, Excel by Microsoft, and others, have been developed and systems that enable conferees to share their computer desktops so that application output can be shared via common display screens has also been developed. Also, recently, teleconferencing capabilities have been added to or built in to conference spaces that enable local and remote conferees to communicate with each other as if all conferees were in the same location.

Regarding services, anyone that has participated in several collaborative activities with different groups of people can likely attest to the fact that there are different ways to facilitate collaborative activities and that not all ways are equally advantageous. In many cases no member of a collaborative group has had any experience leading a collaborative effort and therefore the group often times muddles through a poor process in an uncertain fashion to yield less than optimal results. Even in cases where one or more conferees on a team have had some experience leading or participating in collaborative activities in the past, in many cases the experience may not be based on known best practices so that the guidance brought to an activity by such a conferee may have an adverse effect on the overall activity and final work product. Moreover, even if a conferee understands best practices for one type of activity (e.g., new product design), those practices may not be best and in fact may be unsuitable for other types of collaborative activities (e.g., development of next year's business plan for an international company). Furthermore, in many cases space and related artifacts used to facilitate a conference are not supportive of specific collaborative activities to be performed in the space. For instance, while a space and related artifacts may be optimized for teleconferencing, the space may not be optimized for other activities such as sharing content among local conferees in an egalitarian fashion during a brainstorming session.

In these cases, often times the results of a collaborative process will be unsatisfactory. For instance, in many of these cases, a collaborative process will consume far more time than required to generate work product. In addition, in many of these cases, conferees will move through a collaborative process with an uncertain feeling about whether or not they are doing the right things to achieve optimized work product, one or more conferees will not fully buy into the work product generated at the end of the activity and/or one or more of the conferees will not feel good about the overall collaborative process. Moreover and perhaps most importantly, in many of these cases the resulting work product will not be as good as the team was capable of generating if best practices had been followed. Even if a work product result occurs, a conferee that does not feel good about the overall process used to achieve the work product may question whether or not a better result could have been obtained with a better process.

To meet collaboration needs of organizations such as efficiently identifying and exploiting disruptive innovations, collaboration experts have developed collaboration processes, systems and materials that can be tailored to different types of collaboration activities. Here, for instance, a new product design process may include four sub-processes including (1) initial idea creation, (2) interpreting and evaluating ideas, (3) experimenting/consensus building and (4) formalization of the ideas (a plan for exploiting the ideas). At the end of each of these sub-processes, a work product will be generated that is used to drive the next consecutive sub-process. Each of these sub-processes may include another set of sub-processes and intermediate work product that drives a next sub-process. An expert participates in a collaborative activity with other team members to methodically move the collaboration process along through the different sub-processes to yield quality intermediate and final work product.

When a collaborating team has an impasse at some point or has difficulty moving forward through one of the sub-processes, the expert can bring tools to bear to move through the impasse or difficulty. For instance, the expert may be able to change up the sub-process flow and move in a different direction to generate required work product. For example, in response to an impasse, the expert may dynamically break a large team into smaller groups to think out different solutions to a problem. Then, when the group is brought together again, the relatively more developed different solutions may be easier to compare. As another instance, the expert may simply call for a break in the activity and facilitate a mental or physical game to change up the pace of the team effort prior to continuing working through the impasse.

The general idea here is that best practices have been developed for different types of collaborative activities where specific types of work product are generated during intermediate sub-processes and experts have been trained to understand the sub-processes and associated work product related thereto and in techniques for working through team difficulties so that collaborative activity metrics (e.g., speed with which an activity is completed, quality of final activity work product, quality of conferee experience during the activity, buy in of conferees in the generated work product, buy in of conferees in the overall collaborative process, repeatability of the process to facilitate other collaborative activities, etc.) can be improved.

In addition to understanding collaborative activity best practices, collaboration experts also often bring to bear proven collaboration tools. For example, many experts use paper flip charts to manually capture ideas and concepts considered by conferees during a collaborative session and to capture intermediate and final work product generated during the activities. In many cases, as content is developed, pages of a flip chart are ripped off and posted about a conference space so that all conferees have the ability to observe the current state of content development. As another example, some experts use projectors or large electronic display screens to generate and capture collaboration content.

As still one other example, some experts use activity templates that define a detailed collaborative process including sub-processes and sub-processes of the sub-processes as well as work product goals for each of the sub-processes, target timelines for the sub-processes and various tools for working through stalled activities.

While activities where experts personally participate in collaboration have many advantages, relying on in person expert participation in activities has several shortcomings. First, collaboration experts are typically highly educated and only become experts through years of experience and therefore, having an in person collaborative expert participate in an activity is typically too expensive for most activities. For this reason, expert participation in collaborative activities usually is only brought to bear in particularly strategic or critical activities if at all.

Second, while most experts have their favorite ways of using collaboration tools like flip charts, projectors and common display screens, experiments have shown that conference space artifacts (e.g., screens, conference tables, seating, etc.) can be arranged differently in ways that most experts have not contemplated where the different arrangements can optimally foster the different sub-processes performed during an overall activity. For instance, a simple example of artifact rearrangement to foster different types of activities can be understood by considering a first activity where twelve conferees work in a large group during a first sub-process and a second activity where the twelve conferees break out into three groups of four to delve into different topics during a second sub-process. Here, during the large group activity, three sub-tables may be arranged to form a contiguous single work surface in the center of a conference space and during the breakout session, the three tables may be moved to separate locations in the space to support the three different small groups.

Similarly, during large group activities three portable, large and common electronic display screens may be optimally arranged adjacent each other and facing conferees along one wall of the space and during a breakout activity the three screens may optimally be moved to other locations in the space adjacent the three sub-tables for use by the three groups. While this example is simple, there are many other examples of space artifacts that can be arranged differently than the way in which such artifacts are typically fixed in a conference space where the other arrangements optimally drive different sub-processes of an activity. Most experts are unfamiliar with the ways in which space artifact arrangements can drive processes and therefore this knowledge is never brought to bear. In addition, even if an expert were inclined to rearrange artifacts optimally to support different activities in a space, in most cases space artifacts are fixed in place within a conference space. Even where an artifact is moveable, movement is severely complicated by the need for power and data cables linked to artifacts and locations of power and data receptacles in a conference space. For instance, even a large flat panel display screen on a cart typically requires power and data cable connections to receptacles.

Third, best practices change over time and in many cases experts may be either unfamiliar with current thinking or unwilling to adopt to new practices because of an established comfort level with old practices. Obviously if best practices are not adopted, collaboration metrics suffer.

Fourth, because of the large degree of knowledge required to perform the expert role in collaborative activities and the relatively small market for such services due to associated current costs (e.g., the current market typically includes only extremely important projects for extremely large and profitable business entities), there are only a small number of truly qualified collaboration experts. For this reason, often times expert participation has to be scheduled weeks in advance.

Fifth, while a collaboration expert is particularly valuable during some session activities, at many other times expertise is not needed or adds no value. For instance, there are long periods during most collaborative processes during which team conferees simply need to engage in verbal banter to vet ideas and build consensus around intermediate or end work product. Expert compensation is typically by the day or hour and not based on when the expert actually adds value during some period and therefore, in many cases, entities pay for expert participation for long period when in fact the expertise is only brought to bear during short periods of time.

Sixth, as conferees gain more experience working in and observing leadership in collaborative activities, the conferees get better at facilitating at least portions (e.g., sub-processes) of the activities so that the role of the expert becomes less needed. Unfortunately, in most cases, there is no way to assess conferee collaboration skill sets or leadership ability prior to participation in an activity. Similarly, while a conferee may be qualified and willing to drive one of a subset of activity sub-processes, the conferee may not be qualified or willing to drive another and there is no way to gauge qualification or willingness prior to participation in an activity. For this reason, there is no way to determine when, during a collaboration session, an expert will be needed and when a team could do without expert participation. Where a conference leader lacks the right skills to facilitate an activity, the mere act of leading an activity tends to spread wrong practices within an organization thereby exacerbating the problems associated with leaders that are not properly trained in collaborative processes (i.e., wrong practices tend to spread within organizations if not corrected).

### BRIEF SUMMARY OF THE INVENTION

It has been recognized that information can be obtained from monitors located within a conference or collaboration space that can be used to automatically identify perceived conditions within the space that in turn can be used to identify related activities to be performed to drive collaboration within the space. The related activities can, at least in part, facilitate best collaborative practices.

For instance, in a case where a session includes four sub-processes, a general rule may be that an introduction to each of the four sub-processes should be performed to help a collaborating team transition from one sub-process to the next. Here, each sub-process may generate a required set of work product and the information collected from a space may be analyzed to automatically assess when the work product has been completed or will be completed in the near future for a sub-process. Once work product for a sub-process has been completed (e.g., once a specific condition has been perceived), the system may automatically present information to the team to introduce the next consecutive sub-process. For example, the system may confirm that the generated work product fulfills the requirements of the first sub-process and also may provide a video and audio presentation via large display screens in a conference space summarizing prior sub-processes and resulting work product and describing the next sub-process including steps in the sub-process, required work product to be generated via the next sub-process, optimized arrangement of space artifacts (e.g., tables, screens, etc.) to facilitate the next sub-process, etc.

As another instance, when the system recognizes that a sub-process is nearing completion, the activity related to the perceived condition may be to indicate to a remote human facilitator that transition to a next sub-process is going to occur in the next few minutes. The indication to the human facilitator may take the form of a simple indication causing the facilitator to patch in for a short telepresence conference where the facilitator can confirm the work product developed and can introduce the next sub-process to the team via the telepresence system.

In other cases the indication to the facilitator may take the form of a session summary and may be provided to the facilitator prior to the end of the sub-process to enable the facilitator to consider the current state of the session and whether or not the sub-process work product or the sub-process itself was flawed in some way. Here, the summary may include any of the information from the session including audio, video, information stored during the session as work product, information related to movement of conferees and/or artifacts within a conference space, information or data derived from any of the information monitored within the space, etc. For instance, information derived from the monitored information may include some gauge of conferee participation to indicate how much each or all conferees participated in a sub-process (e.g. did one conferee drive the sub-process or did each conferee contribute a generally equal amount).

In the above example, if a facilitator (e.g., an automated system or a remote human expert) perceives some flaw in the process or in the resulting work product, the facilitator may take some action designed to address the flaw. For instance, the facilitator may cause an instructional video to be played in the conference space that is designed to address the flaw. As another instance, the facilitator may patch into the session via video/audio and discuss the flaw and how to address the flaw. Many other related activities are contemplated.

In more complex systems information monitored within a conference space can be monitored at all times to identify any of several interesting conditions for which related activities can be performed. For example, in a case where a session sub-process is scheduled to end at a specific time and no work product for the sub-process has been stored for the sub-process near the end of the scheduled time, the system may perceive a likely impasse or delay in the sub-process. Here, a related activity to address the impasse may take any of several different forms including, for example, playing a video designed to address the specific perceived condition, sending encouraging or guiding text messages to conferee devices (e.g., smart phones, tablet computers, etc.) within the space, indicating the condition to a remote human facilitator with or without a summary of the current state of the session, etc. Thus, any perceived condition that may require or benefit from some type of either automatic or human expert (e.g., facilitator) based intervention may be defined, monitored and operate as the catalyst for related activities designed to drive an overall collaborative session or to augment or enhance the session.

In some cases the monitored information in a conference room may be completely automatic and conferees may be unaware that any information is being collected. For instance, video and audio may be obtained in a conference room without any conferees being aware. Content added to or shared on large common electronic display screens in a conference space of conferees or space artifacts may be monitored without conferees being aware. Movement or presence within a conference space may be monitored without conferees being aware.

In other cases monitored information may include input from conferees. For instance, instead of or in addition to monitoring information in a space and analyzing that information in an attempt to perceive interesting conditions, the system may provide tools that allow conferees to indicate interesting conditions. For example, an interface on a large common display screen in a conference space may enable one or any conferee to indicate that a current sub-process will be completed in the next 30 minutes. This indicated condition may cause a related activity to be performed such as providing an indication to a remote facilitator in any form, queuing up a video to introduce a next sub-process, etc.

As another example, the system may enable conferees to provide feedback via personal portable devices like laptops, cell or smart phones, pad or tablet type devices, etc. within a conference space regarding conferee perceptions of how well a session is progressing. Where a consensus is that a session is progressing well, the system may not initiate any related activity, even if other monitored information is perceived to indicate an impasse or other interesting condition. Where the consensus indicates some problem, the system may initiate a suitable related activity to address the problem. Where the consensus is that the session is progressing well but one or a small sub-set of conferees indicates concern, the system may present the results to a human facilitator who can field questions from the concerned conferees in private via the conferee's personal device as a related activity. To this end, the system may accept questions posed using a personal device and present those questions to a facilitator.

In at least some cases all information collected in a space and all intervention activities that occur will be stored or memorialized in an archive database or conference file for subsequent use. For instance, the archived information may be used to generate summary reports for a human facilitator to consider prior to or during an intervention. As another instance, the archived information may be used by process engineers to review and identify ways to modify session sub-processes or to create new sub-processes that are better than existing processes. Here, new revelations may be used to generate new characterizing rules for perceiving existing or new interesting conditions based on information automatically collected from a conference space. Stored information for several independent collaborative activities or similar sub-processes may be analyzed to identify what happened when an activity or sub-process when exceedingly well and when progress in an activity or sub-process was slow or less than expected and that information may be used to modify sub-processes or activities altogether.

In at least some cases a server or system computer may itself be programmed to automatically adapt and learn from the ways in which teams use a collaboration system/space. For instance, an initial rule may be that there needs to be at least a version of stored work product within two hours of the end of a specific sub-process or else an off schedule condition may be perceived and initiate a related activity to move the process along. Here, even with prodding, it may be that teams routinely first store a version of work product during the sub-period during the last thirty minutes of scheduled time. In this case, over time the system may learn what is routine and may adjust the time in which work product is expected from the last two hours to the last 30 minutes of the sub-process.

As another example, after a video is played in a conference space that is designed to help a team work through a perceived impasse, the system may seek feedback on the value of the video from the conferees via personal devices or some other feedback system. Here, where the response to a video is routinely negative, the system may automatically discontinue playing the video when the condition is sensed or may automatically opt to play a different video designed to address the same condition. Where a video is routinely negatively received, an indication of that condition may be presented to a facilitator for further consideration.

As still one other example, there may be two or more activities deemed suitable for driving through a specific interesting condition or enhancing or augmenting a sub-process. A system server may be programmed to alternate between the suitable activities when the specific condition occurs during different collaboration sessions and may collect metrics to access which of the two or more activities yields the best results. One or more of the metrics may be automatically collected (e.g., time required to drive through the condition) while other metrics may obtain conference input (e.g., responses to queries about the value or effectiveness of the activity). Over time, the system may be programmed to select only activities that have the best overall results/metrics when the particular interesting condition occurs.

In other cases, instead of automatically adapting, the system may present a suggested change to a facilitation expert or a system administrator and require the expert or administrator to authorize a change in conditions monitored and/or related activities performed. Other automated learning aspects are contemplated.

In some cases it is contemplated that when a human expert operates as a remote session facilitator on a periodic basis, the same expert would be used in the session over the course of the session to maintain continuity. Here, the system may be programmed to, when an interesting condition in a session is perceived, assess availability of an expert previously associated with the session and add an intervention to the expert's schedule if the expert is available within a reasonable time. Where the condition is acute, the system may automatically modify previously scheduled interventions on the expert's schedule to move the acute condition up in the expert's schedule queue. In other cases where a condition is interesting but not yet acute, the system may simply schedule some time for the expert to review the condition in a time slot that is currently available for the expert. Where an expert is busy but a condition is acute, a second expert may be notified so that the second expert can assess the condition and determine how to respond.

In other cases human facilitators may develop expertise in specific sub-processes of specific types of collaborative activities and the system may be programmed to link different experts to a single session at different times to drive the session or to enhance or augment the session. For instance, a first expert may be particularly adept at getting conferees to relax by playing a mind game or getting up and actually moving about during some physical activity. Here, if a sub-process gets stale and a second expert reviewing collected information related to the sub-process determines that a game or physical activity would be advantageous, the second expert may link in the first expert to facilitate the game or physical activity. As another instance, where a session has four main sub-processes, there may be four separate experts that have different skill sets that are optimized for different ones of the sub-processes. Here, when one sub-process stalls for some reason, the expert in that sub-process may be linked in to resolve any problems.

Intervention in a session may be automated and carried out by a system server running a software program. For instance, intervention may include playing a suitable video designed to drive through a perceived interesting condition. Intervention may include instructing a team to play a game designed to change up the pace of activity in the space. Automatic intervention may include automatically seeking private feedback from one or more conferees via personal devices to confirm or deny a perceived impasse or other perceived problem. Where the perceived problem is confirmed, automatic intervention may then include playing a suitable video or the like.

Intervention in a session may be manual and initiated by a human facilitator upon analyzing information obtained from a space. For instance, when an impasse is perceived by a server based on analysis of information monitored within a space, the server may create a summary report that is automatically presented to a facilitator for consideration. The report may include recent video of a conference, prior video of a conference during prior impasses, data regarding the pace of work product or other information development, data derived from information obtained from the space, etc. After analyzing the report, the facilitator may manually patch into a session via video or the like to drive the session or may initiate some other suitable activity.

In at least some embodiments, after the system perceives a specific condition, the system may identify a set of related activities, each related activity designed to drive past the specific condition. Here, in addition to identifying suitable related activities, the system may be programmed to provide the set of related activities to a facilitator along with information about past and current status of the session. After considering session status information, the facilitator may then either select one of the presented suitable related activities, may initiate a different related activity or may choose to do nothing if the facilitator recognizes that the perceived condition is inaccurate or does not need to be addressed for some reason.

When a facilitator opts to either do nothing when an interesting condition is perceived or to initiate an activity other than the activity that is suggested by the system to deal with a perceived condition, the system may automatically recognize the deviation from an expected action and may either immediately or over time as a trend develops, change either one or more characterizing rules or change one or more related activities. Thus, the system may learn by how one or more experts react to interesting conditions and generate new rules and related activities that mimic the expert's activities.

In at least some cases activities related to perceived conditions may include providing directions for conferees to change relative juxtapositions between conference space artifacts in ways that are determined to enhance different session sub-processes. In this regard, empirical data is currently being developed that supports the fact that optimal artifact arrangements in a conference space are different during different sub-processes of an overall collaborative session. Optimal arrangements can be codified in related activities associated with perceived conditions and can result in directions to conferees to move artifacts as a function of perceived conditions.

In at least some cases best practices may be codified in characterizing rule sets and related activities. Here a characterizing rule is a data construct that associates different combinations of session characteristics (e.g., monitored or sensed information in space) with specific perceivable conditions. A related activity is an activity that is to be performed once an associated condition is perceived. For example, a simple combination of session characteristics may be that final work product for a sub-process has been stored. An associated condition may be that the sub-process is about the end. An activity related to the perceived condition may be that a session summary report be generated and automatically presented to a remote facilitator for consideration. Many other characteristic combinations, conditions and related activities are contemplated.

In at least some cases the system may be programmed to provide feedback to specific conferees based on how a session is progressing. For instance, in cases where conferees have personal electronic devices such as tablets, smart phones, or the like in a conference space, the system may provide praise, encouragement or direction to one or more of the conferees in a private communication via the personal devices. For example, the system may prod a conferee to speak up via a text message or other electronic communication if the conferee has not verbally participated in the session for some time. As another example, where one conferee has monopolized verbal input in a session over a recent period, the system may provide a private text message to the conferee asking the conferee to at least think about now to get others more actively involved in the session. Here, the text may even provide one or more suggestions based on recent activities in the session. For instance, where a first conferee shared a list with others on a common display screen and then a second conferee took over the session to discuss the list, the system may suggest that the second conferee seek some input from the first conferee.

In some cases the system may be programmed to seek, obtain and analyze feedback from conferees, either publically or privately, at different times during a session. For instance, at the end of a session sub-process, the system may transmit one or more queries to each conferee's personal device to determine level of conferee satisfaction with the sub-process activities, the sub-process work product, other conferees in the session, etc. This information may be stored for subsequent use to either tweak subsequent sub-processes during the session or to tweak or modify subsequent processes in other sessions. For instance, where most session conferees express disapproval of a second of four sub-processes during a session, the system may be tuned to bring in a human expert more quickly during subsequent sub-processes in the session in an effort to increase conferee satisfaction. As another instance, if satisfaction with work product at the end of a sub-process is below some low threshold, the system may immediately patch in a remote facilitator to review the work product and the sub-process and to address any issues that may negatively affect buy in to the work product by the conferees.

In some embodiments the system may be programmed to assess performance of session conferees as a group and/or individually during a session and/or during separate session sub-processes to help an organization better assemble session teams in the future. For instance, where sensed session information analysis indicates that a first conferee participated fully and worked well with others during a session, the system may give the first conferee high marks for her efforts when compared to a second conferee that did not appear to participate much or that did not appear to work well with others. As another instance, where session information analysis indicates that a session team generally worked well together and where conferee satisfaction is high, the system may store high marks for the team as a while. Using the grading information, an organization may assemble teams that generally work well together. For instance, one rule of thumb may be that teams need at least two conferees that participate fully and work well with others and at least one conferee that, while participating fully, may not work well with others. Here, the conferee that does not work well together may be included to sort of stir the pot a bit with other team members if it is determined that better work product results from such a dynamic.

It should be appreciated that each of the above described systems will have one or more advantages over existing systems. First, each of the above systems should at least reduce the amount of dedicated expert facilitator time required to drive a collaborative session. In fact, in automated systems a facilitator may not be needed at all.

Second, in many cases even a partially automated system will be able to automatically select and initiate related activities based on perceived conditions and therefore will be able to drive through perceived conditions without requiring facilitator time. For this reason, the costs associated with driving an overall collaboration session may be substantially reduced. Where cost of driving sessions is reduced, best practice collaboration sessions can be applied to more collaborative activities (e.g., relatively smaller activities or activities facilitated by smaller entities).

Third, new best practices can be codified in characteristic rules and related activities to increase the complexity of the system to whatever level a system designer chooses. In fact, in some cases, the system may be programmed to recognize new interesting conditions, associated characteristic combinations and related activities and to automatically codify related or associated information. In addition to the system automatically recognizing interesting conditions, characteristic combinations and related activities, a remote human facilitator may recognize conditions and characteristics and codify related activities.

Fourth, organization employees that use the inventive systems will be trained over time in best collaboration practices. Not only should this training increase the speed with which employees can work through collaborative activities, but the training should also increase the confidence of conferees in the process and the value of the ultimate work product and hence buy in to the work product from all team conferees. The value of final work product is substantially augmented when conferees buy into the end results and take ownership thereof.

Fifth, in some cases the system may be programmed to grade conferees and teams or to generate session characterizing information that can be used to assess conferees or teams. The grades or information may be useful to organizations subsequently when forming other teams for other purposes. For instance, an organization may want at least two great communicators on each team as well as at least one member that always tends to think out of the box and question other people's ideas and solutions to problems (e.g., an “obfuscator”). Grades and session information may be useful in identifying organization employee characteristics of this type.

Sixth, in cases where collaboration space artifacts can be rearranged, the system can be programmed to, in effect, codify different artifact arrangements for different session sub-processes and may provide guidance to conferees on how best to arrange the artifacts to complete the sub-process. Artifact rearrangement is something most collaboration experts often have not given much thought to and yet cleat benefits can be attributed to positioning artifacts in optimized arrangements based on what a session team is attempting to accomplish during session sub-processes. Here, for instance, when the system senses the end of a sub-process and that a next sub-process is about to commence, the system may instruct conferees to rearrange artifacts in an arrangement optimized for the nest sub-process.

Seventh, as best practices change over time, practices facilitated at least in part by a remote expert or by an automated system can be modified to reflect the changes. For instance, if a particular artifact arrangement is recognized as optimal for a sub-process, the arrangement may be codified in related activities so the system can give direction to conferees when progressing from one sub-process to a next.

Eighth, in at least some embodiments a system may learn and dynamically adapt over time to how session teams respond to best practices and related results. For instance, in at least some cases when a best practice is suggested to a team, if the team either ignores the best practice of opts for a different course of action, the system may monitor results associated with the different course of action. Where the results are acceptable or even optimal, the system may automatically adapt so that the system encourages future sessions teams to follow the course of action selected by prior teams. This adaptation process may be gradual and only occur after a trend toward a different course of action emerges. In some cases the system may identify a different course of action from team choices and present that course as an option to a collaboration expert prior to adopting the course as a viable option for subsequent teams. In some cases the system may present two or more options to conferees for advancing a session and allow the conferees to select one of the options. In this case the system may monitor results as different teams select different options and may automatically compare the results to identify any best option from the choices. Here, if a best option emerges, the system may automatically adopt and steer future teams toward the best option from the choices.

Ninth, in addition to providing periodic guidance when session progress stalls, in at least some cases the system may push information to a session team to effectively lead a session. For instance, once a specific session type is selected (e.g. new product development, review of quarterly financials, etc.), the system may provide a framework in which a team will work including short videos related to each of four separate sub-processes, specific goals for each sub-process, target durations for each sub-process, a specification for arrangement of work product within a space during each sub-process (e.g., content currently focused on may be automatically moved to a central common display while other content that is not currently focused on (e.g., prior sub-process work product) may be moved to common side displays)), etc. Here, for example, between sub-processes the system may automatically provide a video recapping prior sub-processes and generated work product and introducing the next sub-process (e.g., indicating duration of next sub-process, goals, target end work product and general techniques used to achieve the goals and generate the work product). As another example, where a prior sub-process generated a list of five sub-topics to be addressed during a next sub-process, the system may automatically present each of the five sub-topics on a central common display screen separately and consecutively to focus a team and then help the team develop the sub-topics in detail. Once a sub-topic is developed the system may move the sub-topic and related work product to a side display and bring up the next sub-topic, remind the team of a target end time for the sub-process and start leading the team down the path of developing the next sub-topic. Thus, instead of allowing a team to work as they see fit and then suggesting ways to work through perceived problems, the system may provide some lead at the front end.

Tenth, in addition to providing a lead in some cases and providing guidance in other cases, in at least some embodiments the system may also play an augmenting or enhancing role as a sort of additional team member. For instance, in at least some cases the system may obtain various types of information from within a conference space and use that information to identify perceived key or important topics in a session. Once a key topic is perceived, the system may automatically search the internet, an organization intranet or other databases (e.g., an organizations LAN, WAN, an organizations central document bank, etc.) for information related to the key topic and may present any identified related information to the team. In some cases the related information may be indicated by a simple related information icon on one of the common displays in a conference space for selection to access the information. In other cases the related information may be automatically presented on one of the common displays (e.g., a side display) for consideration by the team. In still other cases the related information may be presented in a summary form (e.g., titles of articles from the internet) on a common display for consideration. In some embodiments, instead of presenting the related information via a common display, the additional information may be presented or indicated on one or more personal computing devices (e.g., laptops, tablets, smart phones, etc., used by conferees in the space) for consideration prior to presentation to the team on a common display.

Some embodiments include a system for providing guidance to collaboration participants in a collaboration space, the system comprising a facilitator database storing characterizing rules for assessing conditions of a collaborative activity, a monitor associated with the collaboration space, the monitor configured to obtain information associated with the collaboration space that is indicative of conditions related to a collaborative activity performed within the collaborative space, a status device and a processor linked to the facilitator database, the monitor and the status device, the processor programmed to perform the steps of obtaining information from the monitor, accessing the characterizing rules, comparing the obtained information to the characterizing rules to assess conditions related to the collaborative activity and based on the comparison, controlling the status device to indicate conditions of the collaborative activity.

In some cases a collaborative activity includes a sequence of sub-processes and wherein the characterizing rules relate to time periods required to complete the sub-processes, the monitor obtaining information related to completion of the sub-processes. In some cases the processor operates a timer and uses time, the characterizing rules and the obtained information to assess conditions. In some cases at least one display screen is located within the collaboration space, the processor programmed to query when sub-processes are completed and presenting a selectable field on the display screen for receiving an indication from the collaboration participants indicating completion of sub-processes. In some cases collaborative activity results in generation of digital content and wherein the characterizing rules relate to the quantity of digital content generated during the collaborative activity.

In some cases at least one display screen is located within the collaboration space for developing digital content related to the collaborative activity, the monitor monitoring content presented via the display screen. In some cases collaborative activity results in verbal communication within the conference space and wherein the characterizing rules relate to the quantity of verbal communication generated during the collaborative activity. In some cases the collaborative activity includes a sequence of sub-processes, at least a subset of the sub-processes resulting in deliverable digital content storable in files of a collaborative activity folder, the monitor tracking information in the files to assess status of the collaborative activity.

In some cases the status device includes a display screen located in the conference space. In some cases the processor indicates conditions via the display by providing a message to speed up the activity upon a determination that the activity progress has been slower than optimal. In some cases the facilitator database also stores a plurality of collaboration specifications designed to guide the collaborative activity at different points along a collaborative process, the processor further programmed to present collaboration specifications information at different times during the collaborative activity to direct activity progress.

In some cases at least one of the facilitation content subsets is designed to be presented upon the occurrence of a specific problem condition assessed by the processor. In some cases the status device is located at a site remote from the collaboration space. In some cases the status device is a computer interface used by a collaboration facilitator. In some cases the processor controls the status device by presenting a summary report of the collaboration process via the computer interface for consideration by the facilitator.

In some cases the processor gathers the information obtained from the monitor and periodically generates the summary report of the collaboration process. The system of claim 15 further including at least one camera and at least one microphone located in the collaboration space and enabling the facilitator to observe and listen to the collaboration activity. In some cases the processor stores video and audio of the collaboration activity and wherein the facilitator observes and listens to stored collaboration activity. In some cases n the facilitator observes and listens to the stored collaborative activity substantially in real time.

Some embodiments include a feedback device located within the collaboration space that enables the facilitator to communicate with collaboration participants within the collaboration space. Some embodiments include a computer interface enabling at least one of the collaboration participants to request help from a remote facilitator. In some cases the status device is a computer interface used by a collaboration facilitator. In some cases the collaborative activity includes sub-processes and wherein the processor uses the information obtained from the monitor to assess transition times between consecutive sub-processes, the processor indicating condition of the collaborative activity by indicating a coming transition time to the collaboration facilitator via the computer interface.

In some cases the processor further stores monitored information in a conference file, the processor indicating status by presenting the at least a subset of the information in the conference file to the collaboration facilitator. In some cases the at least a subset of the information in the conference file is presented to the collaboration facilitator prior to a transition time. In some cases the collaboration facilitator can access the at least a subset of the information in the conference file at any time during the collaborative activity.

In some cases the collaboration space is a first collaboration space and the monitor associated with the first collaboration space is a first monitor, the system further including a plurality of other collaboration spaces and separate monitors associated with each of the other collaboration spaces, the processor obtaining information from each of the monitors, comparing the obtained information to the characterizing rules to assess conditions related to collaborative activities in each of the collaboration spaces and, based on the comparison, controlling the status device to indicate conditions of each of the collaborative activities.

In some cases the processor compares the conditions of the collaborative activities and ranks progress of the activities relative to each other, the processor indicating conditions by indicating relative acuteness of each condition. In some cases the monitor obtains information automatically. In some cases the status device includes a display screen and wherein the step of controlling the status device includes providing an indication via the display screen. In some cases at least one display screen is provided within the collaboration space on which the collaboration participants present information during a collaborative activity and wherein the monitor monitors information on the display screen to obtain information from the space. In some cases a plurality of furniture artifacts are located within the collaboration space and wherein the processor indicates the condition by providing instructions to rearrange the furniture artifacts within the collaboration space.

Some embodiments include a system for providing guidance to collaboration participants in a collaboration space, the system comprising a facilitator database storing characterizing rules for assessing conditions of a collaborative activity, a monitor associated with the collaboration space, the monitor configured to obtain information associated with the collaboration space that is indicative of conditions related to a collaborative activity performed within the collaborative space, at least one display screen supported within the collaboration space and a processor linked to the facilitator database, the monitor and the at least one display screen, the processor programmed to perform the steps of obtaining information from the monitor, accessing the characterizing rules, comparing the obtained information to the characterizing rules to assess conditions related to the collaborative activity and based on the comparison, driving the at least one display screen as a function of the collaborative activity progress to guide the collaborative activity along a collaborative process.

Some cases include a system for providing guidance to collaboration participants in collaborative spaces, the system comprising a facilitator database storing characterizing rules for assessing success of collaborative activities, a plurality of monitors, at least one monitor associated with each of the collaborative spaces, each monitor configured to obtain information associated with an associated collaborative space that is indicative of progress related to a collaborative activity performed within the collaborative space, at least one computer interface located outside the collaborative space for use by a collaboration facilitator and a processor linked to the facilitator database, the monitors and the at least one computer interface, the processor programmed to perform the steps of obtaining information from each of the monitors, accessing the characterizing rules, comparing the obtained information to the characterizing rules to assess progress related to each of the collaborative activities and based on the comparison, providing activity status information to the collaboration facilitator via the computer interface.

In some cases the activity status information is periodically updated for each of the collaborative spaces. In some cases the processor ranks simultaneous collaborative activities according to assessed progress and presents the ranking information via the computer interface.

Some embodiments include a method for providing guidance to collaboration participants in a collaboration space, the method comprising the steps of storing characterizing rules for assessing conditions of a collaborative activity, using a monitor to obtain information associated with the collaboration space that is indicative of conditions related to a collaborative activity performed within the collaborative space, providing a processor programmed to perform the steps of obtaining information from the monitor, accessing the characterizing rules, comparing the obtained information to the characterizing rules to assess conditions related to the collaborative activity and based on the comparison, controlling the status device to indicate status of the collaborative activity.

Still other embodiments include a method for providing guidance to collaboration participants in a collaboration space, the method comprising the steps of storing characterizing rules for assessing conditions of a collaborative activity, using a monitor to obtain information associated with the collaboration space that is indicative of conditions related to a collaborative activity performed within the collaborative space, providing at least one display screen supported within the collaboration space and providing a processor linked to the facilitator database, the monitor and the at least one display screen, the processor programmed to perform the steps of obtaining information from the monitor, accessing the characterizing rules, comparing the obtained information to the characterizing rules to assess conditions related to the collaborative activity and based on the comparison, driving the at least one display screen as a function of the collaborative activity progress to guide the collaborative activity along a collaborative process.

These and other objects, advantages and aspects of the invention will become apparent from the following description. In the description, reference is made to the accompanying drawings which form a part hereof, and in which there is shown a preferred embodiment of the invention. Such embodiment does not necessarily represent the full scope of the invention and reference is made therefore, to the claims herein for interpreting the scope of the invention.

### BRIEF DESCRIPTION OF THE SEVERAL VIEWS OF THE DRAWINGS

FIG. 1 is a schematic view of a plurality of collaborative workspaces in communication with a facilitator;

FIG. 2 is an isometric view of a collaborative workspace that is consistent with at least some aspects of the present invention;

FIG. 3 is an isometric view of a facilitator workspace that is consistent with at least some aspects of the present invention that is in communication with at least one collaborative workspace;

FIG. 4 is a schematic view of various data sources in communication with a server;

FIG. 5 is a schematic view of a server having a processor and memory;

FIG. 6 is a flow chart depicting a general process flowchart of one process executed by the server of FIG. 5;

FIG. 7 is a schematic representation of various components associated with the memory of the server of FIG. 5;

FIG. 8 is an exemplary report generated from the server of FIG. 5;

FIG. 9 is a flow chart of the one particular process implemented by the server;

FIG. 10 is a flow chart of one particular process implemented by a facilitator;

FIG. 11 is a schematic illustrating a system and timeline consistent with at least some aspects of the present disclosure;

FIG. 12 is similar to FIG. 11, albeit showing the system at a subsequent point in time;

FIG. 13 is a screen shot illustrating a session dashboard;

FIG. 14 is a flow chart showing a method consistent with some aspect of the disclosure;

FIG. 15 is a schematic illustrating a conference space in which analog notes are converted to digital notes according to at least some aspects of the present disclosure;

FIG. 16 is a schematic illustrating a paper document that includes a dot code for use in some embodiments of the present disclosure;

FIG. 17 is a schematic illustrating the tip of a pointing device that includes a camera for capturing images of the code on the paper in FIG. 16;

FIG. 18 is a flow chart illustrating a process for posting an analog note and converting the content to digital content;

FIG. 19 is a schematic showing a digital version of a note associated with an analog version;

FIG. 20 is a schematic illustrating a camera for obtaining an image of an analog note;

FIG. 21 is a schematic showing a table edge camera obtaining an image of an analog post note;

FIG. 22 is a schematic illustrating a smart phone holder that is consistent with at least some aspects of the present disclosure

FIG. 23 is similar to FIG. 21, albeit showing the phone in a supported use position;

FIG. 24 is a to plan view of the assembly in FIG. 23;

FIG. 25 is a top plan schematic view of a conference space;

FIG. 26 is similar to FIG. 25, albeit showing conferees in different locations;

FIG. 27 is a flow chart illustrating a process by which cameras are used to follow conferees about within a conference space so that content applied by the conferees can be properly associated with specific locations within the space;

FIG. 28 is a schematic illustrating a virtual note clip board that can be moved about virtually along with a conferee within a conference space;

FIG. 29 is a schematic showing a conferee selecting a note to be posted;

FIG. 30 is a schematic showing a conferee dragging a note to a posted location;

FIG. 31 is a flow chart illustrating a sub-process that may be added to the process of FIG. 27 for having a clip board follow a conferee about within a conference space;

FIG. 32 is a flow chart illustrating a note posting process that is consistent with at least some aspects of the present disclosure;

FIG. 33 is a schematic illustrating an exemplary virtual clip board;

FIG. 34 is a schematic illustrating a lasso action on a display screen used to select a subset of content from the display screen;

FIG. 35 is a schematic illustrating an intermediate content selection step that occurs after a lasso action as in FIG. 35;

FIG. 36 is a schematic illustrating dragging of lassoed content to a virtual clipboard for temporary storage;

FIG. 37 is a flow chart illustrating a process whereby lassoed content is identified by a server;

FIG. 38 is a schematic illustrating lassoed content added to a clipboard;

FIG. 39 is a schematic illustrating a digital note generating device;

FIG. 40 is a flow chart illustrating a process whereby notes created within a space are associated with conferees located in the space;

FIG. 41 is a schematic illustrating an interface for a virtual view of a conference space;

FIG. 42 is another schematic view of a conference space that may be presented via an interface;

FIG. 43 is another virtual interface view of a conference space;

FIG. 44 is similar to FIG. 43, albeit showing a virtual note that is being generated;

FIG. 45 is another view of a conference space that may be presented via an interface;

FIG. 46 is a zoomed in view of the content in FIG. 45;

FIG. 47 is a schematic showing a virtual clip board on the FIG. 46 view;

FIG. 48 is a schematic view showing a new post note presented within an actual conference space after the note is virtually remotely created;

FIG. 49 shows the post note from FIG. 48 shrunk down and posted at a location on a screen within an actual conference space;

FIG. 50 is a schematic of a virtual view of a conference session;

FIG. 51 is a flow chart illustrating a process whereby a server identifies personas missing from a conferring group;

FIG. 52 is a schematic showing an interface for interacting with content within a conference space where the interface includes controls for accessing hisotircal content in a space as well as for selecting specific content to be memorialized for subsequent access;

FIG. 53 is a flow chart showing a process whereby a session server identifies content to be archived for subsequent access;

FIG. 54 is a schematic illustrating three large display screens for presenting content within a space;

FIG. 55 is a flow chart illustrating a process whereby a system identifies and presents content to conferees within a space based on the content being developed by the conferees within the space;

FIG. 56 is similar to FIG. 54, albeit showing different content;

FIG. 57 is similar to FIG. 54, albeit showing different content;

FIG. 58 shows a virtual interface including various controls that are consistent with at least some aspects of the present disclosure; and

FIG. 59 is a schematic illustrating a lasso action on a screen and an archive pop up window useable to archive the lassoed content either personally or in a session archive.

### DETAILED DESCRIPTION OF THE DISCLOSURE

One or more specific embodiments of the present disclosure will be described below. It should be appreciated that in the development of any such actual implementation, as in any engineering or design project, numerous implementation-specific decisions must be made to achieve the developers' specific goals, such as compliance with system-related and business related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

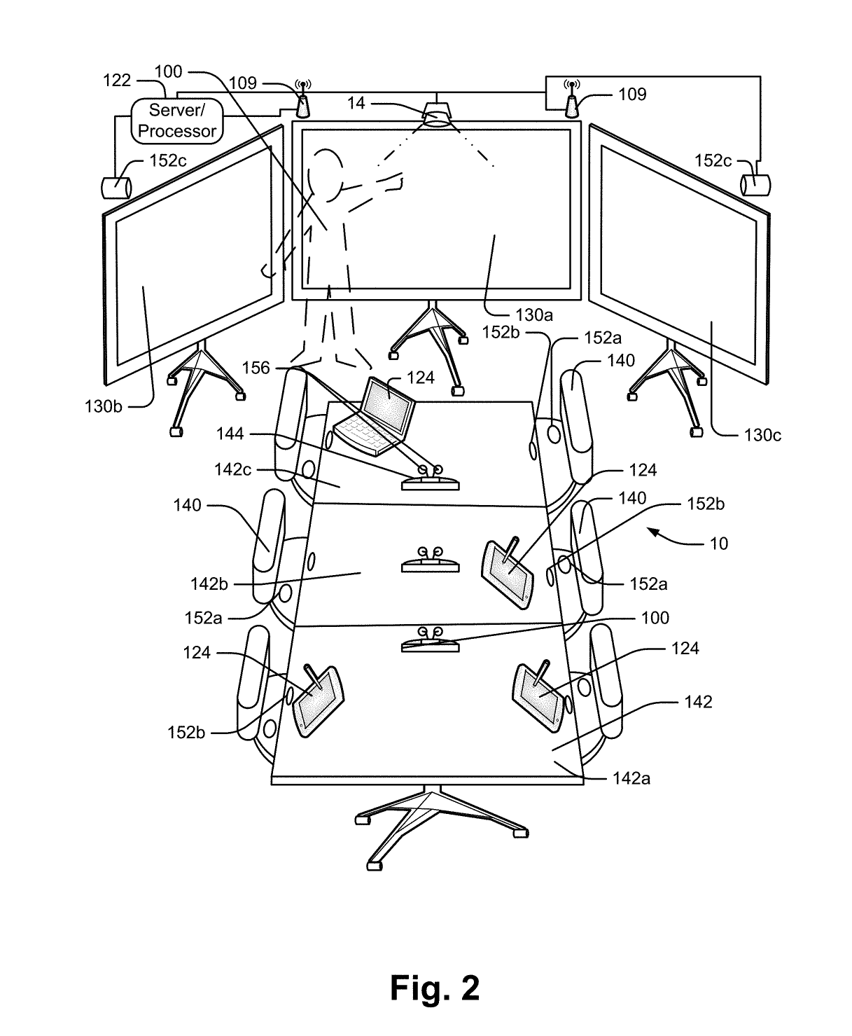

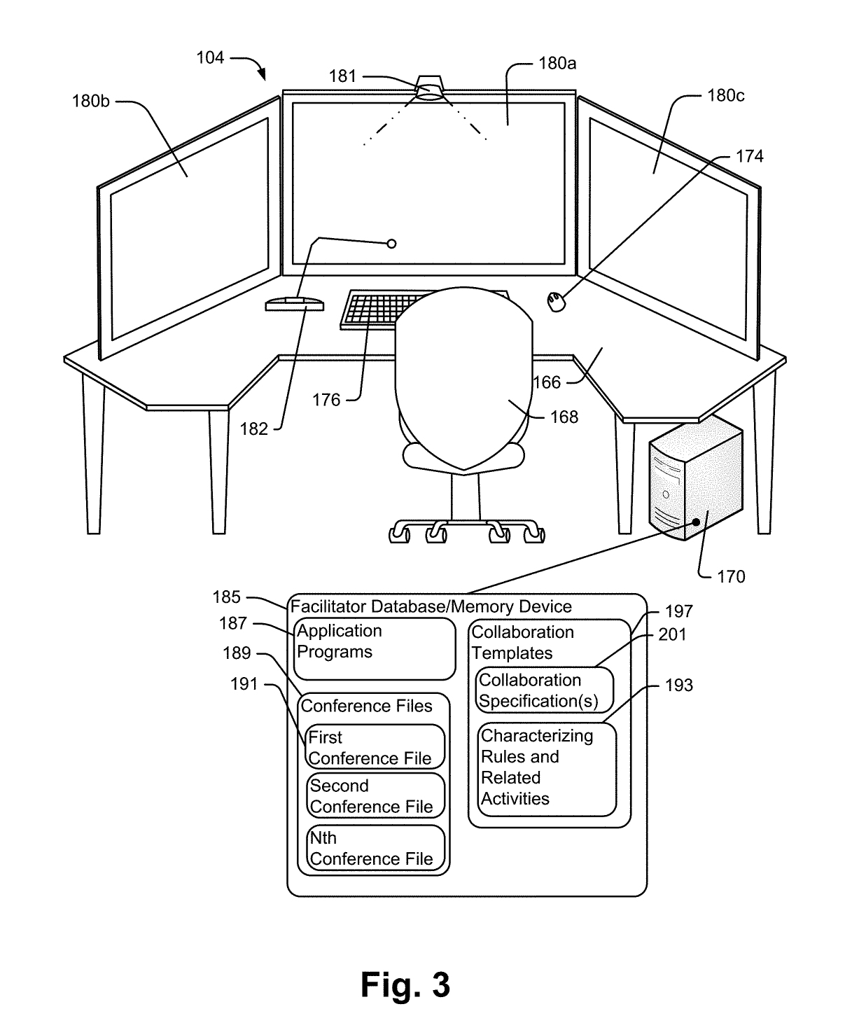

Hereafter, a system is described as including several computing devices including servers and other processor based devices (e.g., smart phones, tablets, laptops, etc.). While the disclosure is described in the context of a system where different functions and processes are performed by specific servers and/or other processors, it should be appreciated that many of the functions and processes could be performed by other system servers or processes. For instance, as seen in FIGS. 2 and 3, an exemplary system may include both a local server 122 and a remote server 170. Many functions described below could be performed by either server 122 or 170, despite being described as performed by one or the other. In fact, in some cases, a single server may perform the functions of both servers 122 and 170.

In the embodiments described hereafter, in some cases the collaborative system is described as a relatively rigid automated system that attempts to keep collaboration sessions moving along in a manner consistent with best practices or where a remote human expert in conjunction with a semi-automated system attempts to enforce best practices. The present disclosure, however, should not be so limited and is also meant to cover other embodiments where collaborative systems operate more in an advisory role making suggestions to session team collaborators that are consistent with best practices and then collecting information usable to discern how conferees react to the suggestions. In some cases the extent of monitoring by and suggestions from the system may be dialed up or down by a session conferee as described in greater detail below.

A. Room as Facilitator

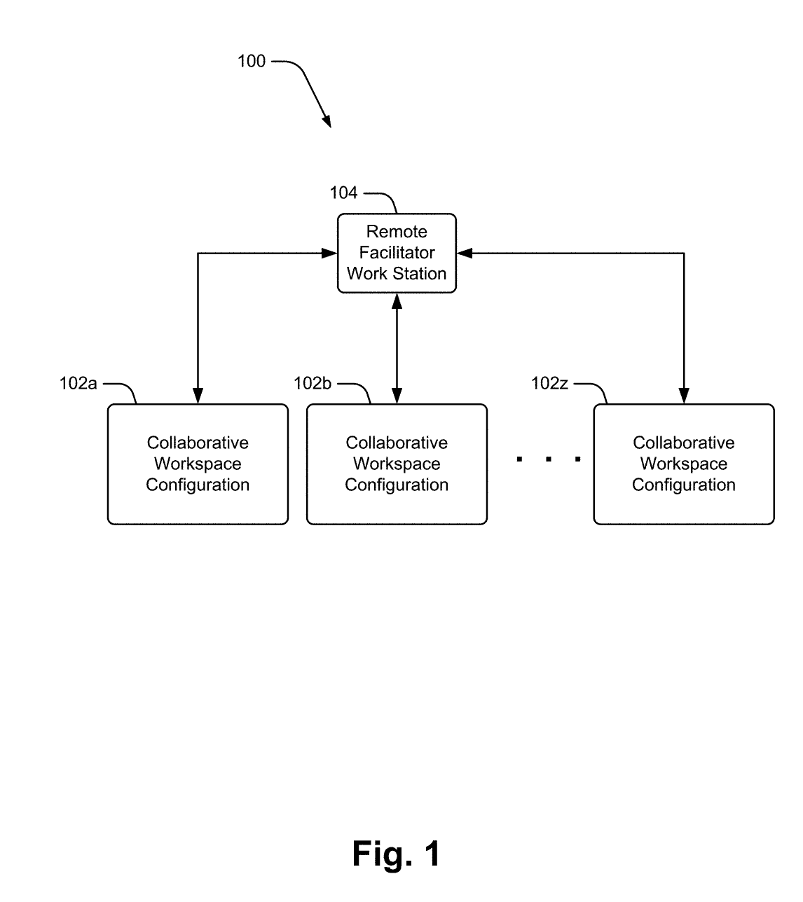

Referring now to the figures wherein like reference numerals correspond to similar elements throughout the several views and more specifically referring to FIG. 1, an exemplary collaborative system 100 that is consistent with at least some aspects of the present disclosure includes one or more collaborative workspace configurations/arrangements 102a, 102b . . . 102z, etc., in communication with at least one remotely located facilitator work station 104 (i.e., station 104 is remote from workspace configurations 102a, 102b, etc., in at least some embodiments). In at least some embodiments, each configuration 102a, 102b, etc., is linked to facilitator work station 104 via a communication or computer network (e.g. the internet) so that information can be communicated between work station 104 and any of the workspace configurations 102a, 102b, etc.

Each collaborative workspace configuration 102a, 102b, etc., is designed to host a plurality of participants participating in a collaborative activity during a collaboration session. The collaborative activity may comprise a brain-storming session, a meeting, a product development session, a marketing initiative, or any other type of activity where a plurality of people interact in a collaborative way. Referring to FIG. 2, exemplary configuration 102a is provided within a collaborative space 10 and includes, among other components, a conference table 142, a plurality of chairs (several of which are labeled 140), three large common or sharing display screens 130a, 130b and 130c, a configuration server or computer 122, wireless access points 109, various sensors, some of which are labeled 152a, 152b, 152c, one or more cameras 14, microphones 156 and speakers 144. While not shown, space 10 may be defined by some type of privacy wall structure.

Table 142 includes first, second and third smaller conference sub-tables 142a, 142b and 142c that are moveable within space 10 to assume different relative juxtapositions within space 10. To facilitate movement, each sub-table includes wheels or casters on the bottom of one or more pedestals. In FIG. 2 the sub-tables 142a, 142b and 142c are shown arranged in an end to end relationship to form a single table assembly 142 that itself is arranged centrally within space 10. Assembly 142 includes a table top for supporting devices and other materials (e.g., documents, etc.) used by conferees.

Exemplary user devices include a laptop 124 and tablet type computing devices, also labeled 124 in FIG. 2. Other user devices may include smart or cell phones or other portable computing devices that conferees bring into space 10.

Referring still to FIG. 2, large common screens 130a, 130b and 130c are arranged at one end of space 10 and spaced from the edge of table 142 at a location that is generally easily viewable by conferees at table 142. In at least some embodiments each of screens 130a, 130b and 130c is a touch sensitive flat panel display screen that a conferee can interact with by contacting the surface of the screen. For instance, when software application output is presented on screen 130a and includes a selectable icon, the conferee may be able to select the icon by touching the icon on the screen thereby causing the software to facilitate an associated activity. As another instance, an application may be run causing screen 130a to operate as a large electronic white board so that annotations may be added to the screen surface. The annotations may be stored in some embodiments as conference content in a conference work file for subsequent access by conferees or others or for electronic distribution to conferees or others.

In FIG. 2, screens 130a, 130b and 130c are shown mounted to support pedestals that include casters or wheels so that the screens can be moved within space 10 or even moved out of the space, if desired, by conferees. Thus, the number of screens and screen positions within space 10 can be optimized by conferees for specific uses or in ways that facilitate best use of space 10 for particular activities. Although not shown, a communication link can be established between each of screens 130a, 130b and 130c and server 122 so that server 122 can drive each of the screens and so that server 122 can receive signals indicative of activities performed by a conferee when interacting with the screens. The screen to server communication links may be via cables or via wireless communications (e.g. via access points 109 and transceivers on each of the screens 130a, 130b and 130c).

Although not shown, some way to provide power to the screens and to other artifacts within the conference space would be provided. For instance, power receptacles may be provided in walls that form the conference space, in the ambient floor, etc., such that each screen could be placed in any location within the space. In other cases some other type of floor power system like a grid type system where positive and negative leads link to electrodes disposed on the screen support pedestals may be employed. Each screen assembly may include a rechargeable battery (not illustrated) and the screens may be plugged in or otherwise powered to recharge the batteries when the screens are not in use (e.g., at night).

In addition to being able to interact with screens 130a, 130b and 130c via touch, in at least some embodiments a conferee may be able to use one of the portable devices 124 to interact with content on or to generate content on one or more of the screens 130a, 130b or 130c. To this end, in at least some cases, a conferee may be able to replicate application output from a tablet device 124 on screen 130a to share. As another example, a conferee may be able to use one of tablets 124 as a doodling pad to create a drawing where the drawing is replicated on screen 130a essentially in real time. As still one other instance, where server 122 runs a program and outputs a digital image on screen 130a, a conferee may use device 124 as a touch pad to move a cursor about on screen 130a and to select or drag or otherwise interact with the content on the surface of screen 130a or to apply annotations over the application output. Wireless signals from devices 124 may be received by access points 109 proximate space 10 or wireless transceivers built directly into the screens 130a, 130b and 130c. In at least some cases conference room application programs may be down loaded onto each device 124 for interacting with the common display screens in a space or with any other computer based system components associated with space 10.

Referring still to FIG. 2, camera 14 or any of the other sensors or monitors in space 10 may be replaced or supplemented by one or more gesture based sensors for obtaining information from space 10 that can be used to discern gestures by conferees intended to control or interact with common screen content. For instance, a conferee 100 may point to a screen 130a and the pointing hand may be recognized and cause server 122 to place a pointing cursor (e.g., an arrow icon) on screen 130a. Here, the pointing icon would be moveable about the screen 130a by changing the trajectory of the conferee's pointing hand. Other sensors for sensing conferee interaction with screens 130a-130c are contemplated.

Referring yet again to FIG. 2, sensors 152a-152c are motion or presence sensors that can be used to sense motion or conferee presence at different locations within space 10. For instance, several of sensors 152a are located within the seats of chairs 140 where the seat sensors 152 may sense weight and be programmed to indicate conferee presence when a threshold weight is sensed in a chair. Other sensors 152b are mounted in table 142 structure and are arranged to sense conferee presence or motion proximate an edge of table 142. Still other sensors 152c may be generally mounted in the ambient space 10 (e.g., in walls, a ceiling, a floor structure, within frames or along edges of the screens 130a, 130b, 130c, etc.) to sense presence and motion within space 10. The sensors described here are only exemplary and many other types of sensors are contemplated such as bio-function sensors that may sense, for instance, conferee body temperature, heart rate, blood pressure, etc. Still other sensors may sense information that is shared on common displays or screens 130a, 130b and 130c within the conference space. When sensing common display information, the sensors may simply sense the amount of content being shared (e.g., how many times content is changed on the common displays, number of content edits, etc.) In other cases the content sensors may actually examine the content of the information placed on the common displays and use the content to assess session progress.

Camera 14 is mounted within space 10 to capture images of activities occurring within space 10. For instance, camera 14 may be mounted above a central screen 130a at a viewing angle that is optimized to obtain video of conferees within space 120 that direct their gaze toward content on screens 130a, 130b and 130c. Other cameras may be positioned above space 10 or at other locations optimized to obtain video indicative of conferee activities within space 10.

Referring still to FIG. 2, each of the sensors 152, access points 109, camera 14 and microphones 156 are linked to configuration server 122 to provide information thereto. In addition, each of displays 130a, 130b and 130c as well as tablet devices 124 are linked to server 122 via access points 109. Thus, server 122 receives video from camera 14 and information or data from sensors 152 that can be used to assess activities within space 10. In addition, server 122 can also monitor content on screens 130a, 130b and 130c as well as, in at least some cases, activities on devices 124 to assess activities in space 10.

Once sensor/camera information is obtained, the information may be examined and analyzed to assess several different conditions or characteristics associated with a session, with the work product being generated by the session, or of session team members. For instance, exemplary interesting conditions that may be assessed include conferee participation levels (e.g., the number of conferees participating in a session, the amount, level and type of participation, etc.), alignment of team or group thinking (i.e., the degree of building on and support for ideas generated by team members), the degree to which thought is coalescing (e.g., the number of linkages to participant generated content as well as to content pulled from other sources such as the internet), position, posture in space (e.g., are conferees sitting, standing, leaning forward, at a table in a lounge chair, at a display, at a white board, etc.), quantities of disposable items in a conference space (e.g., pens, paper, sticky notes, etc.), brain activity (alertness, excitement, activation levels, drowsiness, etc.), correlations to past work (e.g., number of links or references to past projects and/or other active projects), amount, pace, pattern, rhythm of individual and group content creation (e.g., taking notes, making sketches, talking, pointing, gesturing, etc.), endorsement or interest level (e.g., the number of conferees adding to an idea in words, drawings, verbal discussion, etc.), decay of one or more ideas or thoughts (e.g., time since an idea or thought was last referenced in a discussion or appeared in shared content), the amount and/or variety of reference materials (e.g., observation photos, articles, relevant Internet searches shared with a team, etc.), team changes (e.g., monitoring when a team member leaves and when a new team member arrives), etc. Other interesting conditions and characteristics sets are contemplated.

Server 122 runs software programs to drive screens 130a, 130b and 130c as a conference is progressing and to support conference activities. For instance, server 122 may run software to facilitate electronic whiteboard activities on screen 130a, to run an application program like Microsoft Word, Power Point, etc., on one or more of screens 130a, 130b, etc., to receive commands or content from conferee devices 124 or other input devices and use that information to control a session, to receive and store video and audio content as well as other information generated in space 10 and to operate an activity facilitation program that is consistent with at least some aspects of the present invention and which is described in more detail below.

Referring again to FIG. 1 and also to FIG. 3, an exemplary remote facilitator work station 104 includes a table 166, a chair 168, a facilitator server 170, a plurality of display screens 180a, 180b and 180c, input devices including a keyboard 176 and a mouse 174, a camera 181, a speaker and microphone device 182 and a facilitator database or memory device 185. Table 166 includes a table top having a top surface for use by a conference facilitator (not illustrated) and chair 168 is located adjacent table 166 for use by the facilitator. Display screens 180a through 180c are arranges on the top surface of table 166 to face chair 168 and for easy viewing by a facilitator in chair 168. Keyboard 176 and mouse 174 are provided on the table for use by the facilitator to provide input to software applications run by server 170. Keyboard 176 and mouse 174 may be tethered or wireless and other input devices (e.g., touch on the screens 180a, etc., gesture based input devices, etc.) are contemplated.

Each of the display screens 180a, 180b and 180c, microphone and speaker unit 182, memory 185, camera 181 and input devices 174 and 176 are linked to server 170 either wirelessly or via data cables. Server 170 includes a computer having a processor that runs software to control configuration 104 and to perform other functions that are consistent with the present disclosure.

Database 185 stores software application programs 185 run by server 170, conference files 189 and collaboration templates 197. Programs 185 include programs run by server 170 to perform functions described herein. Conference files 189 include a separate conference file 191 for each conference that is facilitated by one of the workspace configurations 102a, 102b, etc., and includes content generated by the collaboration workspace configurations 102a, 102b, etc., during a conferencing session. In at least some embodiments the content or information in one of the conference files 191 may include essentially all information and content that is generated within a conference space (see again 10 in FIG. 2) during a conference session. To this end, in at least some cases a conference file 191 may include all content generated and shared within space 10 on display screens 130a, 130b and 130c, regardless of whether or not a conferee has indicated that the content should be stored in a persistent fashion. In addition, the content in a file 191 may include a complete audio and video transcript of a conference session. In some embodiments a file 191 may also include specific subsets of content that capture work product of conferees at specific times or after specific conferencing activities have occurred where that content, along with other content subsets that represent other work product, can be stored in a persistent manner as conference work product for subsequent access.

Moreover, file content may also include information derived from information collected from a conference space 10. For instance, in some cases file information may include different sub-files that store all information related to different ones of a plurality of conferees. For example, all content added to a session by a first conferee, all video and audio related to the first conferee, all questions, comments, feedback, etc., associated with the first conferee, etc., may be stored in a sub-file associated with the first conferee. A similar sub-file may be stored for each of the other conferees. As another example, where information and input during a session can be ascribed to specific conferees, an algorithm may be used to assess how much collaboration occurred during a session sub-process and to use that assessment as a proxy for the extent to which resulting work product reflects buy in of all conferees (e.g., where only one person out of ten added all content there is a relatively high probability that at least some of the other nine will not strongly buy into the work product).

As yet one other example, where the system derives information about a conferee based on session information the derived information may be stored. Exemplary derived information may include conferee stress level, brain activity based on bio-function information, conferee posture, alertness, etc., during a session, general participation level, a conferee's level of alignment with the team during the session and ultimately with a generated work product, the value of a conferee's contributions, how much of the content initiated by a conferee ended up in final work product, etc.

Referring still to FIG. 3, collaboration templates 197 include collaboration specifications 201 and characterizing rules and related activities 193. It is contemplated that collaborative activities within a space 10 (see again FIG. 2) may take any of several different forms depending upon the ultimate goals of a team of people using the space. Optimized or best practice processes for facilitating collaborative activities will be different depending upon the types of collaborative activities to be performed. Collaboration specifications 201 include a different set of specifications for each different type of collaborative activity. An exemplary collaborative specification may include a definition of sub-processes or stages of an associated collaborative activity and a related optimized or acceptable time line for the different stages. In addition, an exemplary collaborative specification may also include instructions or suggestions for guiding an activity such as instructions for each stage in a process, on expectations, required or possible work product, time constraints or goals, etc. In cases where it is known that specific arrangements of furniture artifacts within a conference space (e.g., moveable displays screens 130a, 130b, etc., in FIG. 2) are optimal for specific sub-processes, the instructions may at least suggest that conferees re-arrange artifacts into the optimal configuration.

Referring again to FIG. 3, characterizing rules and related activities 193 include rules that can be used to objectively assess how well a collaborative session is progressing or to perceive a current status or condition related to a collaborative session. To this end, an entire industry has developed around facilitation of collaboration to help groups of people work together to achieve common goals. In this regard, for instance, many different techniques, processes and sub-processes have been developed that can be used by a group to move through design activities in an efficient and effective manner. In many cases highly specialized collaboration facilitators or experts are brought in to help facilitate collaborative activities by breaking down an activity into sub-processes, clearly defining intermediate goals, applying techniques to help conferees think creatively, build consensus among conferees, reduce excess friction between conferees, etc. For example, where a collaborative activity is broken down into four sub-processes and a team of people has one week to work through the sub-processes and complete the activity, a general rule of thumb may be that the first sub-process should be completed within the first day of collaborative activity given known complexity of the subsequent sub-processes. Here, a facilitator would know the optimal schedule and work with team members to stay on schedule during the first day of activities.

In FIG. 3, characterizing rules 193 include rules that, in effect, codify characteristics of collaborative activities that can be used to assess activity progress. For instance, in a simple example, if the first of four activity sub-processes is to be completed within the first day of a collaborative process and, at the end of the first sub-process, a specific work product has to be generated, one characterizing rule may be that after the first day, the specific work product has to be stored in a conference file 191. Here, if the work product is not stored at the end of the first day, the rule may be used to determine that the collaborative activity is not progressing at an acceptable rate for the activity to be completed within the target time period (e.g. one week). Application of the rule would result in perception of a delayed or slowed session condition.

While the above characterizing rule is extremely simple, many other more complex rules are contemplated. For example, during collaborative activities it may be expected that conferees will jointly and generally continuously generate large amounts of content on the large common display screens 130a, 130b, 130c, etc., within a conference space 10 (see again FIG. 2). For this reason, perceived progress may be measured, in at least some cases, by tracking the amount of content being added to the surfaces of screens 130a, 130b, etc., or by the amount of content from screens 130a, 130b, etc. that conferees are storing in database conference files 191 for persistent association with a specific conference. Here, where content generation slows substantially, one characterizing rule 193 may indicate a lull in content development or persistent storage that may signal that progress has stalled.

In other cases characterizing rules 193 may combine information obtained from various components within a conference space 10 to assess collaboration progress. For instance, where content generation on screens 130a, 130b, etc., has slowed or halted, information obtained from camera 14 and microphones 156 may be examined pursuant to a characterizing rule to determine if conferees have turned to verbal communications to continue progressing along the collaborative process. Similarly, where screen content generation has stalled, presence sensors 152a may be used to determine that conferees have left space 10 during an impromptu break in activities.

In still other cases, movement within space 10 may be sensed and used to assess progress of a collaborative activity. For instance, movement of conferees in space 10 may indicate activity, movement of furniture artifacts like screens 130a, 130b, etc., or tables or other devices may indicate progress, etc. In this regard, for instance, it may be that during a particular sub-process or stage of activity, members of a large team are to break out into smaller working groups to delve into various ideas. Here, server 122 may track locations of team members via analysis of images generated by camera 14 or via locations of user devices 124 determined via wireless triangulation as known in the art and may recognize transitions between consecutive sub-processes based on perceived movement.

In some cases a characterizing rule may require a conferee in a collaborative session to affirmatively indicate that some sub-process has been completed or to confirm a perceived condition. To this end, it has been recognized that in many cases humans are the ultimate sensors as humans process information and draw more accurate conclusions than most sensor/processor combinations. For instance, in the above example where a first sub-process is to be concluded within the first day of a weeklong session, server 170 may be programmed to query via display screen 130a (see FIGS. 2 and 3) whether or not the first sub-process has been completed at the end of or near the end of the first day and to obtain a response via screen 130a. Where no response is received or where a conferee indicates that the first sub-process has not been completed by the end of the first day, the characterizing rule may identify that the session is off schedule.

As another instance, if application of a characterizing rule indicates that a session has likely stalled for some reason, the system may query one, a subset or all conferees in a space 10 seeking confirmation of the stalled session. For example, confirmation may be sought via a voice simulation in space 10 seeking confirmation. Here, confirmation may be via a conferees voice indicated yes or no. As another example confirmation may be sought by transmitting a text query to a conferee's personal tablet or other device 124 seeking confirmation. Where confirmation is obtained, the system may automatically choose a suitable related activity.

In still other cases at least some of the characterizing rules may also be used to identify a process or sub-process that is perceived to have been short circuited or flawed due to moving along too quickly. For instance, where a first sub-process typically requires three fourths of a day to a full day and a team completes the sub-process in one hour, the speed with which the sub-process was completed may reflect a poor process and a related poor result. For instance, it may be that one person on a team has a particularly strong personality and forces his vision on other team members in short order so that, in effect, collaboration never occurs. While other team members may acquiesce to a strong personality, buy into the end result in these cases is often not very strong. One rule may specify that when a sub-process is completed in an inordinately short amount of time, that server 170 further analyze other information that is likely indicative of the degree of collaboration such as audio to ensure that all or at least a majority of conferees participated in the process. Here, where audio is analyzed and it is clear that only one or two conferees drove a sub-process, server 170 may indicate a perceived problem with how the sub-process progressed.

In other cases, where it is perceived that a sub-process was completed too quickly, the system may query team conferees with questions designed to determine the quality of the resulting work product, the conferee's sense of how well the process progressed, the conferee's sense of the quality of the work product, etc. For instance, the system may present a question like, “On a scale from 1 to 10, indicate the level of confidence you have in the work product generated during this sub-process.” Here, if the average answers from conferees are relatively high (e.g., 7 or higher), then the system may encourage the team to move on to the nest sub-process. If the average answers are low, the system may link a remote human expert to the conference to make sure the team generates high quality work product for the sub-process.

In other cases the rules 193 may automatically assess the quality of persistent work product developed by conferees. For instance, one rule may be that at the end of a first sub-process, a list of sub-topics to be addressed in more detail during subsequent sub-processes has to be stored and that, a typical acceptable list would include at least four and at most ten sub-topics. In this case, where a stored list at the end of the first sub-process only includes two (e.g., less than four) sub-topics or fifteen (e.g., more than ten) sub-topics, the rule may indicate a perceived or potential problem with the final work product of the sub-process. Other more complex rules and processes for assessing work product quality are contemplated.

Thus, rules 193 include metrics to objectively determine if stages or sub-processes of a collaborative activity have been completed or are progressing at an acceptable rate or to assess some other collaboration metric like likely quality of work product. The system in FIGS. 1 through 3 operates to obtain information from within a conference space 10 and provide that information to a monitor or system server 170. Server 170 applies the characterizing rules to the obtained information to assess collaborative activity progress and/or in an attempt to perceive specific or interesting conditions related to the session.

Characterizing rules and related activities 193 also include activities to be performed when the result of applying a characterizing rule to the information obtained from a conference space 10 indicates that a collaboration session is not progressing in an acceptable fashion or when some other problem or interesting condition is perceived (e.g., a work product that does not meet certain base line criteria). To this end, the system will include at least one status device that can indicate status of a collaborative activity. Referring to FIG. 3, in at least some embodiments any one of screens 180a, 180b and 180c may comprise a status device for indicating session/activity status. For instance, where application of a characterizing rule to information obtained from a space 10 indicates that a required work product will not be completed within a first day of activities as desired, processor 170 may generate an indication on display 180a indicating that the associated session is moving at too slow a pace.

Upon receiving notice of a slow session on screen 180a, a facilitator at station 104 may take some steps to move the session along at a faster pace. For instance, in some cases the facilitator may simply tap into the session to provide some guidance to the conferees. For example, the facilitator may tap into the session receiving a video and audio feed from space 10 and providing video and audio from camera 181 and device 182 to space 10 (via one of the screens 130a, 130b or 130c) and speakers 144 so that the facilitator can converse with the conferees in space 10. Here, for instance, the facilitator may provide some encouraging remarks about progress made, remind the conferees of the schedule and provide some guidance regarding how to work through a perceived impasse in the collaborative activities.

Referring still to FIG. 3, in other cases when an impasse in activities or some other interesting condition is perceived, server 170 may provide an indication to a facilitator in the form of a summary of activities associated with the conference without automatically linking the facilitator to the conference. In this regard, it has been recognized that characterizing rules 193, while useful, may not always generate results that reflect reality. For instance, the rules may indicate an impasse while in fact healthy and constructive communications are occurring that cannot be perceived and discerned by the characterizing rules used by the system. Here, the idea is that the activities summary may be usable by the facilitator to, in effect, override the characterizing rules and allow a session to continue without interruption when a facilitator's review of the summary causes the facilitator to believe that the session is progressing in a reasonable or acceptable fashion despite a problem or interesting condition determination by server 170. For example, the summary many allow the facilitator to review the last five minutes of conference activity via a video clip which shows progress in the collaborative activity that could not be discerned via application of the rules. Here, the facilitator would still have the option to manually patch into a session for any reason.

In still other cases, when an impasse is identified and indicated to a facilitator, the facilitator may be able to simply provide some indication to conferees to modify their activities. For instance, the indication may simply be a reminder that a sub-process needs to be completed by some specific time in order to stay on track. As another instance the indication may include presentation of a short pre-canned video clip providing more detailed guidance on how to work through a specific problem or showing how another team has worked through a similar impasse.

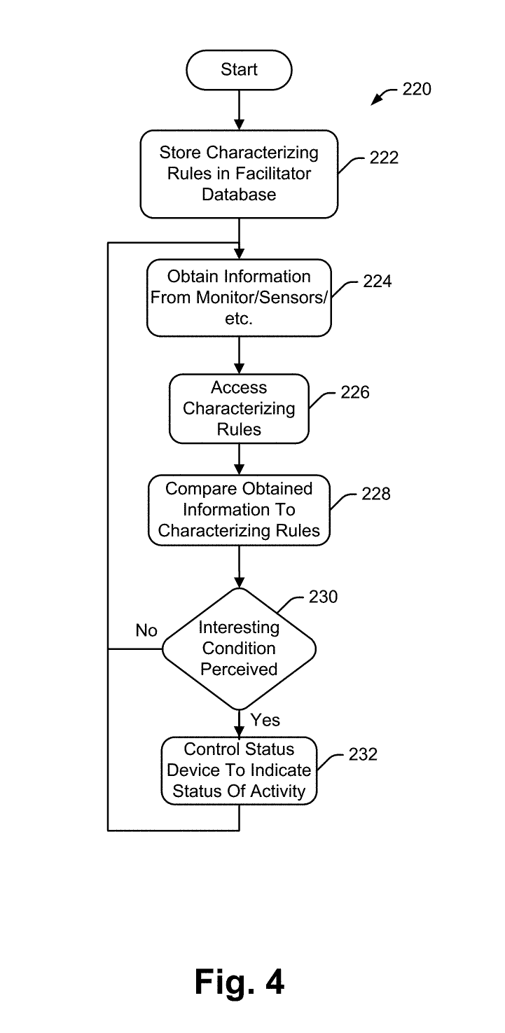

Referring now to FIG. 4 and also to FIGS. 2 and 3, a process 220 that may be performed by server 170 in conjunction with the station components shown in FIG. 2 is shown as a flow chart. At step 222, characterizing rules are stored in the facilitator database 185. Here, the rules may be pre-defined by one or a group of collaboration facilitators. In some cases one or more of the rules may be generated by server 170 running a program based on information such as a collaboration specification 201. For instance, where a collaboration specification simply includes an optimal time line for performing a sequence of sub-processes, server 170 may develop at least default rules for assessing activity progress. For example, where a first sub-process is to be completed in a first day of a weeklong session, one automatically generated rule may be that if at least some data representing work product at the end of the first day has not been expressed within two hours of the end of the first day, a possible impasse condition is perceived. As another example, the system may analyze sensed session information and perceive that conferee thinking is not coalescing around a likely final work product so that buy in to the final work product will not be good.

At block 224, server 170 obtains information from the components in FIG. 2 that is usable to assess progress or perceive interesting conditions. Here, as described above, the information may include content on screens 130a, 130b and 130c, video from camera 14, audio from microphones 156 and information from other sensors 152a through 152c within space 10. The information is stored in a conference file 191 associated with the conference.

Referring still to FIGS. 2 through 4, at block 226, server 170 accesses the characterizing rule sets 193 in database 185. At block 228 server 170 compares the obtained information to the characterizing rules. At decision block 230, server 170 determines, based on the comparison at step 228, whether or not session progress is acceptable (i.e., is on track) and whether or not some other interesting condition has been perceived. Where session progress is on track and no other interesting condition has been perceived, control passes back up to block 224 where the process including steps 224 through 230 is repeated while the session progresses.

At decision block 230, if session progress is not progressing at an acceptable rate or where some other interesting condition has been perceived, control passes to block 232 where one or more status devices are controlled to indicate status of the activity. Again, for instance, the status device may include one or more of screens 180a through 180c in FIG. 3 and the controlling step may include any of several different types of control.

Referring again to FIG. 4, at decision block 230, when server 170 determines that session progress is acceptable, instead of simply looping back up to block 224 to monitor additional information, server 170 may be programmed to provide encouragement to conferees within space 10. In this regard, encouragement make the form of a message on screen 130a in space 10 (see also FIG. 2) indicating that the team is on track to achieving the ultimate goal of the session. Other encouragement may include an indication for the team to take a break or redirecting the team to play a game of some type to change the pace up a bit and keep the process fresh.

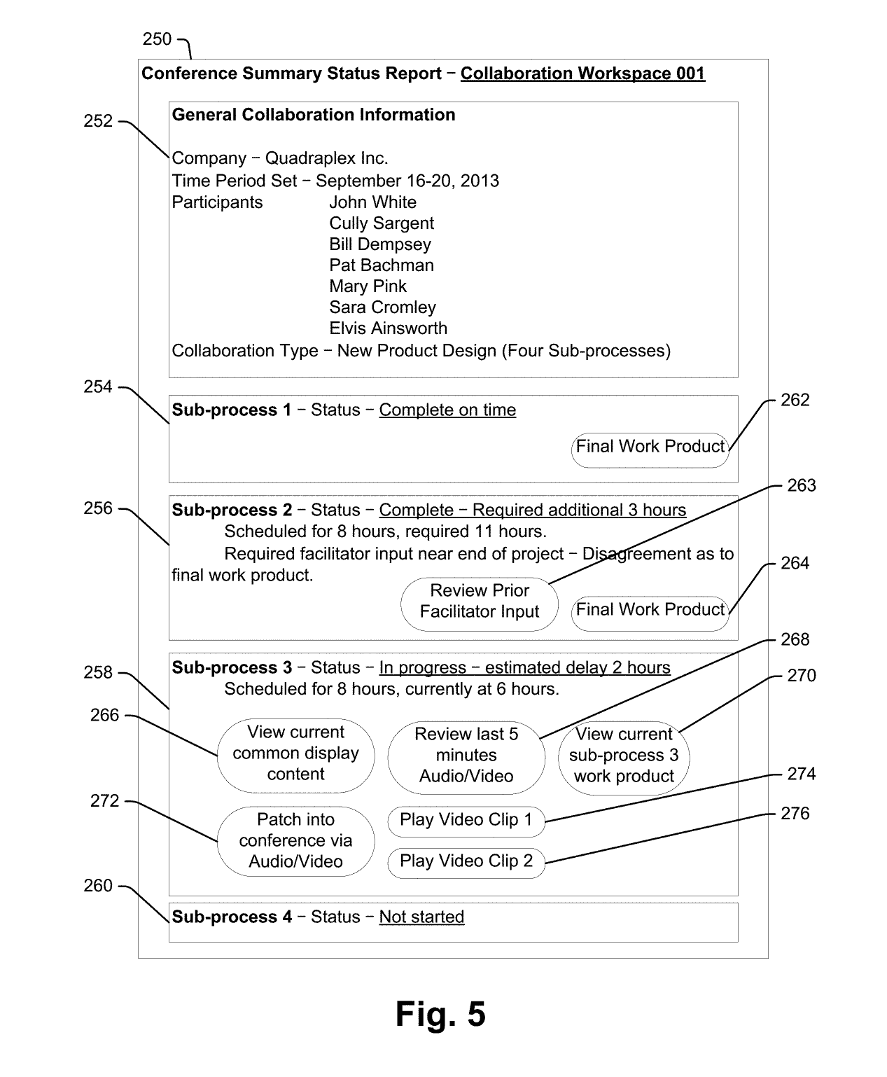

As indicated above, one type of status device control may include presenting a summary report of a session that is at a perceived impasse. An exemplary application interface including an exemplary summary report that may be provided to a facilitator is shown in FIG. 5. The exemplary report 250 includes a general collaboration information section 252 and sub-process status/information sections 254, 256 and 258. General collaboration information section 252 includes general information that allows a facilitator to quickly distinguish the session associated with report 250 from other sessions. In this regard, it is contemplated that a facilitator may work with many (e.g., 20) different collaboration teams in parallel, moving from one team to another as interesting conditions are perceived in the sessions. The general information indicates a company associated with the session, the time period at least initially set for the session, the names of participants (e.g., session team members) in the session and an indication of collaboration type. Regarding collaboration type, here, it is contemplated that a system like the one described above may be usable to facilitate several different types of collaborative activities and that different optimized processes may be supported by the system. In FIG. 5 the collaboration type is a “New Product Design” session type and includes four sub-processes.

Each of the sub-process sections 254, 256 and 258 provides information related to the sub-process. At the point in time corresponding to report 250 in FIG. 5, the first and second sub-processes have been completed and therefore their statuses are indicated as complete. The fourth sub-process has not been started and therefore the status of that sub-process is indicated as “Not started”. The third sub-process is currently in progress and therefore its status is indicated as “In progress”.

Referring still to FIG. 5, the first sub-process section 254 also includes a “Final Work Product” icon 262 which can be selected by a conference facilitator to access work product generated and stored by the conferencing team during the first sub-process. For instance, this final work product may include a final goal for the project as well as a list of eight sub-topics to develop in detail in subsequent sub-processes in order to achieve the ultimate goal. Here, the idea is that a facilitator may be able to generate a better understanding of where the team has been and the current state of the session by reviewing the work product associated with earlier completed sub-processes.

Referring again to FIG. 5, in addition to indicating that the second sub-process has been completed, the status information in section 256 indicates that the second sub-process required three more hours than the allotted eight hours to complete and that the facilitator had to provide input to the team to help move the second sub-process along. Section 256 also includes a “Review Prior Facilitator Input” icon 263 and a “Final Work Product” icon 264. The final work product icon 264 is similar to icon 262 described above and enables the facilitator to see the final work product associated with the second sub-process.

Icon 263 can be selected by the facilitator to access information related to prior times that the facilitator had to provide input to the team. For instance, icon 263 may enable the facilitator to review video and audio of the team when one or more prior impasses occurred, to review notes by the facilitator regarding how the prior impasses occurred and how they were resolved, or any other information that may provide insights to the facilitator regarding how to best interact with the team.

Section 258 in FIG. 5 indicates that it is estimated that the third sub-process will require two more hours than the period that was originally allotted for the sub-process and that the sub-process is currently in the sixth hour of an initially allotted eight hour period. Here the 2 hour estimated delay may be based on analysis of any data gathered from within space 10 as described above.

Section 258 also includes several selectable icons 266, 268, 270, 272, 274 and 276. A “View current common display content” icon 266 can be selected by the facilitator to view the content currently displayed on common displays 130a, 130b and 130c in FIG. 2 so that the facilitator can examine the same information currently presented in space 10. A “Review last 5 minutes Audio/Video” icon 268 can be selected to review the last five minutes of the collaborative activity in space 10 so that the facilitator can obtain a first-hand understanding of recent communications within the space in order to potentially develop an understanding of current dynamics in space 10.

Icon 270 enables a facilitator to review current work product for the third sub-process. In this regard, it may be that any one of the sub-processes will result in several different lists, images, documents, videos, audio clips, compilations of data, etc., and that a sub-set of the work product is stored intermediate the full period associated with a sub-process. Here, the facilitator could examine the existing subset of completed work product for the third sub-process.

Icon 272 allows the facilitator to patch into the current conference for two way communication with the conferees located in space 10. Once patched in, the facilitator can discuss status of the activity, any information that the facilitator has previously reviewed via icons 266, 268 and 270 and suggestions for a way to get back on track to wrap up the sub-process and realign with the initial schedule if possible.

Video clip icons 274 and 276 may be selected by the facilitator to control server 170 to provide associated tutorials or other video clips to the team in space 10. Here, one or more of the video clips may be specifically designed to deal with a specific problem in the collaborative process that often occurs during the third sub-process. Where there are three common and distinct problems that routinely occur, three different pre-canned clips may be provided, one for each typical problem. One or more of the video clips may provide instruction on a mental or even physical game that can be played by team members in space 10 in an attempt to change up the atmosphere in space 10.

In addition to automatically identifying an impasse or an irregularity during collaborative activity, the characterizing rules may be applied to identify where within a process or a sub-process a team is and to provide some type of indication to a facilitator. In response to an indication that a specific point in a sub-process has occurred, the facilitator may be able to choose from among several different courses of action. For instance, storage of work product associated with a sub-process may be used to estimate that the sub-process will likely be completed in the near future (e.g., in the next thirty minutes). In response to an indication that a sub-process is about to be completed, a facilitator may use the facilitator work station (see FIG. 3) to review the stored content, review information on the common displays 130a, 130b, etc., review the last few minutes of audio and video associated with the content, or review any other gathered or developed information related to a session. After having reviewed the content, the facilitator may choose to do nothing and let the team move on to the next sub-process undisturbed or may choose to intervene by patching into the conference space to make remarks, help increase the quality of the sub-process work product or to introduce the next sub-process and help make a transition thereto. Periodic process updates may be provided to the facilitator with options to review and interject in various ways throughout a collaborative activity.

In the above described system, when server 170 recognizes a perceived impasse or other perceived irregularity or interesting condition during a collaboration session, the server is programmed to provide some type of status indication to a remote human collaboration facilitator or expert so that the human facilitator can make a determination regarding whether or not the perceived impasse, irregularity or other condition needs to be addressed by the facilitator and, if so, how. While a human facilitator facilitates many advantages such as the ability to deal with cases in which the characterizing rules yield an incorrect perception and the ability to smartly select one of several different responses when an impasse or irregularity occurs, other systems are contemplated in which the facilitator function is completely automated. To this end, it is contemplated that the characterizing rules and related activities 193 in FIG. 3 may be applied by server 170 to detect irregularities or other conditions and to provide information to conferees within space 10 that attempts to automatically keep a collaborative process on schedule, that helps a session team generate high quality work product, that helps a team generate buy in to final work product, or that achieves some other goal(s) important to an organization.

An automated system can be implemented in a relatively simple fashion where the characterizing rules and related activities are relatively simple. For instance, a collaboration specification 201 in FIG. 3 may require specific work product or a specific affirmative indication by a conferee that a sub-process has been completed and a characterizing rule may recognize that a next sub-process should commence once the required work product has been generated and stored or affirmative action has occurred. The related activities may include presenting work product in a summarized fashion via the common display screens enabling a team to confirm that the work product is accurate. In addition, in some cases the related activity may invite or require one or more of the conferees on a team to memorialize the ends sub-process in a short video that can be used subsequently to remind or inform team members (local or remote) how the ending sub-process progressed and wound up. Here, it has been recognized that often work product from a sub-process may take unexpected paths and it may be difficult for a system to automatically summarize how the work product resulted from session information gathered. Where a conferee is willing to verbally summarize a sub-process, the information can be invaluable to others on a team (e.g., remote conferees), new conferees on a team, etc.

The related activities may also include automatic generation of a graphic showing the overall session and how the team is progressing when compared to an initial session time schedule, information related to conferee buy in to work product as well as the session process in general. The related activities may further include presenting instructions (e.g., video) to a team to help the team understand the next sub-process and its goals and to help the team transition to the next sub-process.

In other cases a related activity during a transition from one sub-process to the next may require movement of screens 130a, 130b, etc., to different relative juxtapositions within space 10. Information from a camera or other sensors (e.g. wireless access points) in space 10 may be used to confirm required or suggested relative juxtapositions. Where screens are not in required or optimized or suggested positions, server 170 may provide text or a graphic or both indicating were the screens should be located. For instance, in FIG. 2, text may be presented on screen 130b indicating “Move this screen left” while text on screen 130c indicates “Move this screen right”. As another instance, a graphic may be presented on center screen 130a indicating where each of the screens should be placed.

While screen locations and the locations of other furniture artifacts in space 10 may be automatically determined in some cases, in other cases, after instructions for relative juxtapositions are presented, a confirmation icon may be presented via one of the displays (e.g. 130a) to be manually selected by a conferee to indicate that the artifacts are in the positions indicated.

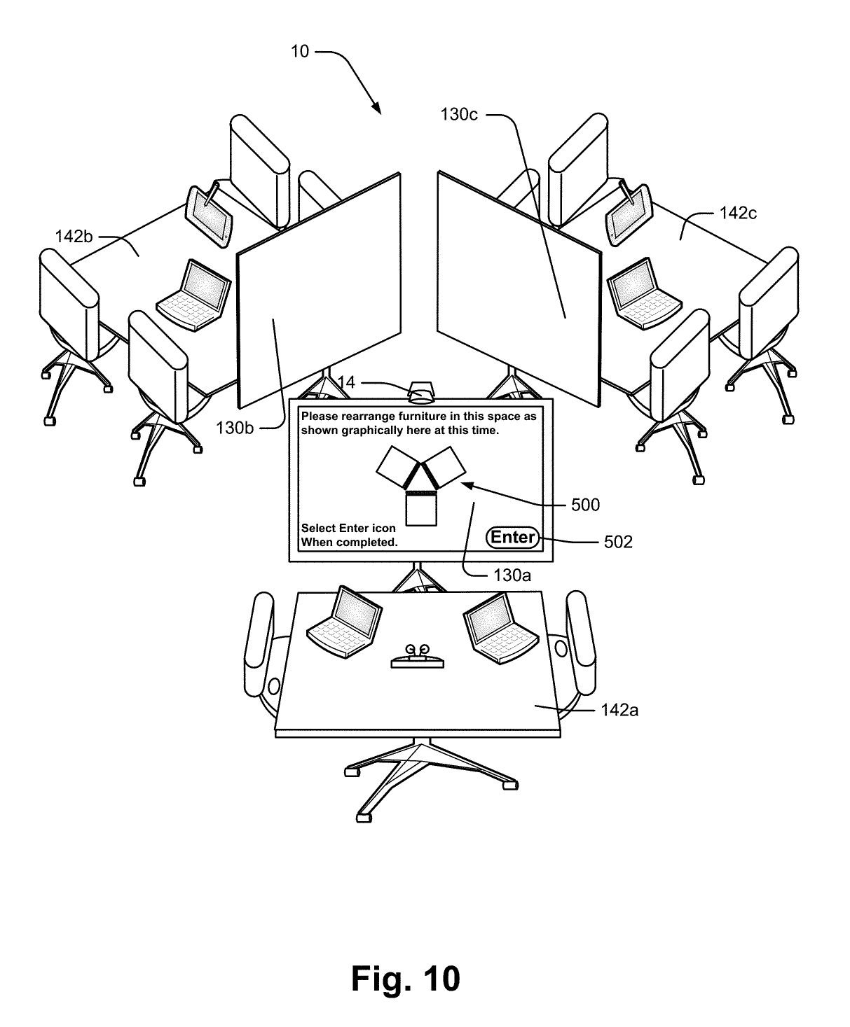

To this end, see FIG. 10 where the sub-tables, display screens and chairs from FIG. 2 are shown after having been rearranged per instructions provided as a related activity by one of servers 122 or 170. Instructions and a plan view diagram are provided at 500 on screen 130a and an “Enter” icon 502 is also provided that can be selected to confirm that the space artifacts are in the relative juxtapositions shown in the diagram 500. In still other cases, an interface may provide an icon to select to ignore an artifact juxtaposition instruction. For instance, a particular team may not want to reorient artifacts for some reason. In this case, a conferee could select the ignore icon to indicate to server 170 that the instruction to rearrange is being ignored.

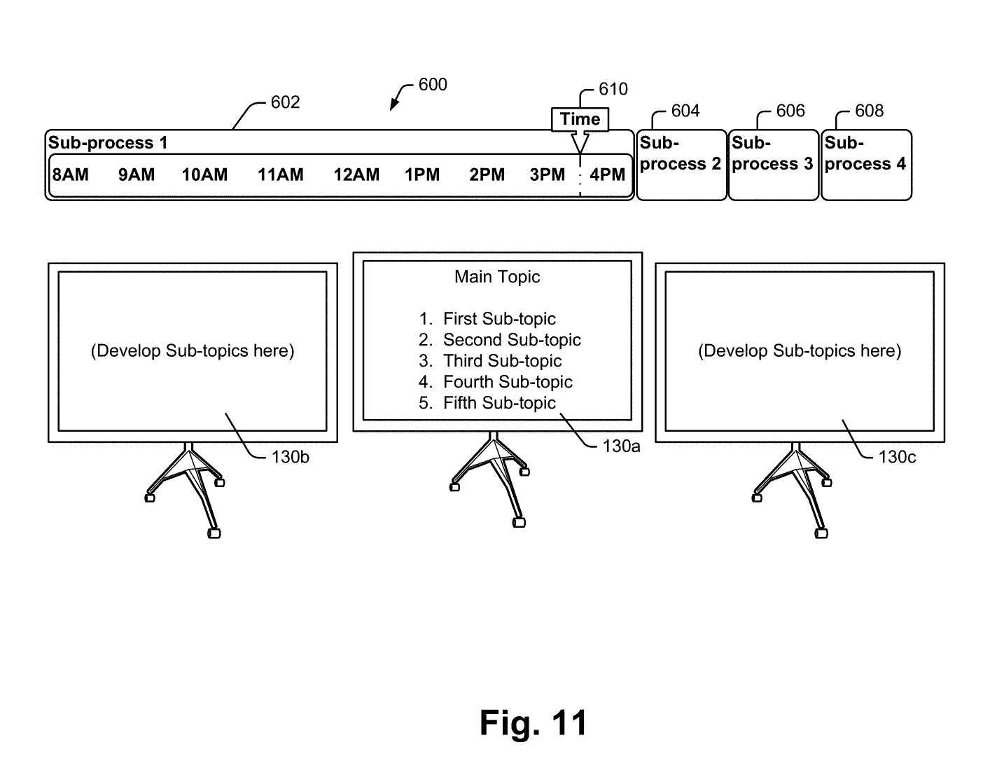

In at least some cases an automated system may automatically rearrange content for conferees at different times during a session to help lead the session. For instance, in some cases where several common display screens 130a, 130b and 130c (see again FIG. 2) are located in a space 10, the system may automatically move session work product around on the screens in an optimized fashion as the session moves from one sub-process to a next consecutive sub-process. To this end, see FIG. 11 where three common screens 130a, 130b and 130c are shown along with a schematic timeline 600. In FIG. 11, the timeline includes four sub-processes 602, 604, 606 and 608 and a current time indicator 610 indicates that the time scheduled for completing the first sub-process 602 is near. Here, one expected work product from the first sub-process may be development of sub-topics to be further developed during a second sub-process. In this regard, see in FIG. 11 that a list of five sub-topics is developed and presented on a central screen 130a where the central display 130a would be positioned in a conference space for optimal viewing by conferees. The side screens 130b and 130c may be used to share and develop content during the first sub-process in an effort to develop consensus around the five sub-topics.

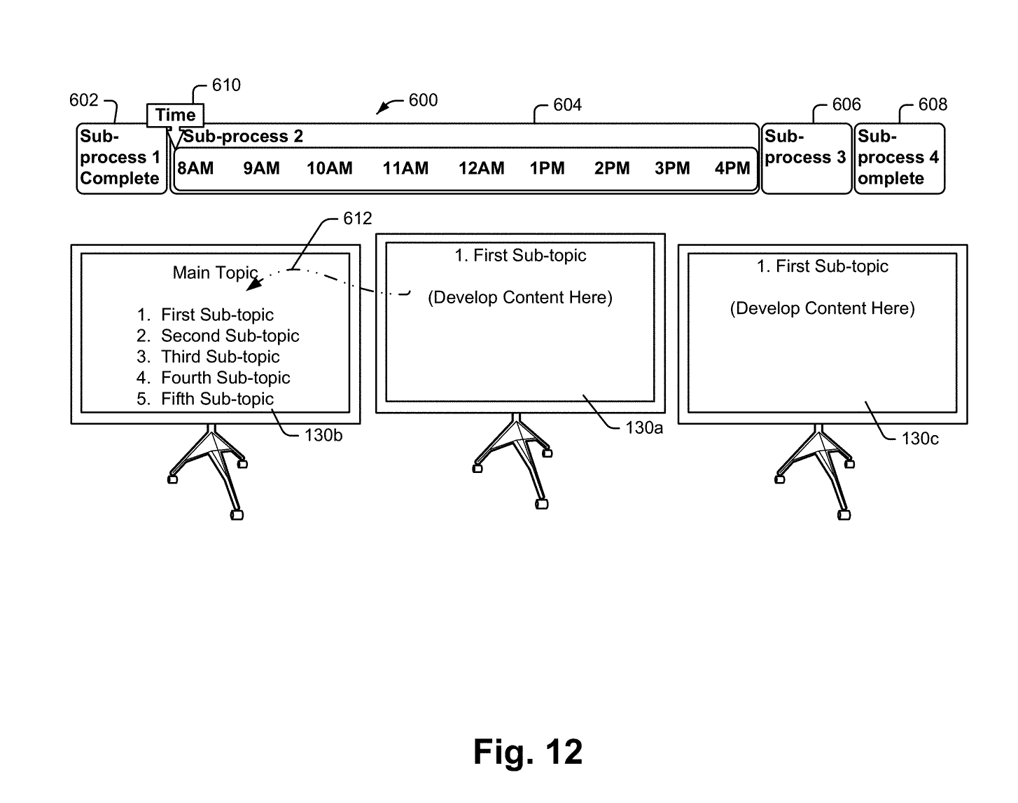

Referring still to FIG. 11, at the end of the first sub-process, once the five sub-topics have been developed and information related thereto has been stored, the session may automatically move to the second sub-process 604. Referring also to FIG. 12, an illustration similar to the FIG. 11 illustration is shown, albeit where the time indicates that the second sub-process 604 is commencing. Here, at or near the beginning of the second sub-process, the system may be programmed to automatically move the main topic and list of five sub-topics (see arrow 612) from the central common screen 130a to one of the side screens 130b as shown. In addition, in the example, suggestions to develop the first topic are provided along the top boundaries of screens 130a and 130b to encourage a team to move forward and develop the first topic. Once the system perceives that the first sub-topic has been developed (e.g., via analysis of stored content related thereto) or once a conferee indicates that the first sub-topic has been developed, the system may automatically change the headings on screens 130a and 130b to suggest that the second sub-topic should be developed. This process of automatically changing screen content and moving screen content to push session progress along may continue until the second sub-process is completed and then more content re-arrangement may occur during the transition to the third and then to the fourth sub-processes. While the example here is simple, other far more complex systems are contemplated where the system helps conferees organize work product and content to work toward final work product.

In other cases the automatic characterizing rules and related activities may be much more complex including many different interrelated rules and activities so that the system can automatically generate and present information to team conferees either when an impasse, an irregularity or another condition occurs or to present information at key times during a collaboration process.

In addition to the human facilitator system and the automated system described above, in at least some cases hybrid systems are contemplated where the system and a facilitator are used to triage a collaborative session. To this end, it has been recognized that an automated system should be able to apply characteristic rules to information gathered from a space 10 to generate an accurate perception of collaborative status most of the time. However, it has also been recognized that most automated systems will misperceive conditions at least some of the time.

In a hybrid system, server 170 may operate as a first system for analyzing information from collaborative space 10 to attempt to perceive conditions and facilitate related activities. If perceived conditions are resolved, the perceived condition may never be brought to the attention of the facilitator. Where a perceived condition persists for a threshold period after a related activity is performed, the perceived condition may be indicated to a facilitator in any of the ways described above so that the facilitator can independently assess how to move the collaborative activity forward. When a persistent condition is indicated to a facilitator, the indication may include information related to the automated steps (e.g., automated related activities) previously performed in an attempt to resolve the perceived condition.

For example, server 170 may examine information obtained from space 10 and estimate that a current sub-process will require two more hours than the period originally allotted for the sub-process. To indicate the estimated condition, server 170 may provide a warning notice (e.g., via screen 130a) to conferees in space 10 that the session is running behind schedule, re-identifying a target end time, summarizing previously stored content for the sub-process and indicating other content required to be stored prior to the target end time. If, after an additional hour, conference status has not changed and moved the team toward completing the sub-process, a summary record like the record shown in FIG. 5 may be generated and presented to the human facilitator at work station 104 for consideration.

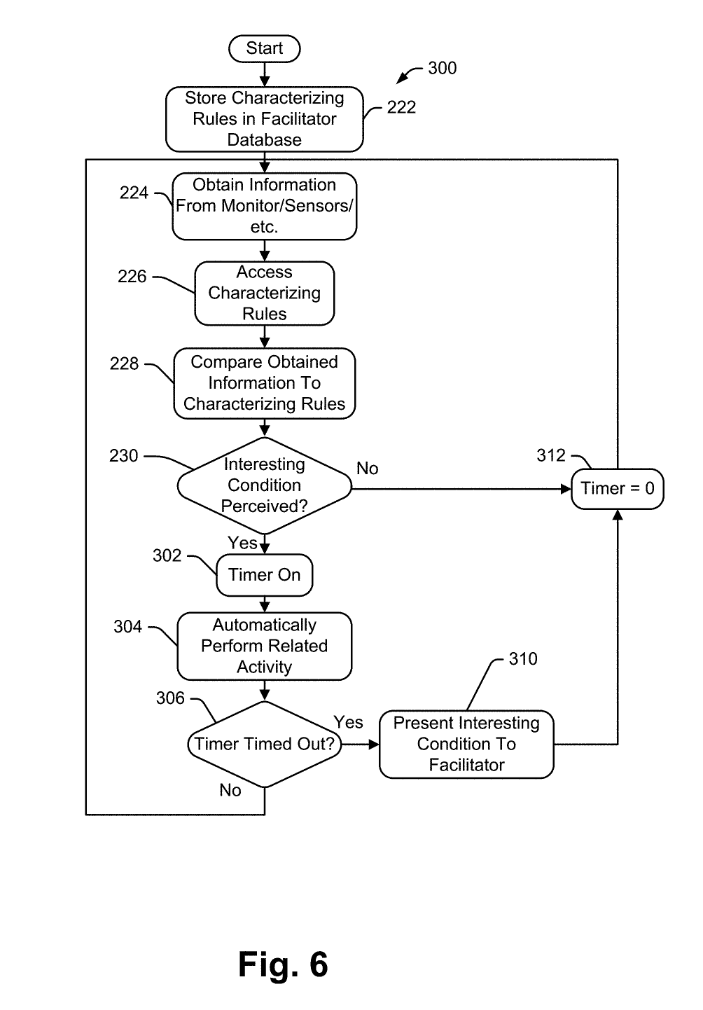

Referring now to FIG. 6, a hybrid process 300 that is consistent with at least some aspects of the present disclosure is shown. In FIG. 6, steps 222 through 230 are substantially identical to similarly numbered steps in FIG. 4 as described above and therefore those steps or blocks will not be described again here in detail. At block 230, if server 170 does not perceive an interesting condition, control passes to block 312 where a timer value is set to zero (e.g., a timer controlled by server 170 in FIG. 3 is reset), after which control passes back up to block 224.

At block 230, if an interesting condition is perceived, control passes to block 302 where a server 170 timer is activated to track the duration of a period after a related activity has been performed after which a facilitator is to be notified of the condition if the condition does not cease. At block 304, server 170 automatically performs an activity associated with characterizing rule that indicated the condition. Here, for instance, the activity may provide a warning to conferees in space 10 that they are off schedule as well as information supporting the perception. After block 304, control passes to block 306 where server 170 determines if the timer has timed out. If the timer has not timed out, control passes back up to block 224 where server 170 continues to monitor for information from space 10 indicating conditions of the collaborative activity.

If the timer has timed out at block 306, control passes to block 310 where a condition indication is presented to a facilitator at station 104. The facilitator can then respond accordingly, based on information provided in the indication or via other information about the session that has been collected and stored in an associated conference file 191 (see again FIG. 3).

In at least some embodiments it is contemplated that a summary dashboard of perceived collaboration conditions for a session may be generated and presented either on demand, or persistently or whenever interesting conditions occur to a collaboration team in a conference space (e.g., via a common large display screen) or to one or more conferees on a team via a conferee's personal device (e.g., a laptop, a tablet, a phone, etc.). Here, the dashboard may include perceived conditions and indicate how those conditions deviate from optimal conditions and may serve to encourage a team to keep up the good work and/or serve as a catalyst for the team to either seek system or expert guidance or to proceed in a different manner than in the recent past. For example, the dashboard may indicate current sub-process work product as well as work product from prior sub-processes and current conditions such as the degree of participation of each team conferee, the time remaining to complete a sub-process and remain on schedule, the perceived buy in of conferees into the ongoing process, an indicator of how well the sub-process is currently progressing based on stored work product or information recently added to common screens for sharing or on any other sensible parameter.

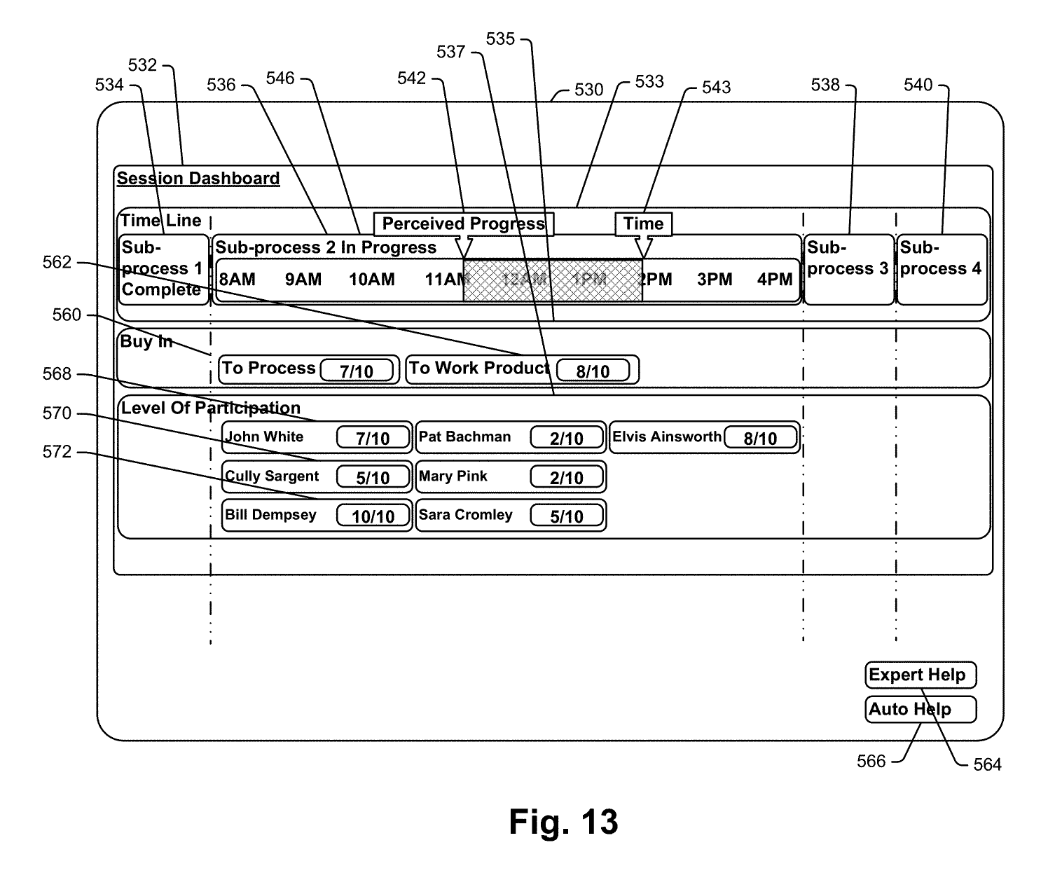

See FIG. 13 that shows an exemplary common screen dashboard view 530. The exemplary dashboard view 530 includes a time line section 533, a buy in section 535 and a level of participation section 537. The time line section 533 includes icons 534, 536, 538 and 540 for each of four sub-processes that make up an entire session. As shown, the first sub-process associated with icon 534 has been completed and is marked as such. Neither of the third or fourth sub-processes has commenced and therefore there is no special indication related to those sub-processes. The second sub-process is in progress and therefore the time line section 533 includes additional information related to the second sub-process. To this end, the additional information in the second sub-process icon 536 includes a timeline 546 corresponding to the second sub-process showing a period during which the second sub-process is to occur which is scheduled to end at a specific time, the current time 543 and a perceived progress indicator 542 indicating that, based on information collected from a session, the session has only progressed to the point that was expected to occur at the time associated with indicator 542. Thus, in the present example, the time line indicates that the session is approximately 3 hours behind schedule as indicated by the double cross hatch bar between indicators 542 and 543.

Referring still to FIG. 13, buy in section 535 indicates, for the second sub-period, the average level of conferee buy in to the process and to the work product via separate fields 560 and 562, respectively. Here, the buy in values may be calculated from answers to private queries posed by the system to the conferees. The level of participation section 537 indicates perceived levels of participation by conferees in the session. For instance, John White, Cully Sargent and Bill Dempsey have levels of participation of 7, 5 and 10 out of 10 indicating relative levels of participation (see fields 568, 570 and 572. Help icons 564 and 566 are also provided on the screen 530 and can be selected to obtain either automated or human expert guidance.

In at least some embodiments it is contemplated that a summary dashboard of perceived collaboration conditions for multiple parallel collaboration sessions may be generated by server 170 and presented to a human facilitator to help the facilitator address collaboration conditions most effectively. In at least some cases the server 170 may rank perceived conditions based on application of the characteristic rules 193 and the durations of perceived conditions. For instance, where first and second parallel collaboration sessions have the same current perceived progress problem but the first session has been stuck for an hour while the second session has been stuck for only five minutes, the server 170 may assess that the first session problem is more acute than the second session problem and rank the perceived problems accordingly. Here, it is presumed that a facilitator seeing relative perceived problem rankings, would be inclined or at least trained to address the more acute problem first followed by less acute problems.

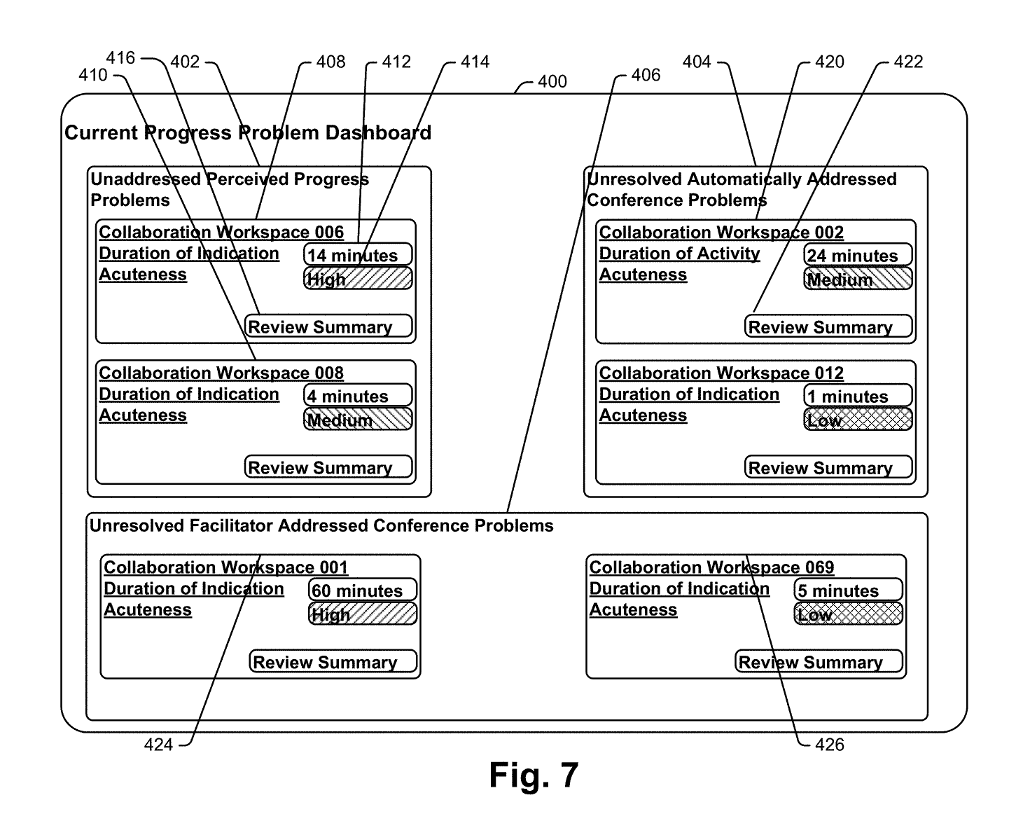

Referring to FIG. 7, an exemplary interface 400 that may be presented to a facilitator via one of the displays 180a, 180b or 180c or via a window thereon is shown. As shown, interface 400 includes a current condition dashboard including three separate sections, an unaddressed perceived condition section 402, an unresolved automatically addressed condition section 404 and an unresolved facilitator addressed condition section 406. Section 402 includes a sub-section for each currently pending unaddressed perceived condition. In FIG. 7 there are two sub-sections 408 and 410 corresponding to two currently pending collaboration conditions in collaboration workspaces 006 and 008. In addition to identifying the workspace in which a condition is perceived to exist, each sub-space 408 and 410 includes some characterizing information like how long the condition has persisted, an estimated acuteness of the problem, etc. For instance, in sub-space 408 duration and acuteness fields 412 and 414 are shown. The acuteness field 414 may be colored to quickly visually distinguish an associated condition from other conditions represented in section 402 based on relative acuteness. For instance, a highly acute condition may be colored red (as indicated by top to bottom right to left cross hatching in FIG. 7), moderately acute conditions may be highlighted yellow (as indicated by top to bottom left to right cross hatching in FIG. 7) and minimally acute conditions may be highlighted green (as indicated by double cross hatching in FIG. 7). A review summary icon 416 is also provided in each of the sub-sections 408, 410, respectively, which is selectable to access an associated report (see again FIG. 5).

In FIG. 7, condition sections are arrange by relative acuteness. Thus, for instance, in FIG. 7, highly acute conditions may be arranged at the top of section 402 while lesser problematic conditions may be arranged near the bottom of section 408.

In FIG. 7, section 404 includes a sub-section for any condition that server 170 has already automatically attempted to address via a related activity but which has yet to be resolved. In FIG. 7 there are two sub-sections 420 and 422. Each subsection 420 and 422 includes information similar to the information in sections 408 and 410 described above and therefore sections 420 and 422 will not be described again here in detail.

In FIG. 7, section 406 includes a sub-section for any condition that the facilitator (or perhaps any facilitator) has already attempted to address but which has yet to be resolved. In FIG. 7 there are two sub-sections 424 and 426. Each subsection 424 and 426 includes information similar to the information in sections 408 and 410 described above and therefore sections 424 and 426 will not be described again here in detail.

Once a condition in one of sections 402, 404 or 406 has been resolved, the condition may be removed from the dashboard view 400. Once server 170 automatically attempts to address a condition in section 402 (e.g., by providing an indication to conferees in space 10), the condition sub-section may be moved from section 402 to section 404. Similarly, once a facilitator attempts to address a condition in section 402, the condition sub-section is moved from section 402 to section 406.

In some cases it is contemplated that a facilitator or server 170 may be able to examine conference information obtained in a space 10 and assess that a collaboration session could benefit from a behavioral change of one or a small group of conferees. For instance, camera and microphone information may be used to determine that only two of ten conferees are adding an appreciable amount of substance to a session. Here, server 170 may be programmed to send “private” messages to the other eight conferees encouraging them to participate more fully. In other cases, server 170 may be programmed to send “private” messages to the two conferees driving the session and encourage them to seek input from other conferees that likely are not fully participating. In still other cases the server 170 may indicate the perceived condition to a facilitator who can then review recent session activities, identify if the activities represent a problem and then provide prodding to one or more of the conferees as the facilitator sees fit.

In still other cases, where server 170 perceives that a ten conferee session is being driven by two conferees, a related activity may cause the server 170 to instruct the conferees to break up into smaller groups to consider the sub-process being performed. Here, for instance, where first and second conferees are the ones driving the session, server 170 may break the conferees into two groups where the first group includes the first and second conferees. In this way, server 170 would force at least some of the conferees in the second group to take on leading roles which may cause an overall different result when the first and second groups subsequently resume the original session and share ideas.

In some embodiments it is contemplated that the amount of server and/or facilitator participation in a collaboration session will be able to be dialed up or down either by a facilitator or by one or more conferees in a space 10. For instance, again, assume ten conferees are participating in a session in space 10. Here, during a session, the conferees may have an unexpected revelation that they know will have the effect of causing the session to deviate from an initial time schedule. Here, the conferees should be able to dial down the facilitation aspect of the system so that they are not routinely hampered with indications of session delays. As another instance, conferees in a specific group may, based on experience with the facilitation system and an understanding of how the group works together, want less facilitation from the system.

In other cases, while characteristic rules 193 applied by server 170 may not cause server 170 to recognize an interesting session condition, conferees themselves may perceive an interesting condition. For instance, conferees may timely generate work product required by the end of a specific session sub-process but may be unclear about if the work product is sufficient to meet the groups objectives. Here, one of the conferees may dial up the facilitation level causing server 170 to apply a more rigorous or detailed rule set to assess progress. If the more rigorous rules are applied and the end result is still that the session is on schedule and the work product is sufficient, server 170 may provide encouragement for the conferees and instructions for moving to the next sub-process. In still other cases it is contemplated conferees in space 10 may be able to request a direct link to a human facilitator at any time during a session.

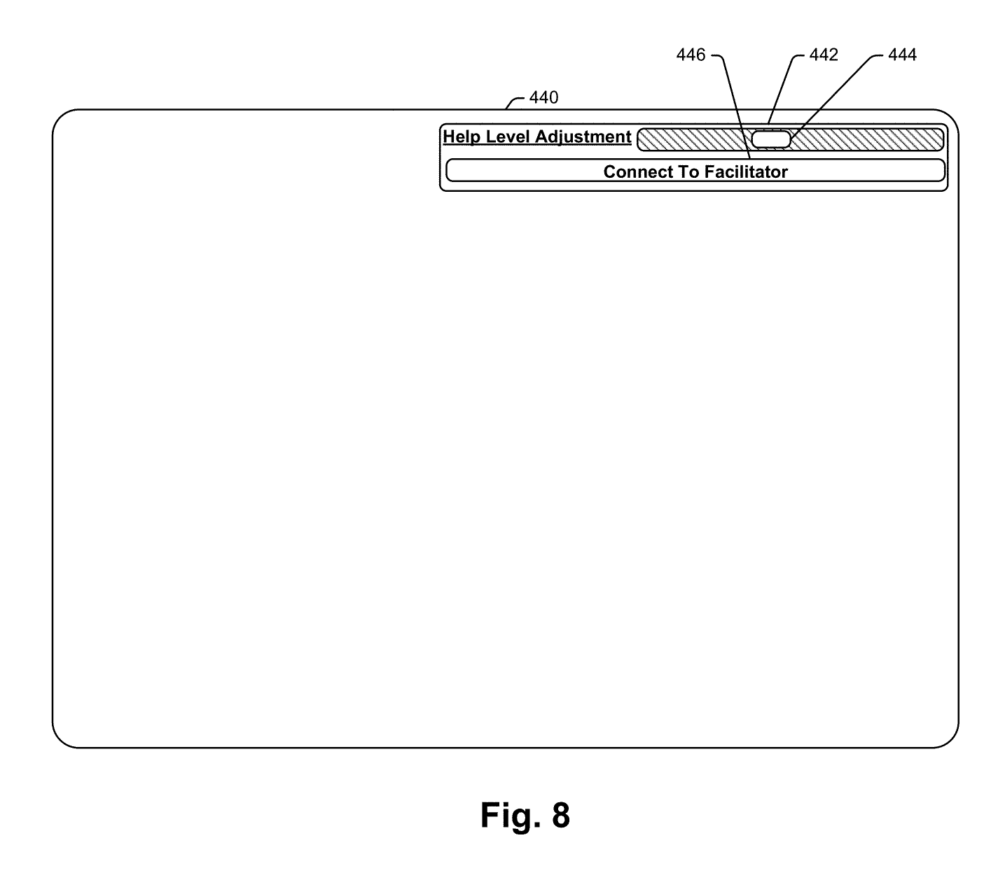

Referring to FIG. 8, an exemplary control interface 442 that may be presented via one of displays 130a, 130b or 130c is illustrated that can be used to dial help or facilitation level up or down and to request a direct connection to a human facilitator. The interface 442 includes a sliding help level adjustment button 444 that can be slid along a scale to increase or decrease the level of help desired. Icon 446 can be selected to patch a facilitator into the session via audio/video, etc.

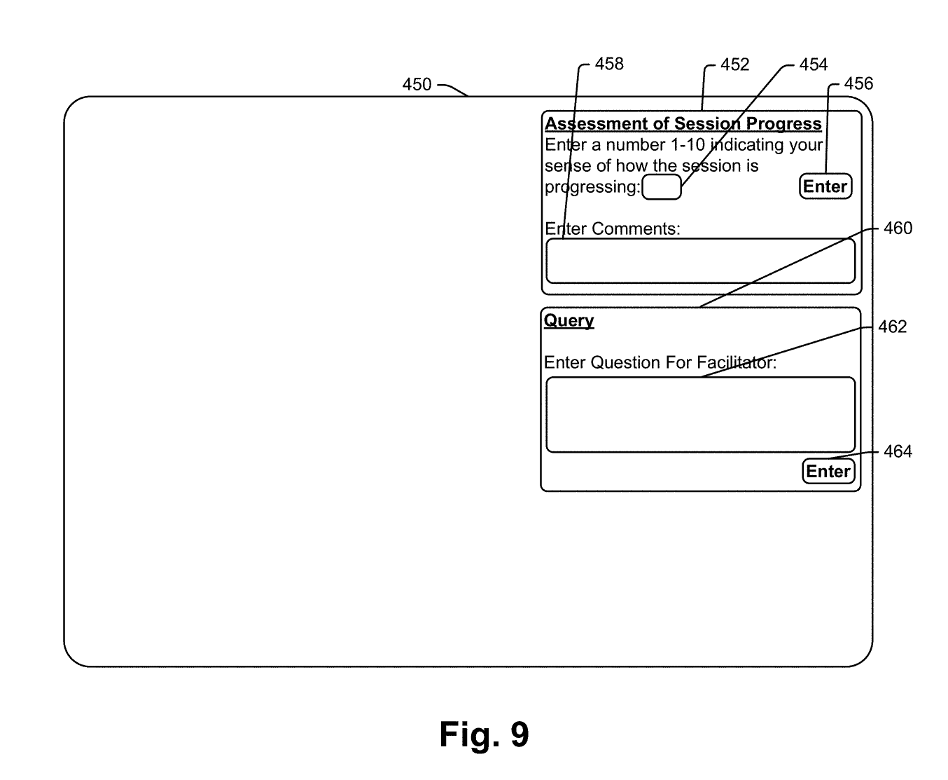

In still other cases there may be ways to obtain feedback on how conferees perceive a session to be progressing and characteristic rule sets may be applied thereto to discern appropriate related activities. Again, in many cases, humans are the best sensors I a conference space. For instance, where conferees use personal devices 124 (see again FIG. 2), conferees may be able to use devices 124 to indicate their perception of how well a session is progressing. For example, at the end of each sub-process in a four sub-process session, each conferee may be presented with a feedback screen to indicate perceived progress. To this end, see FIG. 9 that shows a personal device screen shot 450 including a feedback interface 452 where a conferee can enter a number between 1 and 10 in a field 454 and select an Enter icon 456 to indicate the conferees perception of how well a session is progressing. In some cases the interface 450 may include a comment field 458 where each conferee can enter personal comments justifying the assessment number.

Here, one characteristic rule may consider conferee feedback and, if the feedback indicates at least some threshold level of dissatisfaction among team conferees, server 170 may be programmed to carry out some suitable related activity. For instance, if five out of ten conferees enter a value of 4 or lower, server 170 may present the feedback information to a human facilitator to consider further corrective action.

In addition to being used to identify dissatisfaction during a specific session, conferee feedback may be used to continually refine the facilitation process. For instance, if 80% of conferees provide a low satisfaction rating for a specific sub-process, that information may be used to change how much facilitation occurs during the process to either step up or step down facilitation activities. For example, it may be that a human facilitator needs to routinely get involved at a specific point in a sub-process in order to transition groups of conferees through a portion of the sub-process. Server 170 may, in response to the feedback, automatically adjust an existing characteristic rule or result in server 170 generating a new characteristic rule. For instance, where dissatisfaction routinely spikes at a specific time during a sub-process, server 170 may generate a new rule such that when the specific time is approached, the rule recognizes the time based on information obtained from space 10 sensors and schedules a facilitator to provide guidance when the specific time occurs.

While conferee feedback may be solicited at the ends of sub-processes or at other intermediate times during a session, in other cases conferees may be able to indicate a progress assessment at any time. For instance, interface 452 in FIG. 9 may be presented persistently or may be accessible all the time during a session on each conferee's personal device 124 so that conferees can enter assessment information at any time they see fit.

Conferee initiated feedback may also take other forms. For instance, in at least some embodiments it is contemplated that a conferee may be able to pose “private” questions to a facilitator at station 104. For example, while a session is progressing, a conferee may be under the impression that the session is off track for some reason. Here, a conferee's device 124 may present a query interface for presenting a question to a facilitator. In this regard, see exemplary query interface 460 in FIG. 9 that includes a query field 462 and an Enter icon selectable to transmit a query to a facilitator at station 104. Here, when a conferee generates a query, server 170, in some cases, will generate a summary interface like the interface shown in FIG. 5, albeit including the received query, and will present the summary interface to a facilitator for consideration. By automatically providing the summary information to the facilitator, the process of formulating a suitable response to the query can be expedited as the facilitator can quickly review current status of the session.

In response to a query, a facilitator may respond directly and privately to the conferee that generated the query via the conferee's device 124 or may take any other suitable action. For instance, the facilitator may patch in to the session to discuss progress and any perceived problem with an entire team. As another instance, if the team is near a natural break in the current sub-process, the facilitator may choose not to intervene and to simply let the sub-process be completed and may then provide comments or suggestions after completion of the sub-process. In this case, server 170 may automatically generate a private response to the conferee that generated the query indicating that a natural break in the session is approaching and that the query will be addressed at that time.

In addition to providing information related to the current condition or status of a session in response to application of a characterizing rule 193 to a facilitator, server 170 may also identify a subset of possible actions related thereto that may be suitable responses for a facilitator. This concept is reflected in the FIG. 5 interface where selectable icons 266, 268, 270, 272, 274 and 276 represent optional activities that may be selected by a facilitator in response to a perceived condition.

Where one or a group of facilitators routinely select the same option to deal with the same perceived condition, processor 170 may be programmed to automatically modify the activities associated with the perceived condition so that, for instance, instead of getting a facilitator involved when the perceived condition is identified in the future, server 170 responds automatically, if appropriate, to the condition. For instance, assume that whenever a first perceived condition occurs, a first facilitator always, at least initially, selects an icon 274 (see FIG. 5) to play a video clip 1 in a space 10. Once the pattern is repeated at least some threshold number of times or once some other criteria suitable for identifying a pattern is satisfied, server 170 may be programmed to automatically play the clip associated with icon 274 without requiring the first facilitator to consider the matter. The automatic step may or may not be indicated to the facilitator.

Thus, automated systems, expert facilitator based systems and hybrid automated-facilitator systems have been described above. There is yet another type of system contemplated where one or more conferees within a space 10 may play a role akin to a remote expert facilitator when no remote facilitator is available. To this end, it has been recognized that even in sessions including groups of conferees, often times one or a small subset of conferees will take leading roles during a session. Often times the leading roles may be simply a function of strengths of personalities while in other cases conferees may take leading roles if they have more experience with collaboration techniques. In any event, information monitored and collected in a space 10 can often be used to identify one or a small group of conferees that assume leading roles.

Once a conferee is identified as a leader, a system server may be programmed to indicate interesting conditions to the leader via the leaders personal device 124 in an manner akin to the indications presented to the remote expert described above. The indication may simply identify a perceived condition or may include optimal related activities selectable by the leader to drive the process forward. For instance, when the server perceives that a sub-process will likely end in the next thirty minutes, the server may indicate the condition to the leader and provide the option to play an introductory video clip designed to transition to the next sub-process. As another instance, when the system perceives that there is likely too little input from several conferees, the system may indicate the condition to the leader to prod the leader into directly seeking comments from other conferees. As still one other instance, if the system perceives that a sub-process has slowed substantially, the system may provide an indication to the leader indicating the delayed condition, reminding the leader of a target time in which to wrap up the sub-process and perhaps suggesting a particular video to be played to overcome the perceived impasse.

While a system may automatically discern a leader or leaders among conferees in some cases, in other cases one or a set of conferees may be manually designated as leaders at the beginning of a session or at the beginning of each session sub-process. In this case, perceived conditions would be reported to the manually designated leaders.

In some cases, the hybrid system may include a local leader as well as automated and remote facilitator aspects. Here, for instance, some conditions may result in automated related activities, some conditions may result in local leader based indicators and activity options and other conditions may result in remote facilitator indications and activity options. Thus, multiple level triage systems are contemplated.

In systems including a remote facilitator that is available to provide guidance to a plurality of simultaneous sessions, at times there may be no perceived interesting conditions. At these times it is contemplated that server 170 may cycle the facilitator through reports for each simultaneous session so that the facilitator can independently assess session conditions. In at least some cases the cycle of reports may start with reports for sessions in which interesting conditions were most recently perceived. In other cases the cycle of reports may start with reports for sessions in which interesting conditions have not been recently perceived and addressed.

While the systems described above are described in the context of a conference room including re-arrangeable furniture artifacts, this disclosure should not be so limited. For instance, a facilitation system may be implemented in a conference space that has fixed artifacts, in which case the system would be modified so that the system would not present any guidance on how to re-arrange the artifacts in the space to be optimized for different sub-processes.

As another instance, conference spaces are contemplated where a space may be divided into a plurality of smaller conference spaces where the smaller spaces are optimized to facilitate specific sub-processes. Here, for example, where a session of a specific type includes first through fourth general sub-processes, there may be a separate and optimized furniture artifact arrangement for each of the four sub-processes. In this case, four separate spaces may be configured where each space is optimized for a different one of the four sub-processes and, at the end of any one of the first through third sub-processes in one of the first through third spaces, the system may instruct a team to take a short break and then relocate to the next of the second through fourth spaces. When a team moves from one space to another, the system may be programmed to automatically associate the session content including work product, collected session information, etc., to the next space so the system would, in effect, welcome the team to the next space, albeit where the arrangement of content would likely be different given the different artifact arrangement in the next space as well as the different sub-process to be performed (e.g., see again that when moving from one sub-process to the next, the system may re-arrange content to optimize the content for the next sub-process as in FIGS. 11 and 12).

While a small set of related activities that may be performed when an interesting condition is perceived in a conference space is described in the embodiments discussed above, many other related activities are contemplated including but not limited to suggesting intellectual rest (e.g., a 10 minute break), suggesting a different type of intellectual stimulus (e.g., initiating an intellectual game), suggesting a physical break such as a certain type of exercise (e.g., stretching, yoga, etc.), summary of significant breakthroughs or milestones, simple pinging of conferees or an entire team, bringing in an outside coach or facilitator, summarizing work product, rearranging work product to suggest a different point of view, querying team members about buy in to work product or overall process, querying team as to how they are feeling, instructing a team to rearrange furniture artifacts, providing a video, providing content to read so a team better understands a session process or a sub-process, bring in an outside employee of an organization to take a fresh look at what has occurred, change one or more conferees, clear away stale or unimportant information, perform a real time patent search on perceived concepts or on concepts that the team comes up with, etc.

B. Room as Participant

In some cases, in addition to suggesting best practice session processes or procedures, the system may also be programmed to automatically augment session content. To this end, the system may be programmed to analyze content of various types generated by session conferees to identify persistent or consistent topics and may then be programmed to search various databases for potentially relevant information that can be automatically shared with conferees. For example, where the word “Australia” is verbally pronounced within a conference space several (e.g., 5 or more) times and appears in content presented via common display screens several (e.g., 5 or more) times within a threshold period (e.g., 10 minutes), the system may recognize “Australia” as a topic of interest. The system may also recognize the phrase “world cup” in session content. The system may then use the phrase “Australia world cup” as a search phrase in an internet search engine to gather information related thereto to be presented to a session team. Here, in at least some cases the content may be presented to the team via one or more of the common displays, in full form, in summary form, or as a selectable icon to access the full form.

In other cases, after potentially useful content is identified, the system may be programmed to suggest the content to one or a sub-set of conferees via the conferee's personal devices (e.g., tablets, laptops, phones, etc.) for consideration and possible sharing with the larger team. Where a conferee agrees that the augmented content would be of interest to the larger team, an interface on the conferee's device would enable sharing of the content via one or more of the common display screens 130a, 130b, 130c.

In addition to searching the internet for possibly interesting content, the system may also be programmed to automatically search other databases such as, for instance, an organization's LAN or WAN or an organization's document database.

Where a conferee generated a document that the system identifies as possibly interesting to a team, the system may be programmed to present the document to only the conferee that generated the document instead of to the entire team. By presenting the possibly interesting document to the conferee that generated the document, the person with the most knowledge about the document pre-vets the document and can make an informed decision about relevance prior to presenting the document to others on the team. In addition, by presenting a document only to the conferee that generated the document, potentially embarrassing or sensitive documents can be rejected and remain secret.

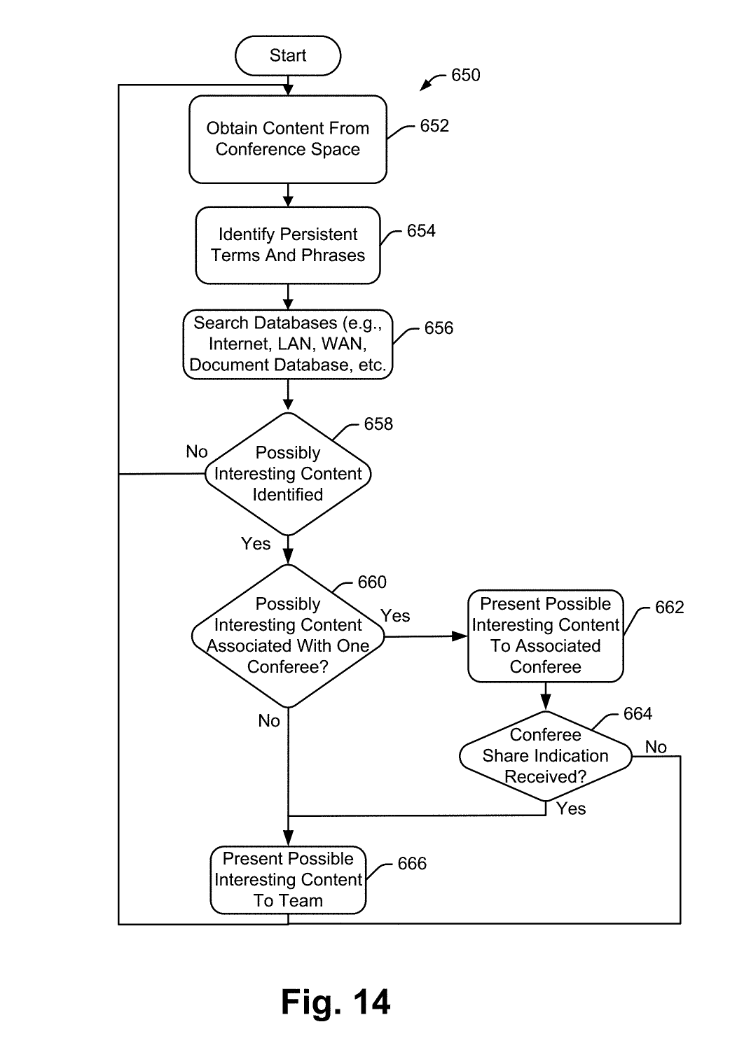

Referring now to FIG. 14, a session augmenting process 650 that may be performed by the one of the systems described above is illustrated. Beginning at block 652 a system server obtains session information from system sensors and cameras (see again FIG. 2). At block 654 the server uses the obtained information as well as perhaps information derived from the obtained information to identify one or a plurality of system terms and phrases that seem to be main themes in the session. At block 656 the server accesses one or more databases and searches for content that is associated with the identified terms or phrases. At decision block 658 the server determines if any possibly interesting content was located. Where no possibly interesting content is located, control passes back up to block 652. Where possibly interesting content is located at block 658, control passes to block 660 where the server determines if the possibly interesting content is associated with a single conferee (or a subset of the conferees on the team).

Referring still to FIG. 14, where the content is not associated with a particular conferee, control passes to block 666 where the possibly interesting content is presented to the full tea via one of the common display screens 130am 130b or 130c after which control passes back up to block 652 where the process continues to loop. At block 660, where the possibly interesting content is associated with one of the conferees, control passes to block 662 where the content is presented to the associated conferee via, for instance, a personal device like a laptop, a cell phone, a tablet type device, etc. At block 664, the system monitors for a selection on the conferee's device indicating that content presented thereby should be shared with the entire team. Where the content should be shared with the entire team. If a share indication is received, control passes from block 664 to block 666 and the content is shared with the team via one or more of the common screens. If the conferee does not indicate that the content should be shared or indicates that the content should not be shared, control passes back up to block 652 where the process continues.

Although not shown, after the system identifies possibly interesting content once based on information collected from a conference space and that information is indicated to at least one or perhaps all of the conferees, the system may be programmed to store an indication of the content so that the system does not continue to search for, find and present the content. One or more conferees may indicate that some or all of the presented content is interesting (e.g., via selection on a screen, voice, etc.) and there after the system may continue to use the interesting content in searches cobbled together with other qualifying terms and phrases generated during subsequent portions of a session.

In still other cases, after persistent or popular terms or phrases have been identified at block 654, the system may present the terms or phrases to one or all of the conferees in a space and query whether or not the terms should be searched prior to performing the database search. If a conferee affirms that a search should be completed, control may pass to block 656 where the search commences. If a conferee indicates that a suggested term or phrase should not be searched, control would pass back up to block 652 where the process would continue.

While the system is generally described above as one where a system may offer suggestions or guidance for how to move a session process along, in at least some cases the system may provide alternative suggestions, present information related to the value of each alternative suggestion and allow the conferees on a team to decide which alternative to pursue. Here, for instance, alternatives may include playing an instructional video clip or taking a ten minute break to participate in a regulated physical activity. The system may monitor which alternative is selected as well as the perceived effectiveness of the alternative on sub-process and overall session work product, efficiency, buy into work product and the session process, etc. This perceived information can then be used to automatically change the related activities based on which activity has the best overall results. For instance, if the physical break has superior results when compared to the video over time, the system may adapt to suggest the physical break first and turn to the video only if the break is perceived to not work well in a specific instance.

It has been known for a long time that different people have different strengths and weaknesses when it comes to collaborating with others. For instance, some innovation experts classify conferees in groups into different categories based on strengths and perceived weaknesses. Ten exemplary categories include an anthropologist, an experimenter, a cross-pollinator, a hurdler, a collaborator, a director, an experience architect, a set designer, a storyteller and a caregiver. A person classified as an anthropologist is a person who ventures into the field to observe how people interact with products, services, and experiences in order to come up with new innovations. Often times these persons are extremely good at reframing problems in new ways and usually share such distinguishing characteristics as the wisdom to observe with an open mind, empathy, intuition; the ability to “see” things that have gone unnoticed; and a tendency to keep running lists of innovative concepts worth emulating and problems that need solving. An experimenter celebrates the process, not the tool, testing and retesting potential scenarios to make ideas tangible. A calculated risk-taker, an experimenter models everything in order to efficiently reach a solution. A cross-pollinator draws associations and connections between seemingly unrelated ideas or concepts to break new ground. Armed with a wide set of interests, an avid curiosity, and an aptitude for learning and teaching, a cross-pollinator brings in big ideas from the outside world to enliven their organization.

A hurdler is a tireless problem-solver who gets a charge out of tackling something that's never been done before. When confronted with a challenge, a hurdler gracefully sidesteps the obstacle while maintaining a quiet, positive determination. A collaborator is the rare person who truly values the team over the individual. In the interest of getting things done, the collaborator coaxes people out of their work silos to form multidisciplinary teams. More of a coach than a boss, a collaborator instills their team with the confidence and skills needed to complete the shared journey. A director has an acute understanding of the bigger picture, with a firm grasp on the pulse of their organization. Subsequently, a director is talented at setting the stage, targeting opportunities, bringing out the best in their players, and getting things done.

An experience architect is a person relentlessly focused on creating remarkable individual experiences. This person facilitates positive encounters with your organization through products, services, digital interactions, spaces, or events. An experience architect maps out how to turn something ordinary into something distinctive every chance they get. A set designer looks at every day as a chance to liven up their workspace. They promote energetic, inspired cultures by creating work environments that celebrate the individual and stimulate creativity. To keep up with shifting needs and foster continuous innovation, a set designer makes adjustments to a physical space to balance private and collaborative work opportunities. In doing so, this person makes space itself one of an organization's most versatile and powerful tools. A storyteller captures our imagination with compelling narratives of initiative, hard work, and innovation. This person goes beyond oral tradition to work in whatever medium best fits their skills and message: video, narrative, animation, even comic strips. A caregiver is the foundation of human-powered innovation. Through empathy, they work to understand each individual customer and create a relationship.

While some people have characteristics that are a blend of some of the above, most people have a prominent persona that can be perceived as the person works with others during a collaboration session.

In at least some embodiments of the present disclosure it is contemplated that the system described above will be able to monitor conferee participation in a session and classify each participant into one or two or a small group of the personas supported by the system. Then, the way in which the system interacts (e.g., searches for supplemental content, presents content, presents guidance, etc.) with the group can be tailored to the strengths and weaknesses of the group. For instance, where a collaboration team lacks a hurdler persona that can side step problems to move toward results, the system may be programmed to take on the hurdler role and provide more directed guidance to the team during a session. As another instance, where a team lacks an anthropologist that has a broad range of knowledge of many disciplines to draw on when coming up with new ideas, the system may be programmed to take on the anthropologist role and perform more searching of peripheral resources in order to trigger original thought amongst the team. In other cases where a team includes an anthropologist persona, the system may present new, unusual or off beat ideas, content or concepts to the anthropologist alone so that the anthropologist can consider the presented information and potentially advocate for a new or different point of view. The system may provide different information to different team members based on their perceived personas. Thus, the system may facilitate sessions differently and/or obtain different content and present the content differently based on the mix of personas in a conference space.

The system may play several roles at once if a team lacks several different personas and which personas are provided may be a function of the type of activity occurring in a space. For instance, where a single person is presenting content to other conferees in a space, the system may take the role of a collaborator as opposed to an anthropologist or a hurdler.

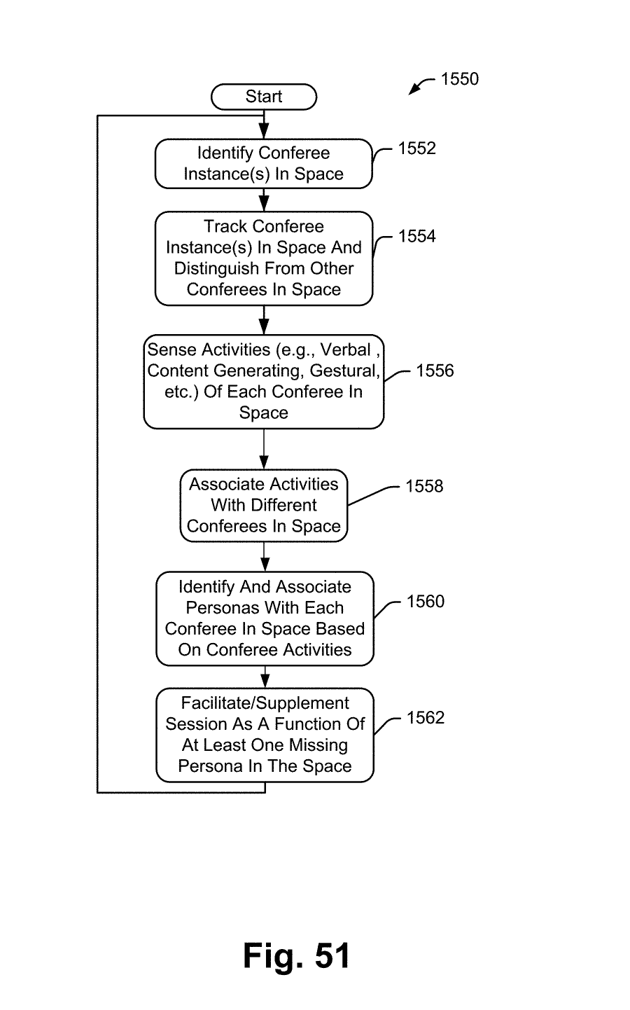

Referring to FIG. 51, a process 1550 for identifying missing personas in a conference space and interacting with a team of conferees within the space as a function of at least one missing persona in the space is illustrated. Referring also and again to FIG. 2, at block 1552 server 122 identifies conferees within the space. Conferee identity may be determined in any of several different ways known in the art including via biometric sensors, interaction with smart phones, tablets or other conferee devices upon entering the space or when present within the space, log in processes performed by conferees to be associated with the space, etc. At block 1554 server 122 tracks locations of the conferees within the conferencing space via cameras, presence sensors or some other types of devices. At block 1556, server 122 receives information from the cameras, microphones, etc., in the space about activities of conferees within the space and at block 1558 the activities are associated with the different conferees in the space. For instance, where a conferee is at a location where a verbal comment emanates from within a space, the comment is associated with the conferee at the location. As another instance, where a conferee is at a location adjacent display 130b when content is added to the display via touch, the content is associated with the specific conferee. At block 1560 server 122 uses the content obtained from within the space to characterize each of the conferees by persona (e.g., anthropologist, experimenter, hurdler, etc.) by applying a rule set designed to distinguish one conferee persona from another. At block 1562, the server 122 modifies the way the server interacts with the conferees to provide one of the personas that the conferees lack.

Which content generated in a space is used to drive automatic searching may be dynamically changed as a function of time or activities that occur in a conference space. For instance, while a conference space may have content presented all over a large space, it may be clear that conferees are focused on one relatively small area of the presented content. Focus may be determinable based on images of conferees generated within the space. In this case, the system may only use the content being focused on to develop automatic search queries. In the alternative, the content focused on may be used as primary content that is more heavily weighted than other content presented within the space when formulating automated search queries.

As another instance, more recently generated content, audio, gestures, etc., may be used to formulate automated search queries. For instance, while content in a space may be heavily associated with volcanoes in general, if content in the last half hour has focused on hurricanes, automated queries may be more focused on hurricanes than on volcanoes.

C. Digital Echo

Digital content is useful when conferees share content on common display screens within a space for several reasons. For instance, digital content often times can be selected and moved within a space by selecting and dragging the content from one location to another on a display screen to rearrange content. As another instance, digital content is useful because it can be recreated at a different time or, in at least some cases, can be recreated at different remote locations so that local and remote conferees can view the exact same information at the same time.

As still one other instance, digital content tends to clean up a conference space by requiring content to be represented on flat common display screens as opposed to in a hard copy form on paper that can be frayed, ripped or otherwise damaged in various ways. For instance, many conference spaces where people collaborate on projects become cluttered with flip chart sheets and “Post It” type notes that, over time, may become layers thick as content is moved about a space during generation, brainstorming, presentations, etc.

One other advantage of digital content as opposed to analog content is that when content is digital, a processor can analyze the content for various purposes. For instance, in the case of analog paper based charts, notes, etc., while conferees may be able to associate content on notes with adjacent flip charts, no processor can do so until all of the chart and note content is digitized. Thus, for instance, even scripted text on a hand written note can be digitized into an image and the image content can then be analyzed using an optical character recognition program to identify the meaning of the content which can be used for associative purposes thereafter.

While digital information is useful for various reasons, it has been recognized that many people prefer pen and paper to current digital interfaces. To this end, while great strides have been made in creating digital input devices like tablet devices, touch screen computers, smart phones, etc., that can be used to scribble a note or quickly draw an image, anyone who has used current products knows that those products do not have the feel of paper and a pen when being used. For instance, often times digital ink that is generated on a screen does not accurately follow the tip of a writing device (e.g., a stylus or the like). As another instance, often there is some latency between when a stylus tip moves on a screen surface and when digital ink is generated on the surface. The end result is that these input devices do not feel natural in the sense that a pen and paper feel natural to use and many people shy away from using digital input devices. Hereinafter, to distinguish from digital data and digital input devices, the data generated via pen and paper and a pen and paper will be referred to generally as “analog” data and analog input devices or tools.

One other problem with digital content is that digital content interfaces are unnatural. To this end, with flip charts and post notes (e.g., “Post-It” notes) that include actual analog content on paper sheets, it is completely intuitive for conferees to physically grab a sheet with content and move that content from one location to another. Once that content is represented digitally, an interface has to be provided to select the content and then to move the content within a space. While selection and dragging on a small screen to move digital content is somewhat intuitive, selecting and moving content on a large screen (e.g., 10 or more foot diameter) or from one screen to another (e.g., screens on opposite sides of a room) has not been well thought out.

It has been recognized that the advantages of both analog input devices and digital data can be had by providing a system that allows conferees to use analog input tools to generate content where the content is then converted into digital data. Various ways of converting the analog content to digital content are contemplated. In at least some cases an analog device can be moved around within a space and the digital data may move along with the analog data within the space. In general these systems capture analog data placed by pen on a post note (e.g., a Post It note) or the like and convert that data to digital data. Then, when the analog post note is moved to some location within a conference space, the digital data is associated with the location in the space at which the associated analog note is posted at. The post note can be moved about many times within a space and the digital content moves along with the analog tool within the space.

In at least some embodiments, when a conferee removes an analog post note, the system may present a digital post note that is a mirror image of the related analog note that was removed at the location from which the analog note was removed. Here, if, after removing an analog post note from a first location, the conferee places the post note at a second location, the system may remove the digital post note from the first location and associate the digital content with the second location. If, after removing an analog post note from a first location, the conferee does not place the analog note at a second location, the digital note may persist at the first location.

If a digital note persists at a first location after removal of an analog note, in at least some cases the system may monitor for some gesture that the digital note should be removed. For instance, the system may monitor for a conferee to make an “X” across a digital note to indicate that the note should be removed. Another gesture may include a double tap on the note to indicate that the note is being moved to another location. For example, a conferee may double tap on a note at a first location, move to a second location and double tap the second location to indicate that the note should be moved to the second location. Movement of the conferee between the first and second locations may be tracked by cameras in the space. Thus, a first double tap or other gesture would start a tracking process and a second tap would end the tracking process and place the digital note at the location of the second double tap. Local adjustments of the locations of digital notes may be accomplished via selection and dragging.

In some cases a selected note will be highlighted or otherwise visually distinguished so that a conferee knows when a note has been properly selected and knows which note has been selected. Thus, analog tools can be used to generate digital content and both analog and digital notes can be moved about within a conference space to move digital content within the space. Because this concept generates a digital mirror image of analog content that can be moved about within a space like an analog note, this concept is generally referred to herein as a “digital echo” concept.

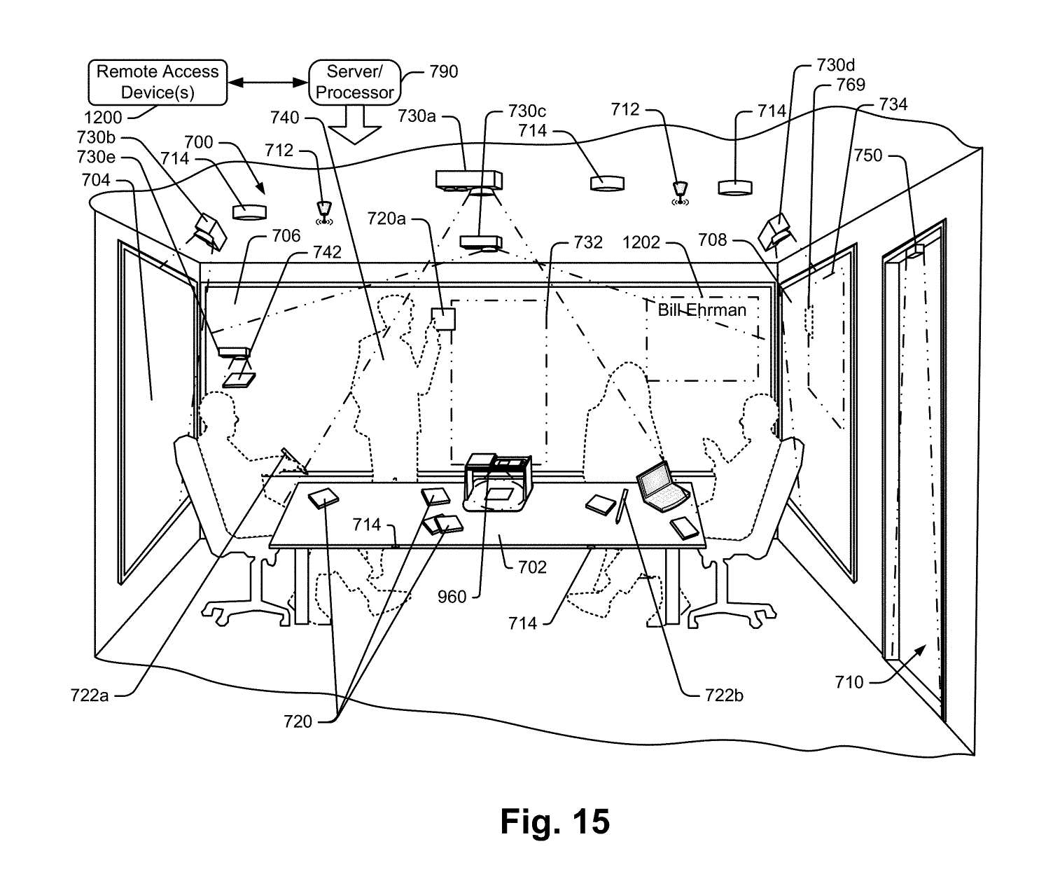

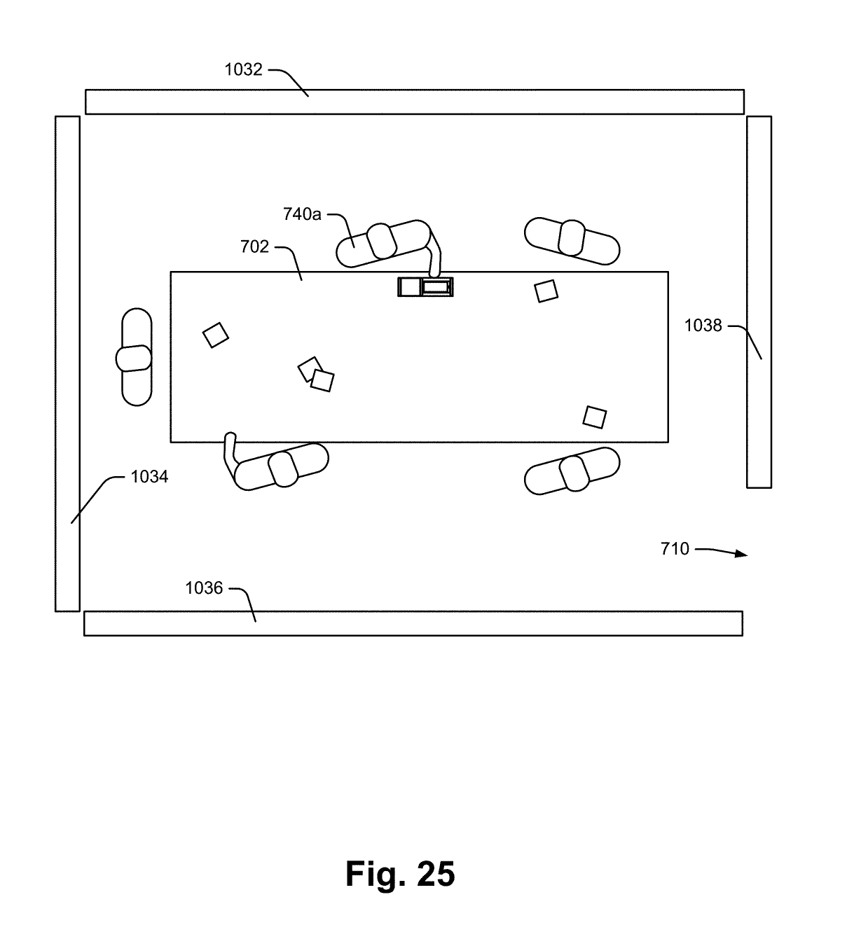

Referring now to FIGS. 15 and 25, the digital echo concept will be described in the context of an exemplary conference space 700 that is formed by the four walls 1032, 1034, 1036 and 1038 (only three walls shown in FIG. 15) that close off the space 700 from a general ambient. The exemplary room or space 700 includes an entry way 710 that may include a door for closing off the space 700 from the ambient. Space 700 has been configured to be used by conferees during collaboration or other types of sessions and, to that end, includes large flat panel displays 704, 706 and 708 that cover large portions of the internal surfaces of the space defining walls. In at least some embodiments a fourth or more displays may be mounted on the other enclosing wall(s) for use by conferees. Although not shown, the displays may cover an entire wall or multiple walls within space 700. In other embodiments the display surfaces or presentation spaces may be supported for movement within space 700 on large carts or the like or the displays themselves may be sufficiently light weight that they can be moved about within space 700 to be in other relative juxtapositions with respect to the walls and to each other. Unless indicated otherwise the digital echo concept will be described in the context of the display configuration shown in FIG. 15.

Referring still to FIG. 15, a large conference table 702 is located within space 700 and provides a large horizontal table top surface for use by conferees arranged thereabout in task chairs. In FIG. 15 four conferees are shown in phantom and one is labeled 740. Wireless access points 712 are mounted within a space ceiling for communicating with various electronic devices within space 700. For instance, wireless laptops, tablet devices, smart phones, etc., may communicate with access points 712 for various reasons. In the present case, in at least some embodiments, access points 712 may be used to obtain digital information associated with analog content from one or more devices as will be explained in detail hereafter.

A conference server/processor 790 is provided that links to all of the devices associated with space 700 including the access points, RFID readers and other devices to be described later like cameras, presence sensors, etc. Server 790 runs various software programs that are consistent with different aspects of the present disclosure. While server 790 is shown as a single server component, in other embodiments, server 790 may include a plurality of servers that cooperate to perform various functions and processes.

Referring yet again to FIG. 15, in at least some embodiments RFID reader devices 714 are also supported within the ceiling structure of space 700 for reading RF identification tags within the space 700 and determining the locations of those tags. Tag location can be determined in various ways including signal strength triangulation where signals received by several readers 714 from a single tag can be used to statistically identify the location of the tag. In FIG. 15 several RFID reader devices 714 are also built into the edge of the table 702 and other locations within space 700 are contemplated.

Referring still to FIG. 15, post note pads 720 are provided within space 700 to be used to generate analog post notes for sharing and memorializing information among conferees. Here, the intention is that the post notes 720 be used like conventional post notes to add comments at specific locations within space 700 and more specifically to add comments to specific content presented within space 700. To this end, each pad includes a stack of 100 or so notes where each note can be torn off the pad to reveal a semi-sticky glue along a top edge of the back surface of the note. The note can be stuck to any location within space 700 and more specifically to any location on one of the display surfaces of displays 704, 706, 708.

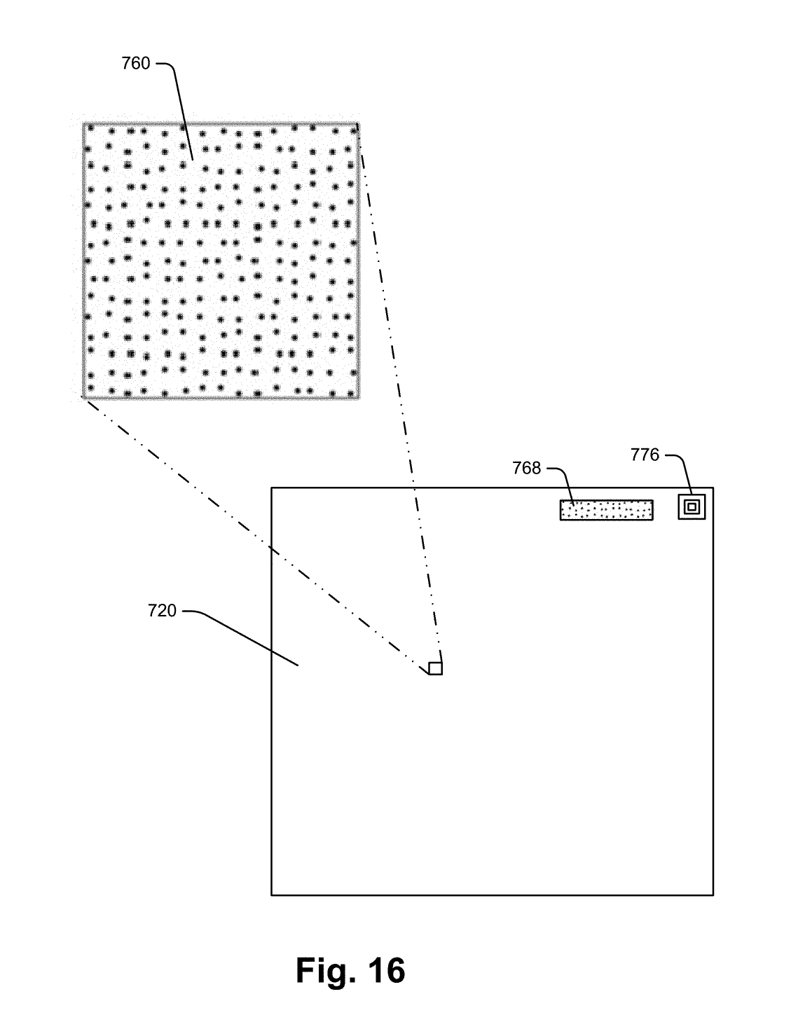

Referring also to FIG. 16, in at least some embodiments each note 720 includes a dot pattern 760 on its front face where the pattern dots are small and are of a color that is similar to a back ground color such that the human eye has difficulty perceiving the dot pattern. While a person cannot easily perceive the dot pattern, a camera can be designed to obtain an image of the pattern which can be analyzed by software to distinguish any location on the note from other locations.

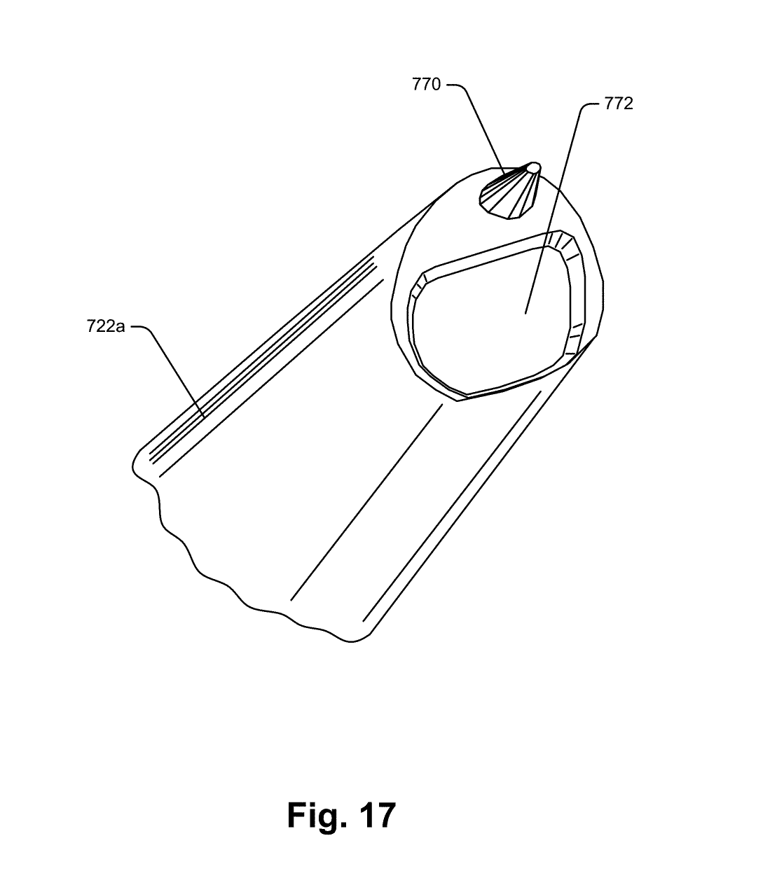

Referring again to FIG. 15, special pens 722a, 722b may be used by conferees to add content to the front surface of a note 720 where each pen has a built in camera for obtaining images of local portions of the note dot pattern that can be used to determine the location of the pen tip and hence the ink being applied by the pen on the front surface of the note. To this end, see also FIG. 17 that shows a tip end of one of the special pens 722a that includes ink tip 770 and a camera lens 772 where the pen camera is located behind the lens 772 and is focused on a location proximate the ink tip 770. Images generated by the pen are analyzed to identify the code proximate the pen tip and a signal indicative of the code is transmitted wirelessly to the access points 712 within space 700. A processor linked to the access points receives the signals and uses the signals to identify the location of the pen tip on the note and to create a digital representation of the analog content applied by the ink tip to the note. Pens for sensing location on a note or flat surface using a dot pattern and a exemplary dot patterns have been used in other products like the Eno whiteboards manufactured and sold by PolyVision, Inc. which should be referred to for a better understanding of this technology.

Referring again to FIG. 16, in at least some embodiments, each note 720 includes an RFID tag 776 on a front or preferably a rear surface that can be used to uniquely distinguish one tag and associated note from others. Any type of RFID tag may be employed that is relatively thin and, in some cases, flexible so that the tag does not appreciably affect the way the note receives ink. Each tag stores a note specific identifier code that can be obtained and used to distinguish the specific note from other notes.

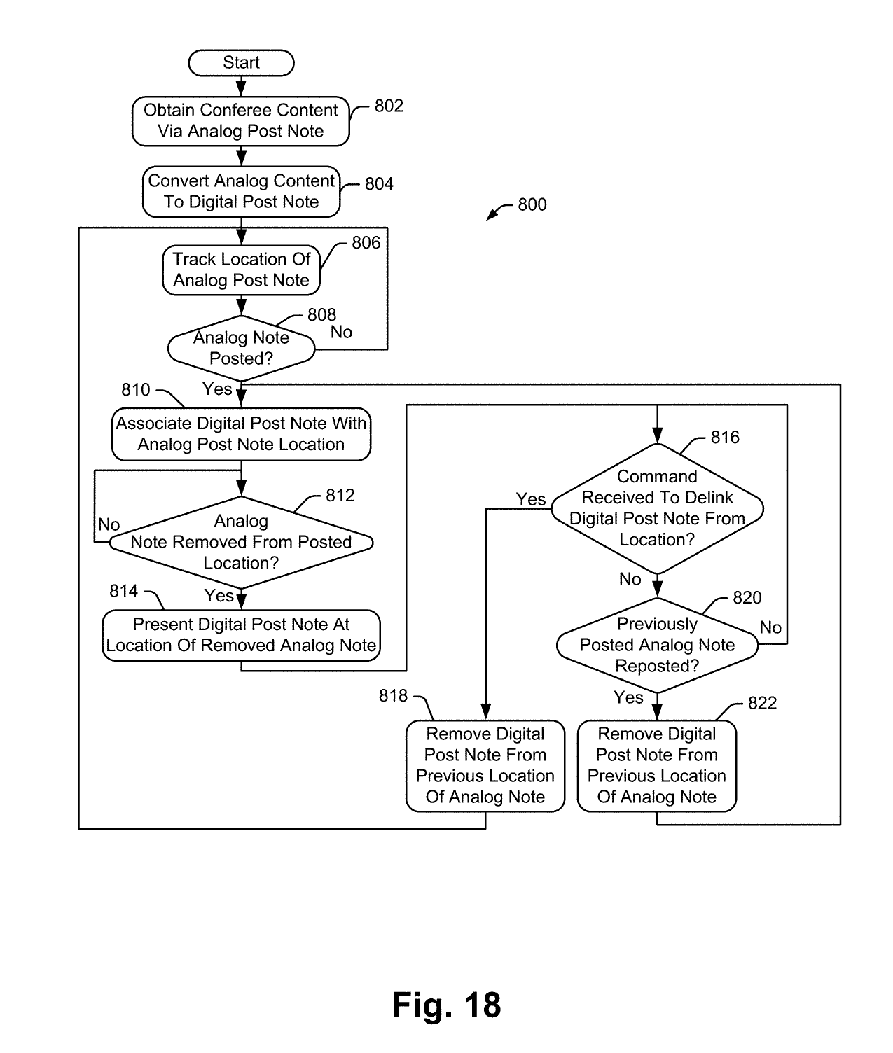

Referring now to FIG. 18, a process 800 that may be performed for managing analog and digital post notes 72a in a space 700 is illustrated. At block 802 a conferee uses a pen to generate content (e.g., analog content”) on the front surface of one of the post notes 720a. Referring again to FIG. 15, at block 804 the system converts the analog content to a digital post note. A digital post note is a virtual note that has an appearance that mirrors the appearance of an associated analog note. At least initially, in at least some embodiments, a digital post note does not appear on the common display screens and instead its contents is simply stored as a digital note for subsequent posting. Consistent with the FIGS. 16 and 17 note and pen described above, the conversion to digital may be based on Eno type technology where the location of ink is determined via a pen based camera.

In addition to capturing digital content on an RF tagged note, the system has to be able to determine identity of the note on which the analog content has been applied. In some cases the note may include an identifier that the pen can use to identify the specific note. For instance, referring to FIG. 16, in some cases a note identifier dot code 768 may be provided along an edge of the front surface of the note that specifies the note identity. In other cases a note identifier may be provided within the general Eno type dot code pattern. Where a code is presented on the note, the pen in FIG. 17 may be used to read the code. In still other cases RFID readers may be built into the table top for reading tags 776 and identifying which tag is on the top of a pad as the one receiving analog content. Other ways of identifying specific post notes are contemplated.

Referring still to FIG. 18 and again to FIG. 15, at block 806 the server 790 tracks the location of the post note 720a (e.g., of the analog input device) via triangulation of the RF tag 776 (see again FIG. 16) using signals from access points 712. When a conferee 740 attaches the note 740a to a specific location on one of the display screens 706, the system recognizes that the note has been posted at block 808. For instance, once the note is proximate one of the display surfaces and the note has not moved for some threshold period of time (e.g., the note location has persisted), the system may be programmed to determine that the note has been posted at its current location. Note location can be determined generally and in at least some cases specifically by using RF signals. In other cases where screens 704, 706, 708 are touch screens so that specific locations touched on their surfaces can be determined, general location may be RF based and specific location may be touch based. Thus, for instance, as a conferee moves a note to and posts the note at a screen location, RF signals may be used to generally track the note location and recognize that the note is stationary after posting and while a conferee moves away from the note and then the specific location of the note sensed when the conferee posted the note can be determined via the location sensing processor in screen 704.

At block 810, server 790 associates the digital post note with the location of the posted analog post note. At this point the digital post note is stored and is associated with the location of the associated analog note but still has not been represented on the common screens in any fashion.

It has been recognized that once an analog note is posted, a conferee may want to do one of four basic things with the note. First, the conferee may want to keep a persistent digital instance of the posted note at the posted location even after the analog version of the note is removed. Second, the conferee may want to move the posted note to a second location. Third, the conferee may want to remove and discard the posted note. Fourth, the conferee may want to edit the posted note. Rules for managing notes as conferees add notes, move notes, discard notes and edit notes are required for the system to operate properly. One exemplary set of note managing rules is presented at the end of the process shown in FIG. 18.

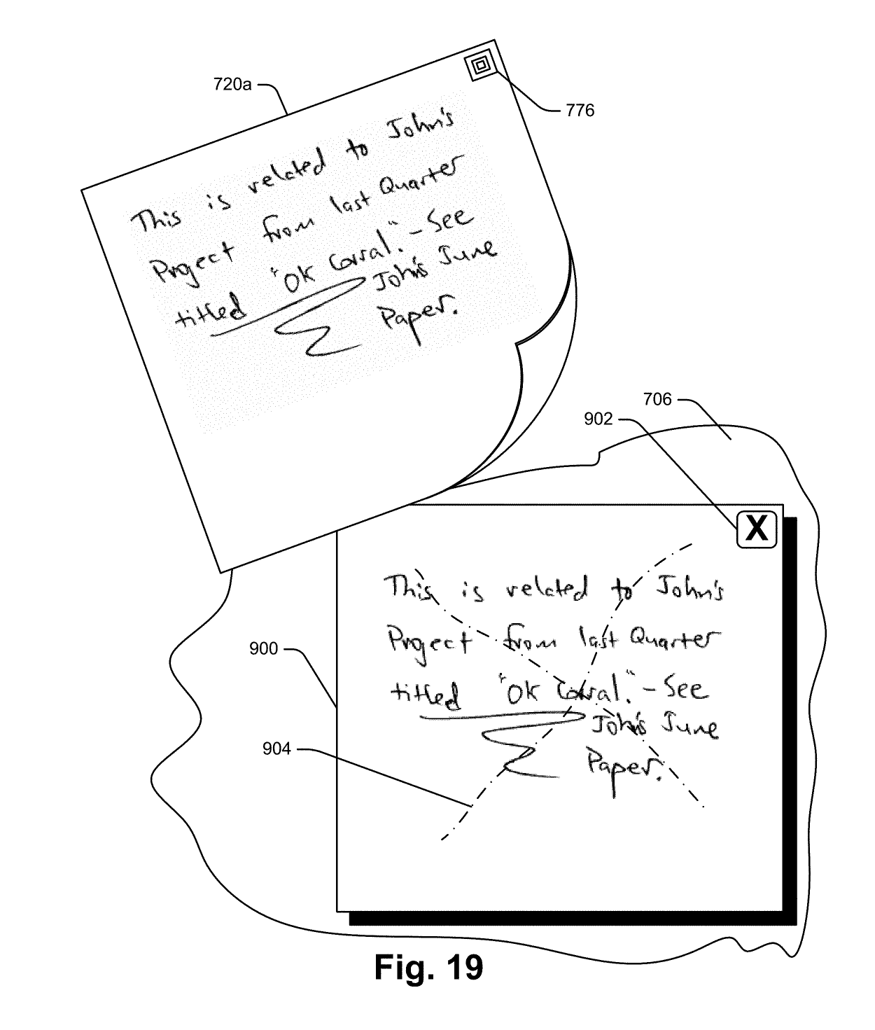

At block 812, server 790 determines if a previously posted analog note has been removed from its posted location. If the note has not been removed, control continues to loop through block 812 monitoring the note for movement. Referring also to FIG. 19, if an analog note is removed, control passes to block 814 where server 790 generates a digital note 900 that mirrors the analog note at the location from which the analog note was removed on a display screen. Thus, in at least some embodiments, a conferee may post an analog note at a specific location on a screen 706 and immediately remove the note to generate and post a digital version of the note at the location.

Continuing, at block 816, server 790 determines if a conferee has issued a command to delink a digital note from a screen location. Here, for instance, where the display screens 704, 706, 708 are touch sensitive, server 790 may monitor for an “X” gesture over a posted digital note. In another case, when a digital note is contacted via touch on a common screen, a conventional “X” icon 902 (see again FIG. 19) may be provided in the upper right hand corner of the note that can be selected to cancel or remove the note from the common screen. Where a delink command is received, control passes to block 818 where the digital post note is removed from the screen after which control passes back up to block 806 where the process continues to cycle.

Referring again to block 816, if a delink command has not been received, control passes to decision block 820 where server 790 monitors for a reposting of the removed analog note. If the removed note is not reposted control passes back up to block 816. Once an analog note is reposted, control passes to block 822 were the digital note created at block 814 is removed from the common screen and control passes back up to block 810 where a new digital note is associated with the new location of the reposted analog note. Thus, a conferee can move a single analog note several times between different locations within space 700 and the mirroring digital note will follow along. When an analog note is removed, a digital version appears in its place until the analog note is reposted or a gesture to remove the digital note is made by a conferee.

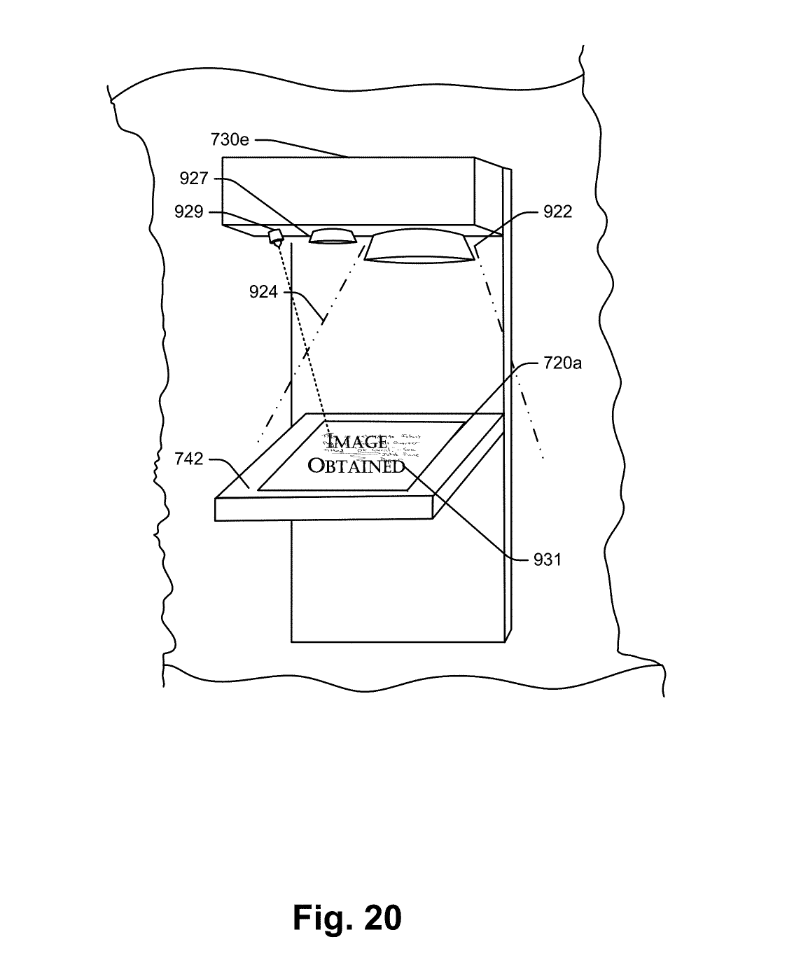

Other ways to capture content on an analog note are contemplated. For instance, a camera may be provided that can take a high definition picture of content on the face of a post note to generate an associated digital post note. To this end, see again FIG. 15 where a screen mounted camera 730e and associated note shelf 742 are shown proximate one end of screen 706. See also FIG. 20 that shows the camera 730e and shelf 742 in a larger view. Shelf 742 has a top substantially horizontal surface that is large enough to support a post note 720a. Camera 730e includes a lens 922 that focuses a CCD or other type digital camera (not separately illustrated) onto the top surface of shelf 742 so that the camera field of view subtends the top surface. When a note 720a is placed within the field of view 924, camera 730e is controlled to take a picture of the note to generate a digital post note associated therewith. The camera 730e may be programmed to recognize when a note is stationary on the shelf and may take the image automatically. To this end, the camera may include a presence sensor 927 for sensing when an object is located within the space between lens 922 and the sop surface of shelf 742. Other automated trigger systems are contemplated. In other cases a button (not illustrated) may be present on camera 730e for controlling when images are obtained.

Once a digital note is generated, a conferee may attach the analog note at any location on the display screens 704, 706 or 708 to associate the digital note with the attachment location and can move the analog or digital note around in any of the ways described above. In at least some cases the system server 790 may restrict note activity to a single note at a time. For instance, server 790 may require a conferee to post an analog note after the digital note is generated via camera 730e prior to taking an image of another analog note to be posted. If a second image is obtained prior to posting a prior analog note, the server may simply discard the first image.

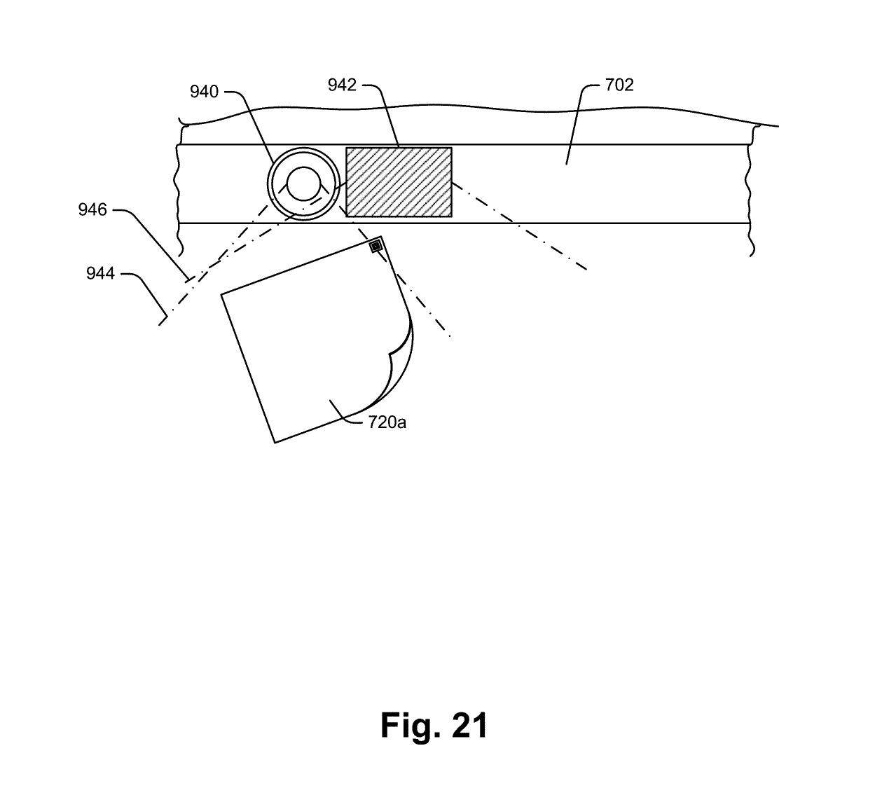

Cameras for obtaining digital content from analog notes may be located at many other locations. For example, see FIG. 21 where a camera including a camera lens 940 is built into the edge of the table top 702 adjacent an RF sensor 942. Camera 940 and sensor 942 have a field of view 944 and a sensing area 946 that overlap. When an analog note 720a is placed within the camera field of view 944, RF sensor 942 senses the tag on note 720a, uses RFID information from the tag to identify the specific note and causes the camera 940 to take an image of the note to generate a digital post note. Once the note content has been digitized, the analog note can be moved and posted at any location in space 700.

Referring again to FIG. 15, ceiling mounted cameras like camera 730a may be programmed to obtain video of the top surface of table top 702 usable by a system processor 790 to recognize instances of post notes on the top surface of table 702. The processor may be programmed to recognize when a conferee has interacted with a post note and may then obtain high definition images of the note to identify if any content has been added to the note and if so, to identify the content and generate mirroring digital content. For instance. Where a conferee grabs a post note pad and writes on the pad with a pen, movements of the conferee may be analyzed within the video generated by camera 730a to discern that the conferee is likely adding content to the note. Once the conferee is done adding content, the conferee may sit back and camera 730a may focus in on the note and take a high definition image. The processor may be programmed to assess if content has been added to the note and if not, to reset and generate the table top video again to monitor subsequent note activities. The processor may be programmed to examine note content and determine the top and bottom of the content based on the content itself. For instance, the processor may identify letters on a post note and determine the top and bottom of the note as a function of the letters on the note. A digital note would then be generated that properly presents content once posted.

In at least some cases a conferee may make a gesture recognizable by the processor as a gesture indicating that content has been added to a post note to cause the processor to control camera 730a to obtain a high definition image of the note. For instance, referring again to FIG. 15, a conferee may use her finger to draw a circle 713 about a note 720 on the top surface of table top 702 where the circle gesture indicates that an image of the note should be obtained. As another instance a conferee could use her thumbs and index fingers to frame a note as a gesture to generate an image.

In at least some cases it is contemplated that some feedback may be given to a conferee that a note has been imaged. For instance, referring again to FIG. 20, a laser scanner device 929 may also be provided as part of a camera 730e that can generate a notice 931 on an analog post note once an image of the note has been successfully obtained. The exemplary note in FIG. 20 includes presenting the words “Image Obtained” on the face of the note for a short period. The ceiling mounted camera device 730a may also have a laser scanner device 929 built in that can generate a notice on any post note located on table top 702.

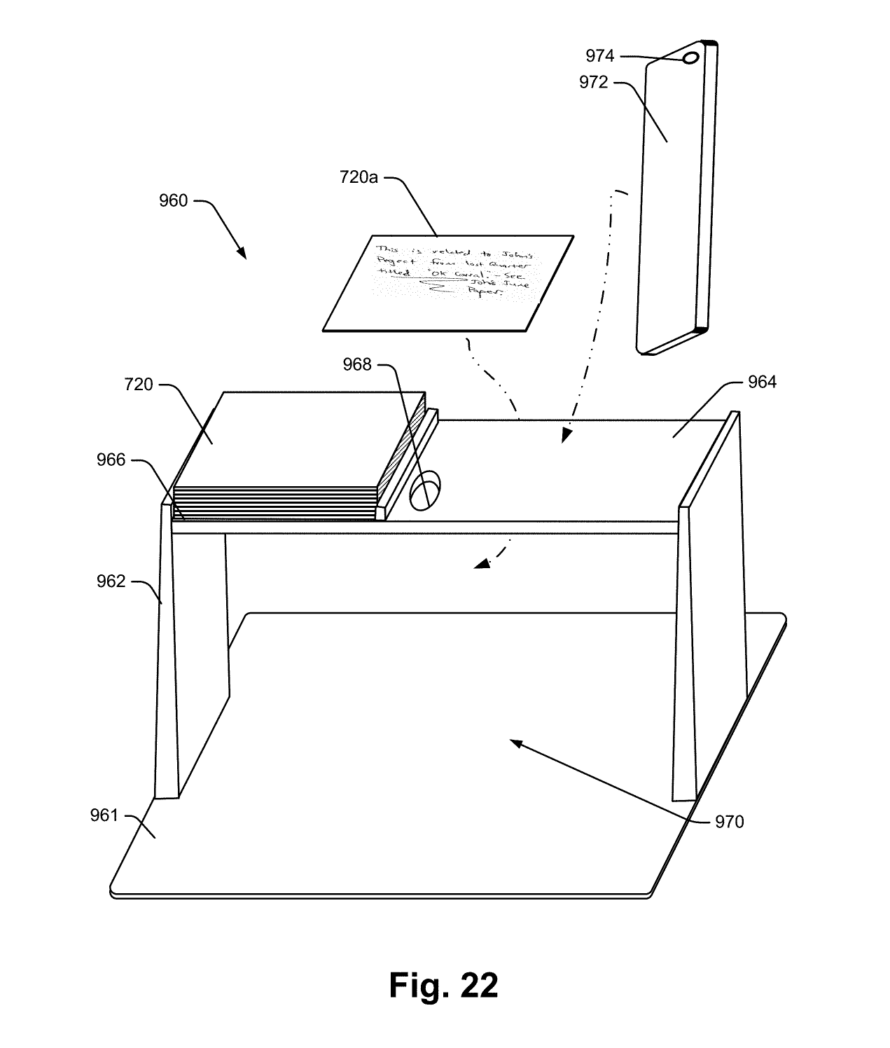

A room based note tracking system may also take advantage of capabilities of personal computing devices used by conferees to convert analog content to digital form. For instance, in at least some cases a smart phone, tablet or the like may be used to capture analog content and convert to digital form. To this end, see again FIG. 15 and now also FIG. 22 that shows an imaging station 960 resting on a top surface of table top 702. Station 960 includes a rectangular base member 961 and a bridge structure 962 that extends upward from base member 961 and forms an underpass space 970. A top horizontal member 963 forms two spaces 964 and 966 for receiving a personal computing device 972 and a post note pad 720. Space 964 forms an imaging opening 968 that should align with the locations of camera lenses on many different models of personal computing devices 972. Space 964 is large enough to accommodate a personal device 972 with the camera lens 974 aligned with opening 968.

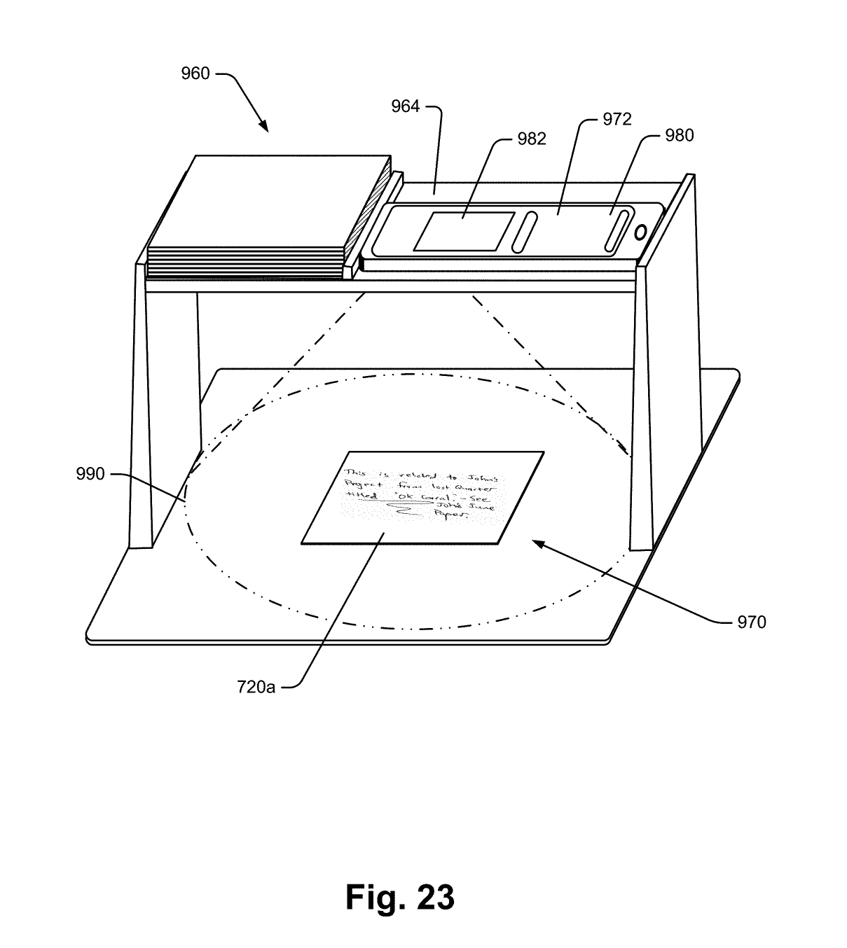

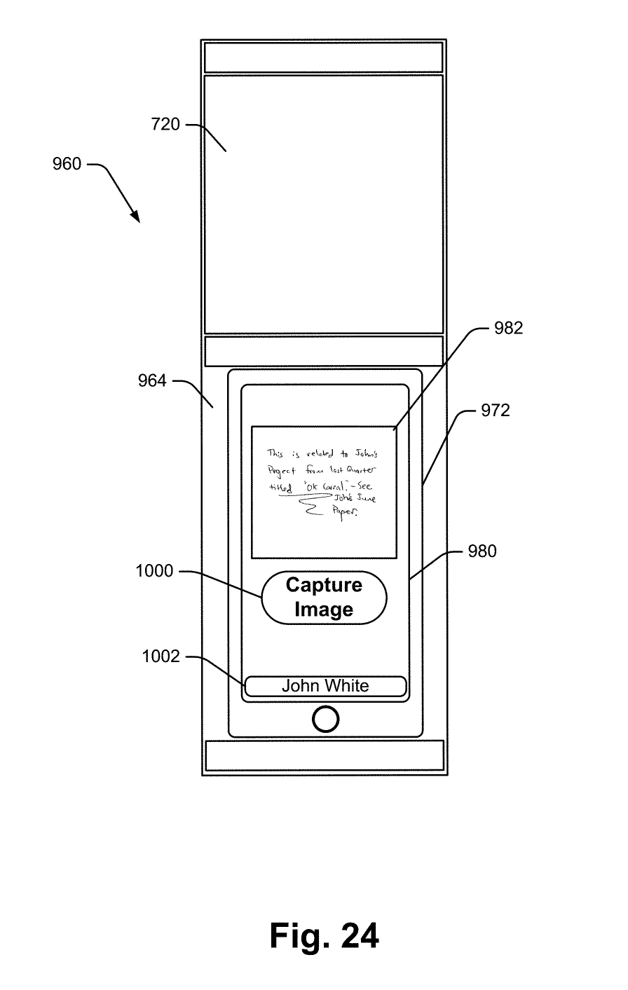

Referring also to FIGS. 23 and 24, device 972 includes a display screen 980 on a side opposite the side on which lens 974 resides. When device 972 is placed within space 964 with lens 974 aligned with opening 968, an image 982 of a note 720a placed within space 970 can be obtained and presented on screen 980. A “Capture Image” icon 1000 may be presented on screen 980 for capturing a persistent digital image of the note content.

Where conferees use a personal device 972 to obtain images to be used in the space 700, it is contemplated that a conferencing application would be downloaded to any personal device used for this purpose upon entering space 700. TO this end, server 790 may sense personal devices in space 700 and may present the option to download the application immediately upon porting a personal device into space 700. In other cases a conferee may have to access an applications store on the internet or the like to obtain the system application. In some cases all conferees in space 700 may use the same personal device 972 at a station 960 to convert analog content into digital or each conferee may have access to their own station 960.

In other cases, each conferee may use a personal device 972 independent of a station 960 to convert analog content on a post note to digital form to be used with the system. For instance, a conferee may use a conventional pen to apply content to an analog post note and may then use a system application loaded onto the conferee's personal device 972 to obtain an image of the note thereby generating the note in digital form. Thereafter, the conferee may move the analog note and post the note at a specific location on one of the screens 704, 806 or 708 at which point the digital content would be associated with the posted location as described above.

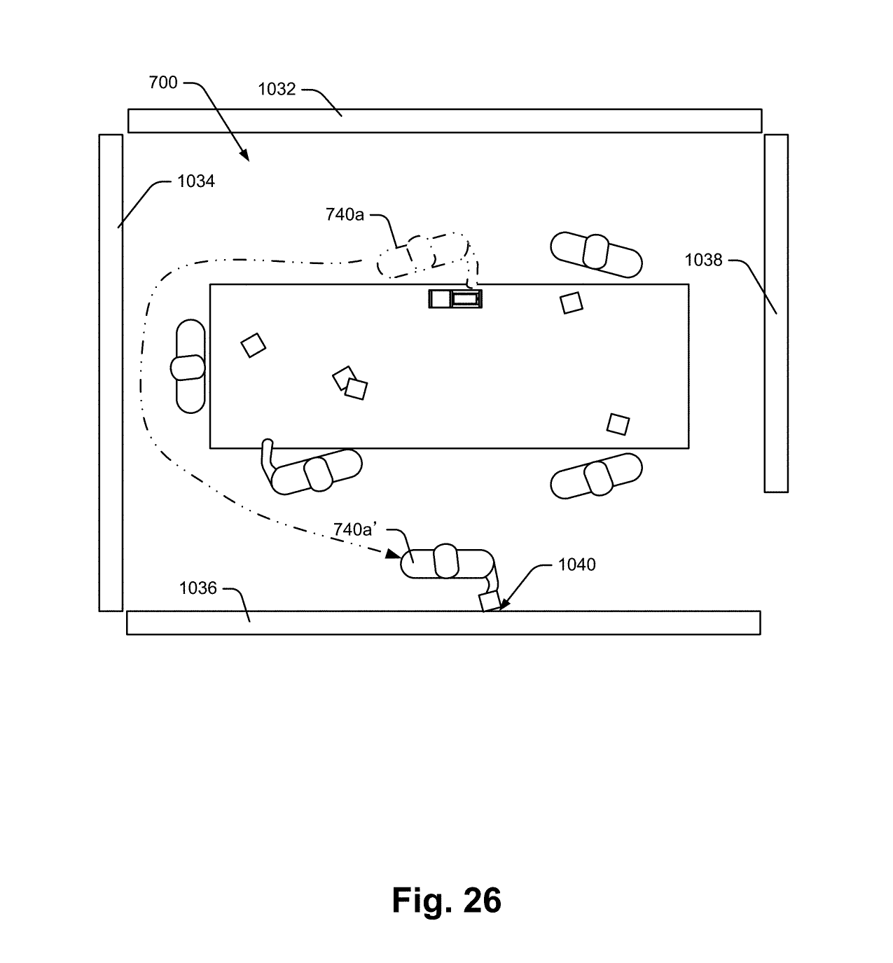

Other embodiments contemplate other ways of tracking the locations of analog post notes within space 700. For instance, note locations may be tracked at least in part by tracking the locations of conferees within space 700 that generate the notes. For instance, referring to FIGS. 25 and 26, after a first conferee uses station 960 to generate a digital version of an analog note, camera 730a and/or other cameras within space 700 may be used to track the location of the first conferee within space 700 as the conferee moves from the location 1040 shown at 740a to the location shown at 740a′ in FIG. 26. Here, if a note is placed at location 1040, server 790 may be programmed to associate the new digital note with the posted analog note at location 1040. A new note at location 1040 may be identified by images from camera 730a or other cameras 730b, 730c, 730d, etc., that are directed toward the space walls or other surfaces that may be posted to.

In at least some embodiments it is contemplated that posting and movement of content may be accomplished completely with the digital realm while taking advantage of the comforts afforded by using analog tools to generate post note content where actions required for digital posting and movement mimic actions required for analog posting and movement. For instance, after converting analog content to digital content at table 702, a conferee may get up and move to a location adjacent screen 704 to post a digital note at the location. The conferee's location can be tracked via cameras 730a, etc., and a gesture on screen 704 to post a note may be recognized at a specific location on the screen causing server 790 to post the most recent digital note created by the conferee at the location associated with the gesture. For example, the conferee may draw a “P” at a location at which to post a recently created digital note causing server 790 to present the digital note at the location of the “P” gesture. Local adjustments of the posted digital note may be may made by selecting and dragging a note for precise placement.

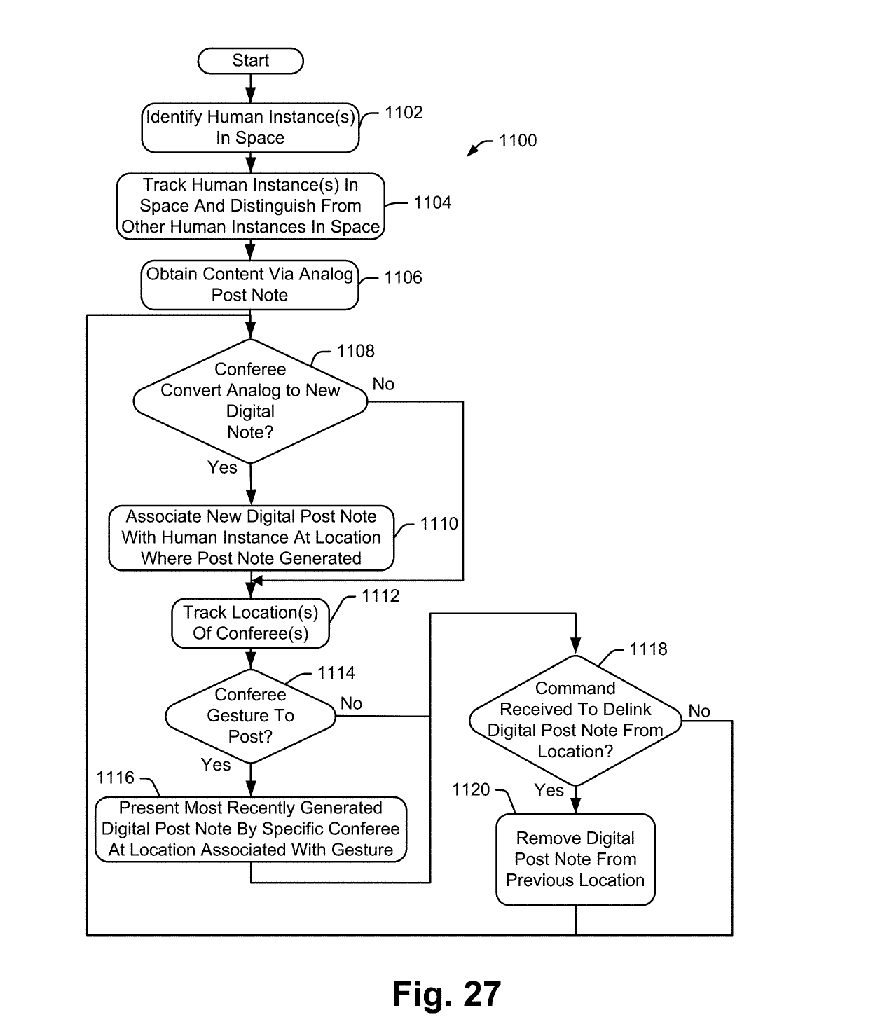

Referring now to FIG. 27, a process 1100 for digitally posting a note on a screen is illustrated. Referring also to FIG. 15, at block 1102 server 790 identifies human instances (e.g., separate conferees) within space 700. Kinect type camera devices using technology provided by Primesense can be programmed to perform the conferee identifying process. At block 1104, after identifying separate conferees in space 700, server 790 tracks the locations of the conferees within space 700 as they move about. At block 1106 one of the conferees uses a pen and a post note to create analog content. At decision block 1108, server 790 monitors to detect when a conferee converts analog content to create a new digital post note in some fashion such as, for instance, via an Eno type pen, a camera, etc. If no post note is generated control passes to block 1112. If a new digital note is created, control passes to block 1110.

At block 1110, server 790 associates the new digital post note with the conferee (e.g., the human instance) that was at the location where the digital post note was created. For example, referring again to FIG. 26, if a first conferee is at the location indicated by 740a when a digital note is created using device 960, the new digital note would be associated with the first conferee. As the first conferee moves in space 700, the digital note moves along with the representation of the first conferee in video generated by a camera 730a or other cameras in space 700. At block 1112 server 790 racks the locations of the conferees in space 700. At block 1114, server 790 monitors for a gesture (e.g., drawing a “P” at a location on one of the touch sensitive screens 704, 706, etc.) from a conferee to post a post note in space 700. If a post gesture is detected, control passes to block 1116 where the digital post note most recently created by the first conferee is presented at the location at which the gesture was detected. Thus, in some embodiments digital post notes follow a conferee around in a space 700 so that the conferee can “carry” content along as they move without having to physically carry analog notes.

Referring still to FIG. 27, if the server 790 does not detect a post gesture or after a digital note has been posted, control passes to block 1118 where server 790 monitors for a command to delink a digital note from a posted location. Again, a delink command may include an “X” gesture across the face of a digital representation of a note, selection of an “X” icon in the upper right hand corner of a note, etc. If no delink command is received control passes back up to block 1108 where server 790 continues to track locations of all conferees within space 700. Once a delink command is received, control passes to block 1120 where a digital note associated with a delink gesture is removed from the posted location after which control passes back up to block 1108.

It has been recognized that a system that requires conferees to work with a single post note at a time may be tedious to use. For instance, with this type of system a conferee would be required to create and place one digital note prior to creation and placement of a second note. As another instance, if a conferee has placed prior digital notes when another digital note is created to be placed and then the conferee wants to remove one of the posted digital notes prior to placement of the new note, there may be no way to retain the removed digital note for subsequent placement in another location. As one other instance, a conferee may want to generate three digital notes while seated at table 702 for subsequent posting. A single note-at-a-time system would not allow generation of multiple notes for subsequent posting.

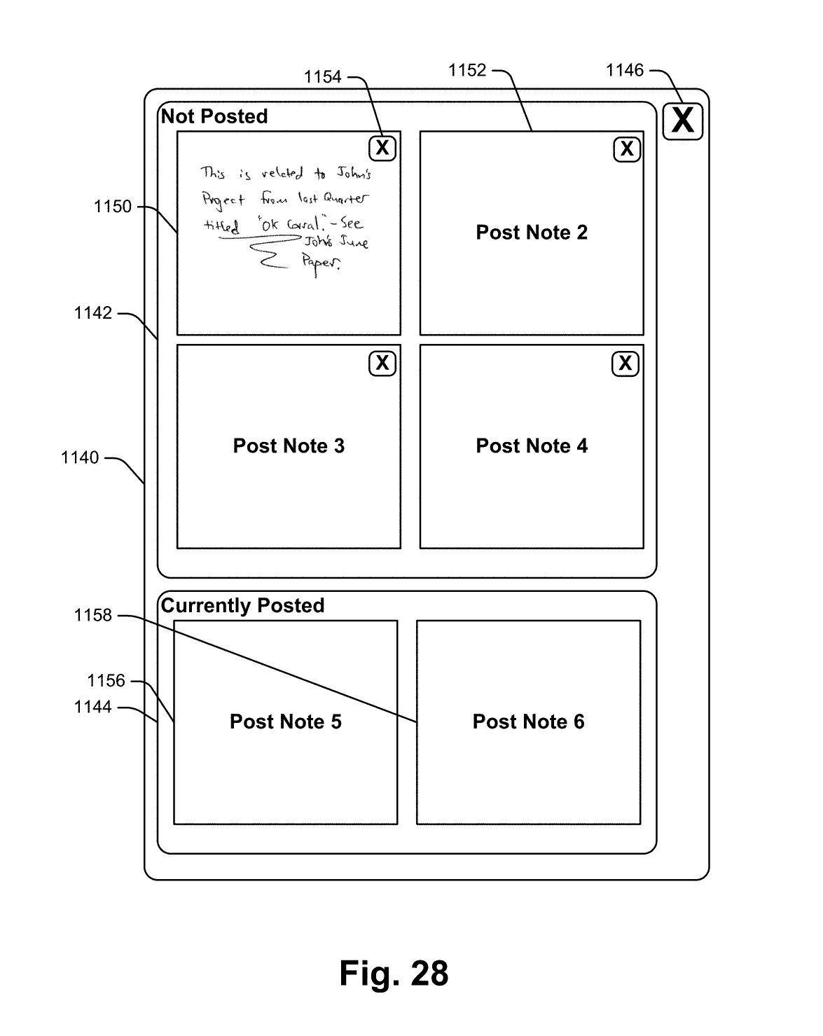

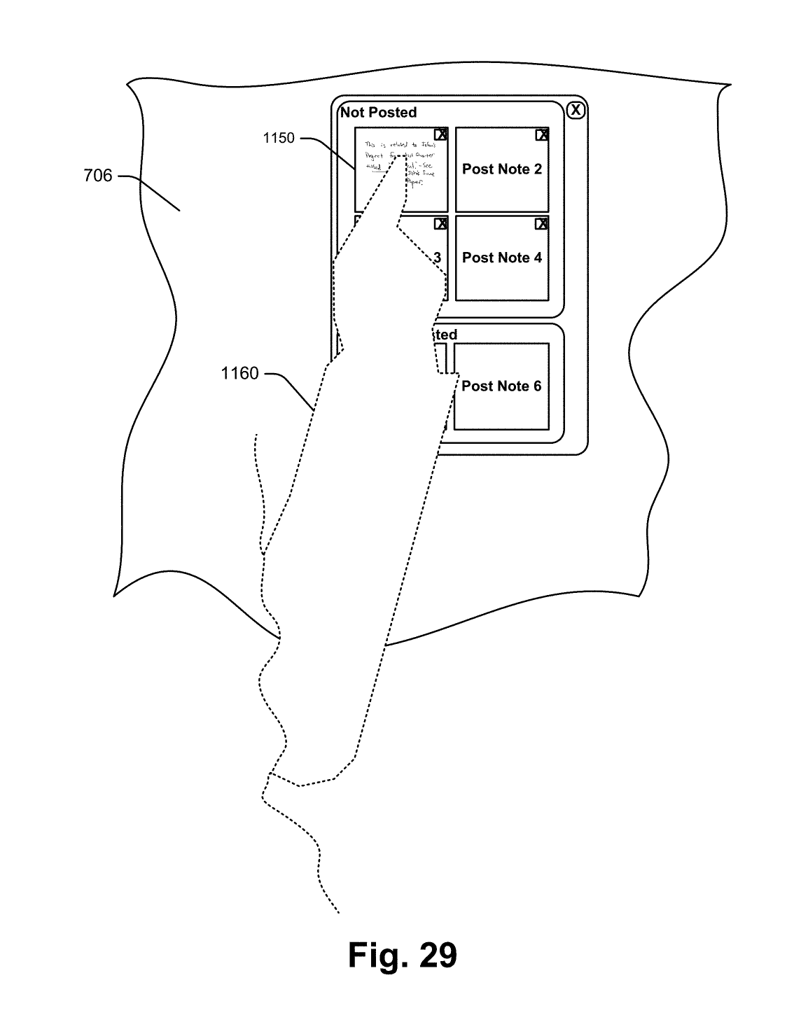

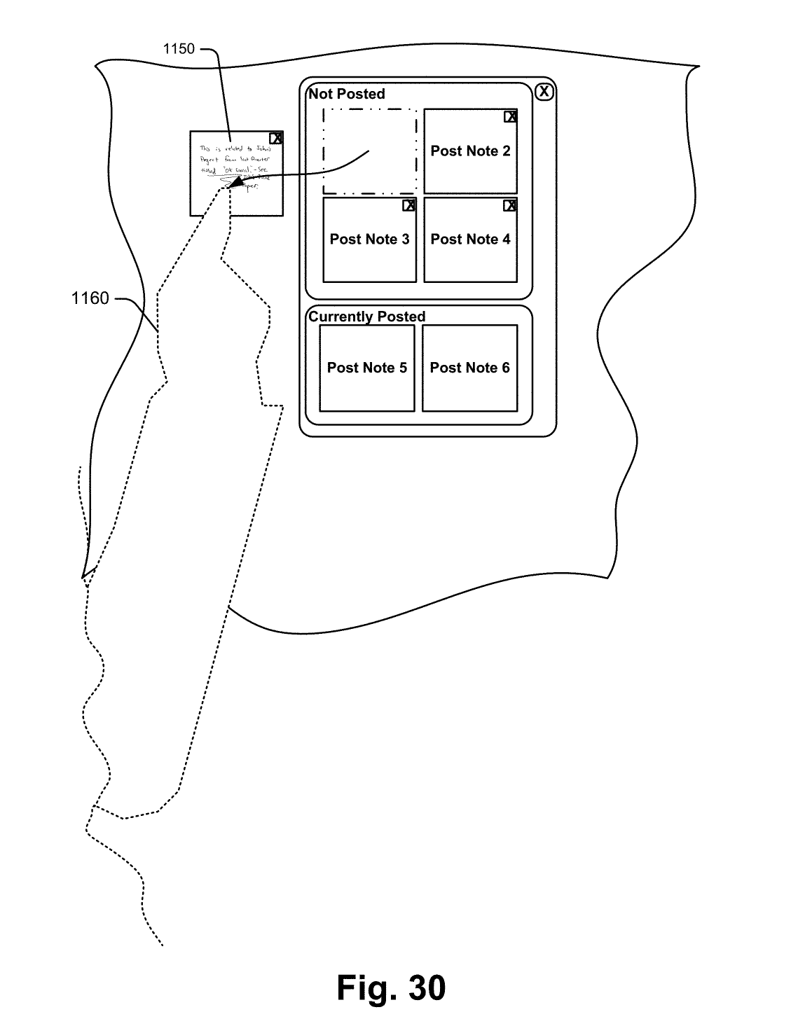

At least some embodiments of the present disclosure contemplate a conferee note clip board for storing digital post notes for use by conferees during a session where the clip board may be accessed at a common screen for note selection and placement. To this end, see, for instance, the exemplary virtual clip board shown in FIG. 28 that includes a clip board window 1140 having a “Not Posted” field 1142 including all digital notes (see exemplary notes labelled 1150, 1152) generated by a conferee that are not currently posted. Referring also to FIG. 29, in this case, when a conferee gestures on a common screen (e.g., draws a “P” on the screen), server 790 may present the note clip board on the screen 706 at the location of the gesture. Referring also to FIG. 30, the conferee can select a note via a finger touch as indicated at 1160 and can drag the note out of the clip board window 1140 and onto a space on screen 706 where the conferee can drop the digital note at an intended posting location. Here, the conferee can select any of the post it notes in filed 1150 to move to the common space 706. Similarly, although not illustrated, a conferee could remove one or more posted notes from the common space by simply selecting the note on the screen and dragging the note into field 1142 on the clip board 1140.

Referring again to FIG. 28, clip board window 1140 includes an “X” close icon 1146 for closing window 1140. Similarly, each digital note 1150, 1152, etc., represented in field 1142 includes a close icon (e.g., see 1154) for removing the note from field 1142. In at least some cases a “Currently Posted” field 1144 may be presented in window 1140 to indicate notes currently posted to common screens by the conferee associated with the clip board window 1140.

In at least some cases where a virtual clip board is associated with each conferee, when a post note is removed from the common space, the removed or delinked note may be placed on the conferee's clip board in field 1142 for subsequent posting if desired at a different location. Thus, for instance, a conferee may draw an “X” on a currently posted digital note to remove the note from the current location and place the note on the conferee's clip board. Then, when the conferee moves to a second location in space 700 and draws a “P” at the second location, server 790 may represent the clip board at the second location to present the removed digital post note for replacement proximate the second location.

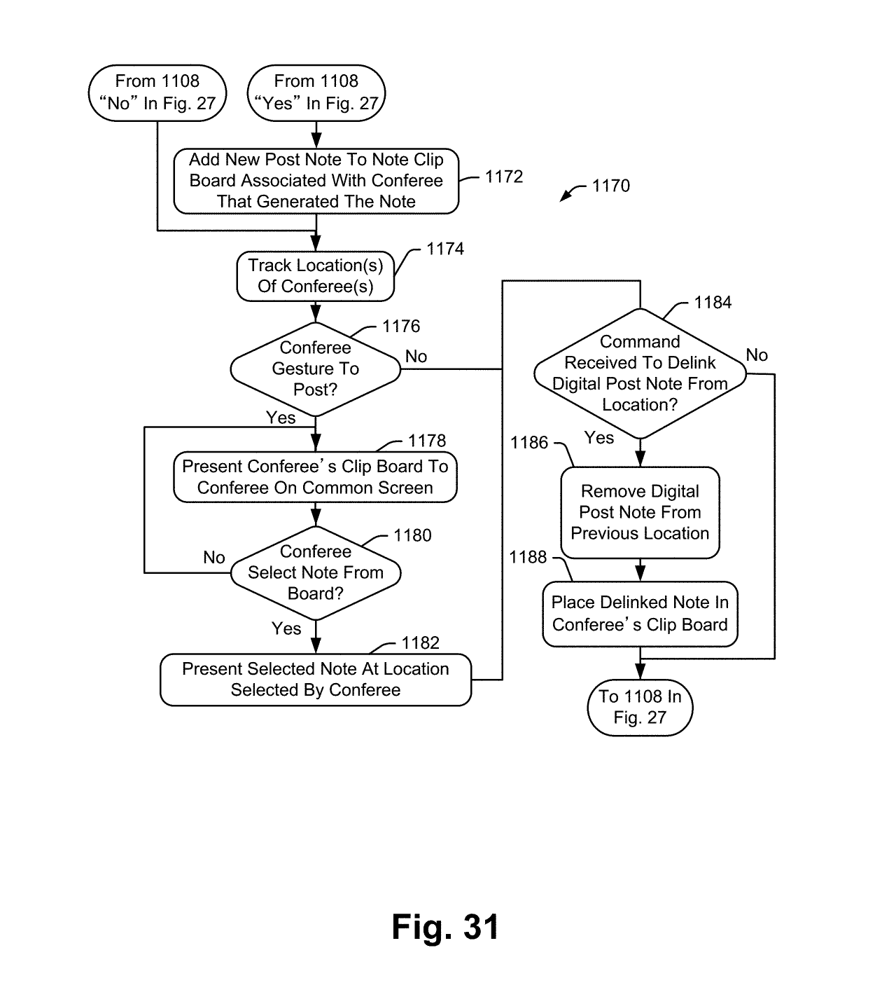

Referring now to FIG. 31, a sub-process 1170 that may be substituted for a portion of the process shown in FIG. 27 for supporting virtual note clip boards for use by conferees is presented. Referring also to FIG. 27, after analog content has been converted to digital content at block 1108, control may pass to block 1172 in FIG. 31. At block 1172 a new digital post note is added to the note clip board associated with the conferee that generated the new digital note. If a new digital post note is not created at block 1108 control passes to block 1174 in FIG. 31.

At block 1174 server 790 tracks the locations of conferees in space 700. At block 1176 server 790 monitors for a post gesture (e.g., “drawing a “P” on a common screen). When a post gesture is received, control passes to block 1178 where server 790 presents a conferee's note clip board at the location where the gesture is detected (see again FIG. 29). At block 1180, server 790 monitors for a gesture to post a note from the conferee's clip board to the common screen space (see again FIG. 30). If no gesture to post is received, control passes to decision block 1184.

At block 1180, once a conferee gestures to post a specific note, control passes to block 1182 where the selected note is presented at the location selected by the conferee. After block 1182 control passes to block 1184. At block 1184, server 790 monitors for a command to delink a note from a location on the common space. If no delink command is received, control passes back up to block 1174 where the process described above continues to cycle. If a delink command is received at 1184, at 1186, server 790 removes the digital post note from the location associated with the delink command and at block 1188 the re-linked note is added to the conferee's note clip board after which control passes back up to block 1108 in FIG. 27.

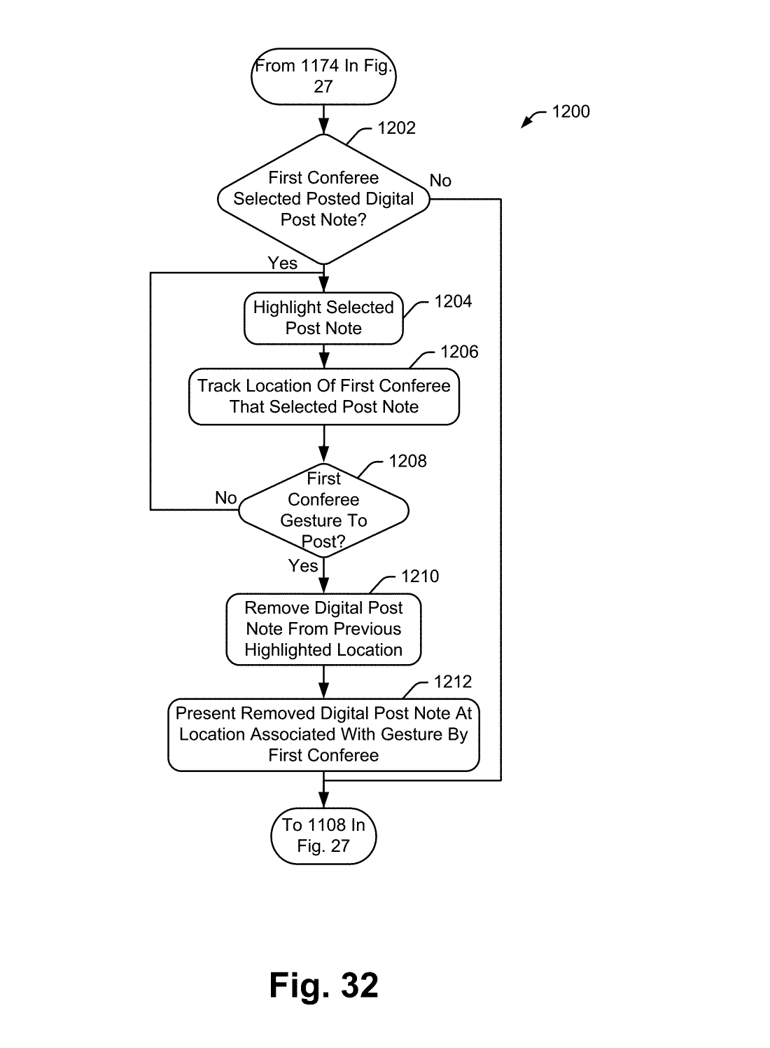

In at least some embodiments it is contemplated that server 790 may afford several different ways of digitally capturing content, moving content about within space 700 and posting content such that conferees can select the most intuitive ways of performing these tasks. To this end, another sub-process 1200 that may be added to the sub-process described above with respect to FIG. 31 is shown in FIG. 32 so that a conferee has two ways of removing a posted digital note from one location and placing the note at a different location. In this regard, the process described with respect to FIG. 31 already presents one way of removing and reposting a note by placing a posted note from a first location on a virtual clip board, moving to a second location, re-opening the clip board and placing the note at the second location via a dragging or other gesture action.

Referring to FIGS. 31 and 32, sub-process 1200 is performed in parallel with the portion of sub-process 1170 including the blocks between blocks 1174 and 1188. Thus, after block 1172 control also passes to block 1202 where server 790 monitors for a firs conferee selecting a posted digital note via, for instance, a double tap of the note to be selected. Where no note selection occurs, control passes back up to block 1108 in FIG. 27. Once a posted note is selected control passes to block 1204 where server 790 highlights the selected note to confirm for the conferee that the note has been properly selected. At block 1206, server 790 tracks the location of the first conferee that selected the posted note and at block 1208 monitors for a posting gesture by the firs conferee. Here, the posting gesture may be a second double tap or some other gesture that is different than the gestured to open up a note clip board. Where a posting gesture does not occur control may pass back up to block 1204. Once a post gesture is detected, control passes to block 1210 where the highlighted digital note is removed and delinked form the prior location and then at block 1212 the removed digital note is re-presented at the location associated with the posting gesture. Thereafter control passes back up to block 1108 in FIG. 27.

In at least some embodiments it is contemplated that several differently sized post notes may be supported by the system. For instance, some post notes may be three by three inch square while others are five by five inch and still others are seven by seven inch square. In some embodiments analog post note pads may have different colors and each color may be associated with a different conferee. For instance, yellow post it notes may be associated with a first conferee while light green and light blue notes are associated with a second conferee. Here, when the analog notes are converted to digital, server 790 may provide the option to show all posted digital notes in one color (e.g., yellow) or to show all posted digital notes in the colors associated with the analog pads used to generate the notes and therefore associated with the conferees that generated the notes.

While the content generation and movement concepts are described above in the context of post it or post notes, in at least some embodiments content may be generated in other analog forms and moved about within space 700 in a fashion similar to that described above. For example, where screens 704, 706, etc., are touch sensitive so that content may be developed on those screens via a drawing application or other content generating applications like w word processor application, a spreadsheet application, etc., the content may be moved about within space 700 via touch and dragging, via a double tap followed a s second double tap at a target location to which to move the content or via some other supported gesture.

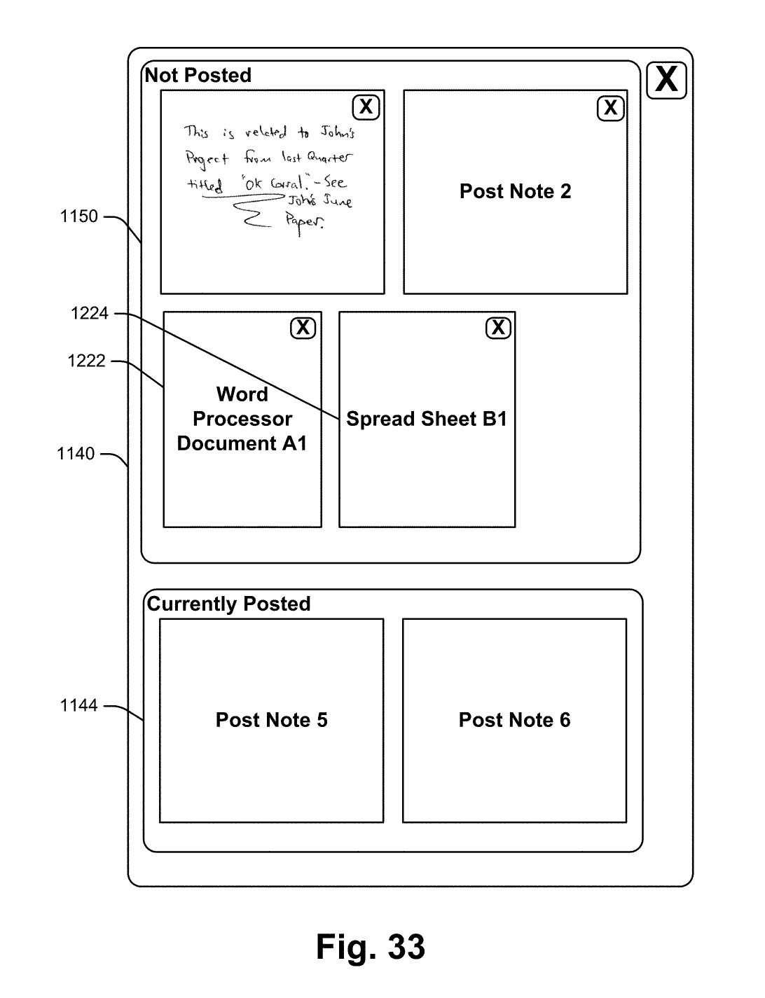

In some cases it is contemplated that content may be moved to a conferee's virtual clip board for temporary storage or to be virtually transported by movement of a conferee to a different location in space 700. To this end, see FIG. 33 that shows a virtual clip board where the “Not Posted” and “Currently Posted” fields store, in addition to post notes, other content currently not posted and posted, respectively, including a word processor document A1 1222 and a spread sheet document B1 1224. In this case if a conferee opens clip board 1140 on a common screen, the conferee can move any of the notes or document or other content onto the common screen to generate a version thereof. In the case of other content like a document or spreadsheet that is better viewed in a larger format, movement of the digital content to a location on a common screen will typically increase the size of the content to a size suitable or optimal for viewing the content, often the largest size possible given dimensions of the screen on which the content is open.

Often times post notes are placed at locations relative to other content on common screens during a conferencing session. For instance, where a drawing has been developed in a window on a common screen 704, 706, etc., conferees may post a large number of post notes on, partially on or proximate the drawing during a brain storming session. Thereafter, in many cases, a conferee may want to move the drawing or other content within space 700 to a different location. If the drawing is selected via a double tap or in some other fashion, it would be useful if there was some way to quickly associate other content including post notes with the drawing to be moved so that the associated content could be moved along with the drawing. One way would be to move all post notes that overlap the drawing along as the drawing is moved but there may some overlapping notes that are not associated with the drawing. In addition, there may be some post notes adjacent the drawing but that do not overlap the drawing that are associated with the drawing that would be missed if only overlapping notes were moved along with the drawing.

One solution to associate notes with other content when being moved is to automatically associate a default subset of notes with content selected to be removed from or moved on a screen to a different location and provide tools to a conferee to add other notes to or remove notes from the default subset. Here, the default subset would be based on a set of rules. For instance, a general rule may be that all notes that overlap the representation of selected content on a common screen be included in the default subset. To indicate the default set of notes, in at least some cases, server 790 may highlight the selected content as well as the default subset of notes to be included in a move or a removal. Once highlighted, a conferee can view the highlighted content and assess whether or not any highlighted content should be removed from the subset or any non-highlighted content should be added to the subset. Other notes that do not overlap the selected content may be added by gesture. For instance, one gesture may be to touch and drag a note to a location that overlaps the selected content. In some instances when a note is dragged to an overlapping location, the note may be moved or a ghost version of the note may move along as the conferee drags and upon dropping, either the note will be included at the dropped location or the note in its original location will be highlighted so that its relative juxtaposition to the selected content can be maintained after the dropping action to be reflected when the content and note are re-positioned at a different location. As another instance, a simple touch of a highlighted note may toggle the note to an un-highlighted state and an un-highlighted note may toggle to a highlighted state upon a simple touch. After related content is highlighted, a conferee may drag selected content as a whole into a virtual clip board window as described above.

Another default rule may be that if there in only one non-note content set on a common screen and several notes on the screen, if the non-note content is selected to be moved or removed, then all of the screen notes regardless of overlap should be associated with and moved along with the selected content. Still one other rule may be that if other non-note content on a screen is substantially spaced from notes that are near a first content set when the first content set is selected, regardless of overlap, the notes are associated with the first content upon selection of the first content.

In still other cases server 790 may be programmed to track a lasso type action by a conferee intended to select one or more non-note content items (e.g., documents, images, notes, etc.) on a common screen and to select a default note set based on the space defined by the lasso gesture. For instance, notes having areas that are at least 50% within a lasso space may be included in an automatic default subset of notes and other notes may be initially excluded. Again, a conferee may be able to add notes to the set or remove notes from the set via gesture (e.g., selection or dragging) as described above.

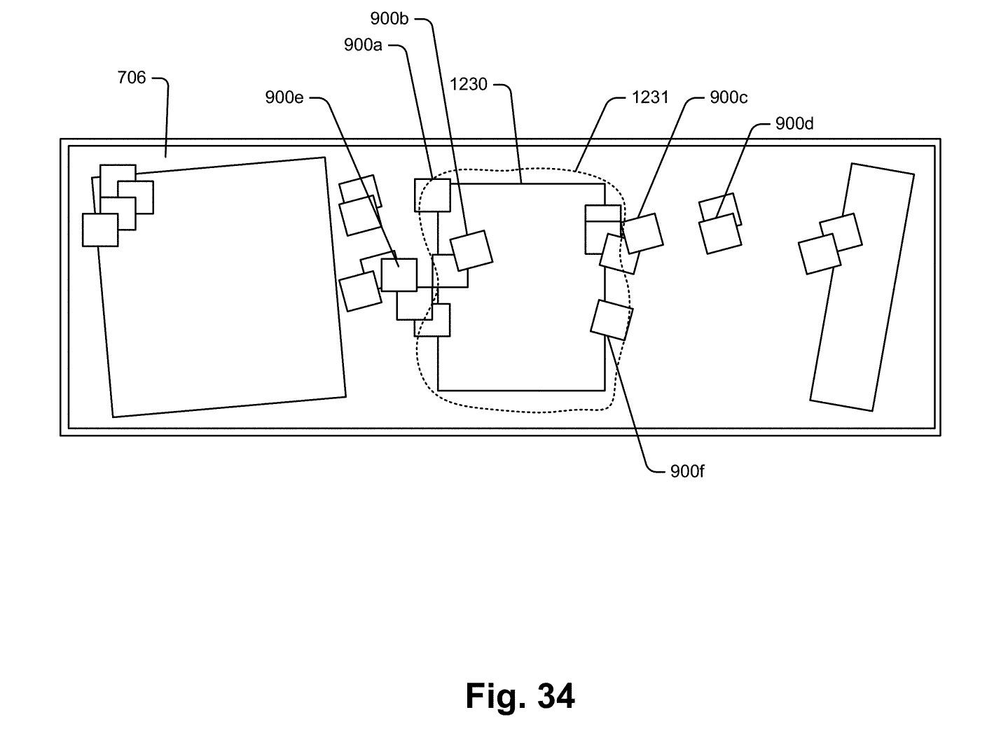

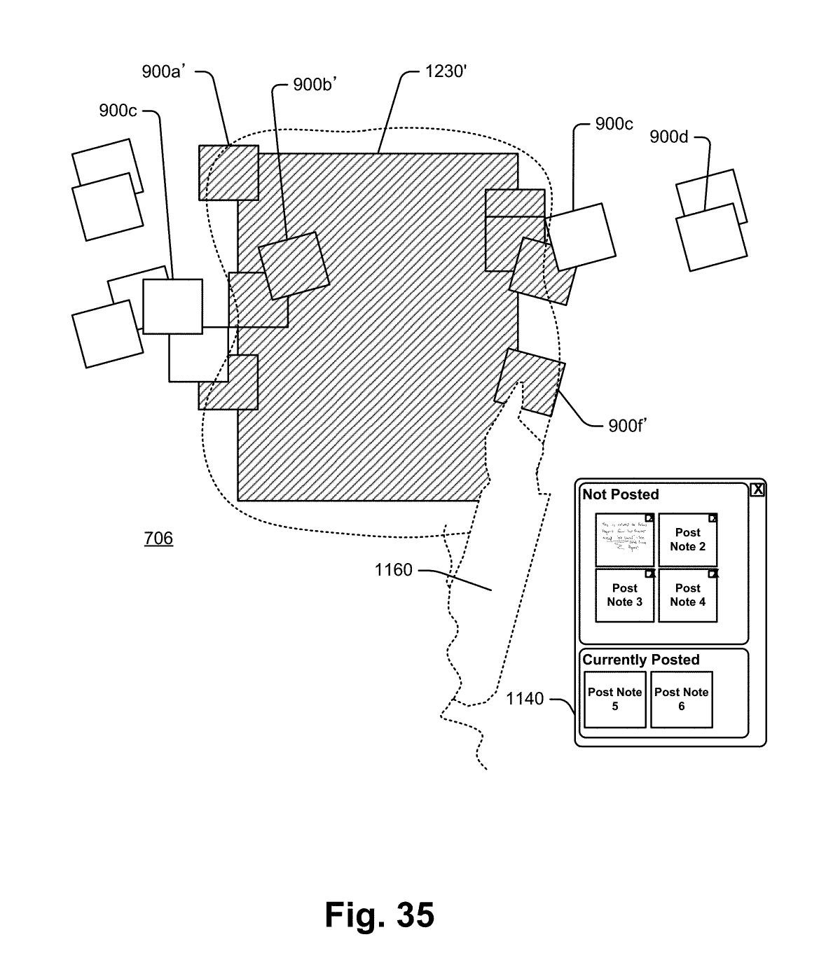

Referring now to FIG. 34, an exemplary lasso type drawing action to select content to be moved is illustrated at 1231 where the lasso action is intended to select a document displayed at 1230 as well as digital post notes associated therewith. When a lasso action is detected, server 790 may be programmed to show the lasso shape as well as to open a conferee's virtual clip board as at 1140 in FIG. 35. As can be seen, some of the notes (e.g., 900b) are completely within the lasso shape and therefore would be included in a default subset associated with document 1230. Other notes (e.g., 900a, 900f) are mostly (e.g., greater than 50%) within the lasso shape 1231 and therefore, based on a 50% in rule, would be included in the default set. Notes like 900c that are more than 50% outside shape 1231 are excluded from the automatic default set as are other notes like 900d, 900e and 900f that are completely outside shape 1231. Thus, the selected document 1230 and note representations would appear as shown in FIG. 35 where content 1230′ and the initial subset of associated notes including notes 900a′, 900b′ and 900f′, among others, are all highlighted.

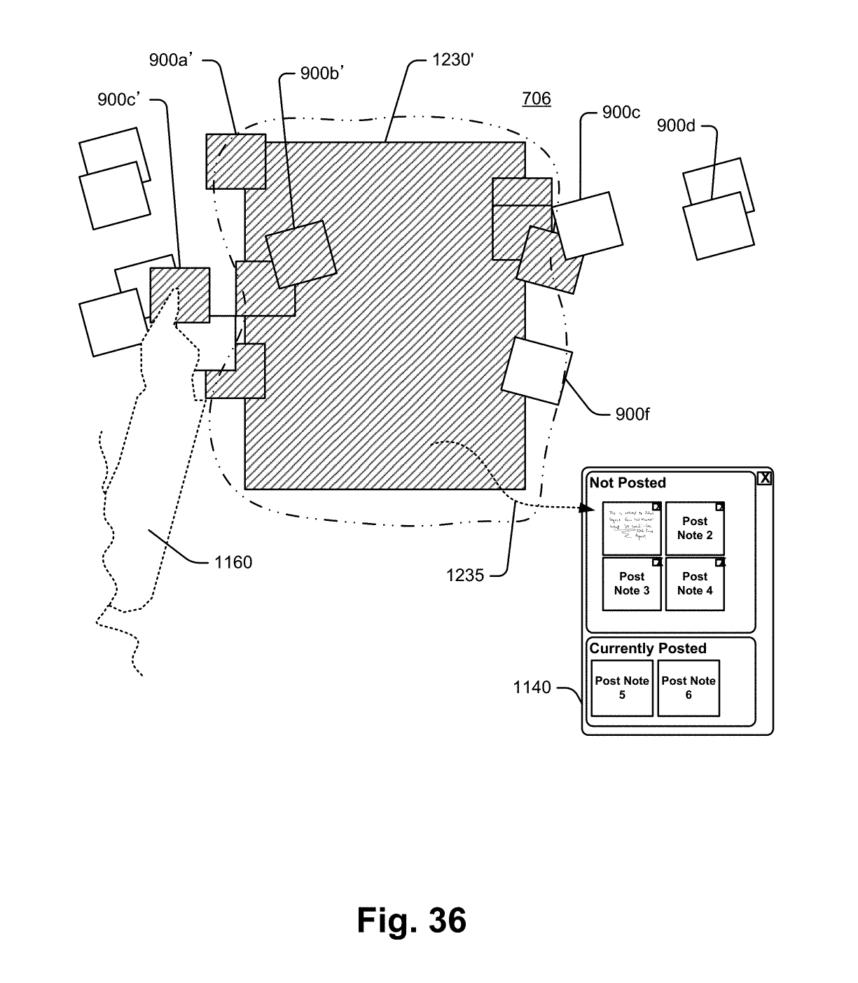

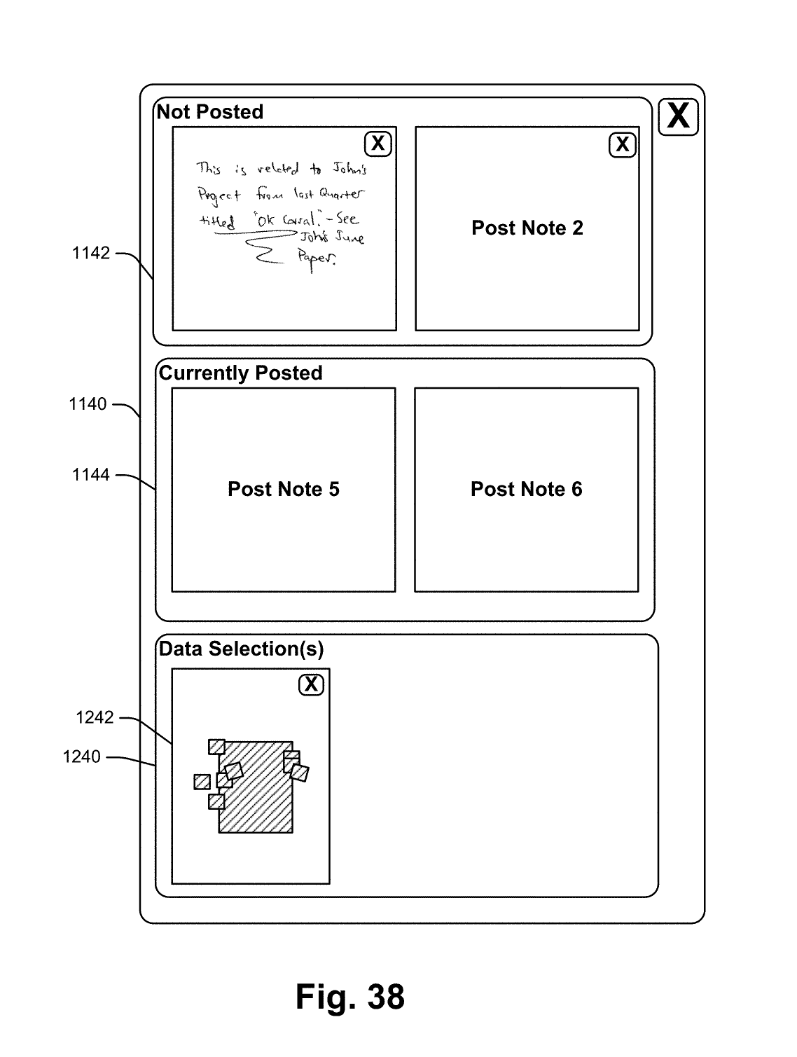

Next, if the conferee wants to remove note 900f′ from the highlighted set, the conferee can select note 900f′ to toggle the note to un-highlighted status as shown in FIG. 36 at 900f. If the conferee wants to add note 900e to the set in FIG. 35, the conferee can select the note as shown in FIG. 36 to add the note to the highlighted set as at 900e′. After all content is properly selected, the conferee can drag the content as indicated at 1235 to the clip board 1140 resulting in addition of the selected/highlighted content to the clip board as shown at 1242 in FIG. 38 in a data selection field 1240. Selections in field 1240 persist on the clip board until they are removed by a conferee or are placed at a different location within space 700.

While the subset of associated content is described above in the context of posted digital notes, other content sets such as documents, images, etc., may also be included in an initial automatic subset to be highlighted unless removed and other content sets may be added by selecting from outside a selected area. Herein, unless indicated otherwise, the term “object” will be used to refer generally to a digital posted note, a document, an image, a drawing, or any other content set distinguishable on a common screen 704, 706, etc.

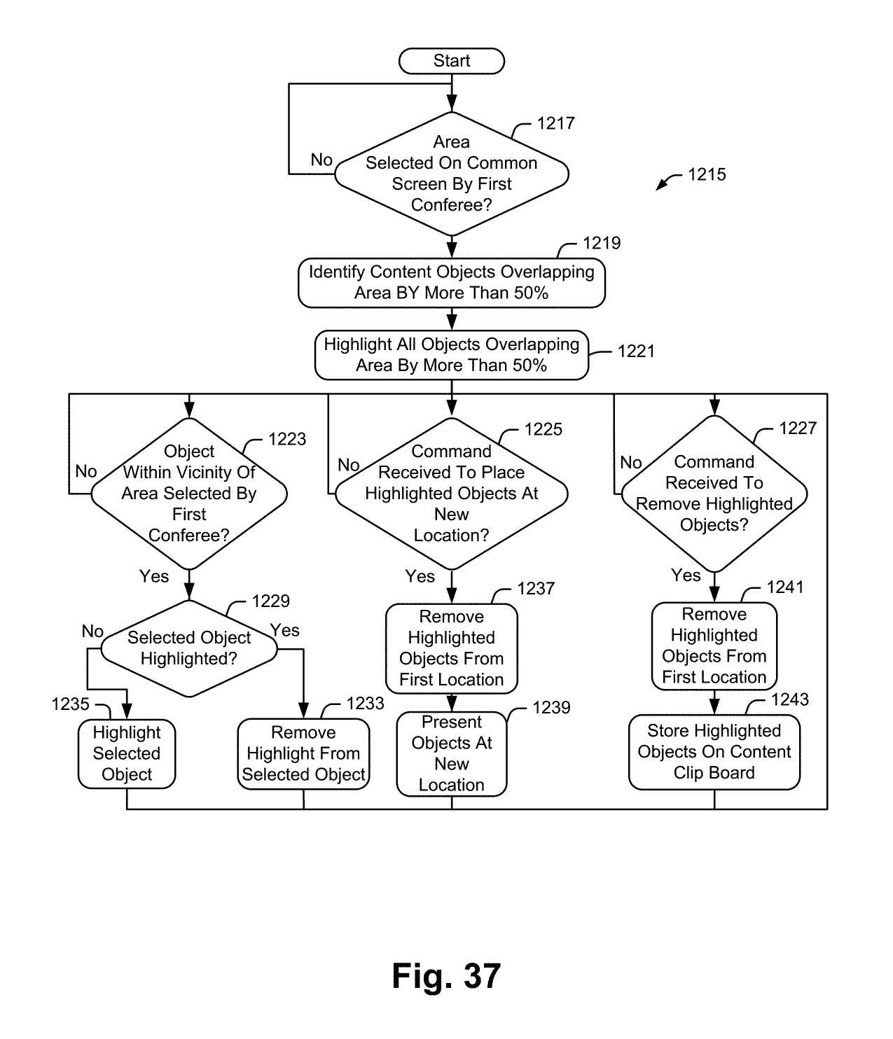

Referring now to FIG. 37, a process 1215 for selecting content on a common screen and associating posted notes or other objects therewith for simultaneous movement is presented. At block 1217 server 790 monitors to detect when an area on a common screen is selected by a first conferee. Once an area is selected, control passes to block 1219 where server 790 identifies content objects that overlap the selected area by more than 50% and at block 1221 those overlapping objects are highlighted. After block 1221 three separate sub-processes occur simultaneously. At block 1223, server 790 monitors for selection of another object or note within the vicinity of the selected area. When another object is selected, at decision block 1229, server 790 determines if the selected object was highlighted prior to selection. If the selected object was highlighted, control passes to block 1233 where the highlight is removed from the selected object. If the selected object was not highlighted prior to selection at block 1229, control passes to block 1235 where the selected object is highlighted. After blocks 1233 and 1235 control passes back up to the output from block 1221.

Referring still to FIG. 37, at decision block 1225, server 790 determines if a command has been received to place highlighted objects at a new location within space 700. For instance, a re-placement command may include a double tap at a new location by the conferee that selected highlighted objects. Once a post or placement command is received, control passes to block 1237 where the highlighted objects are removed from their original or initial location and then at block 1239 the objects removed are presented at the newly selected location after which control passes back up to the output of block 1221. At block 1227, server 790 monitors for a command to remove highlighted objects from a common screen and once a command is received, control passes to block 1241 where server 790 removes the highlighted objects from the screen. At block 1243, server 790 stores the removed highlighted objects to the content clip board (see again FIG. 38 at 1242) after which control passes back up to the output of block 1221.

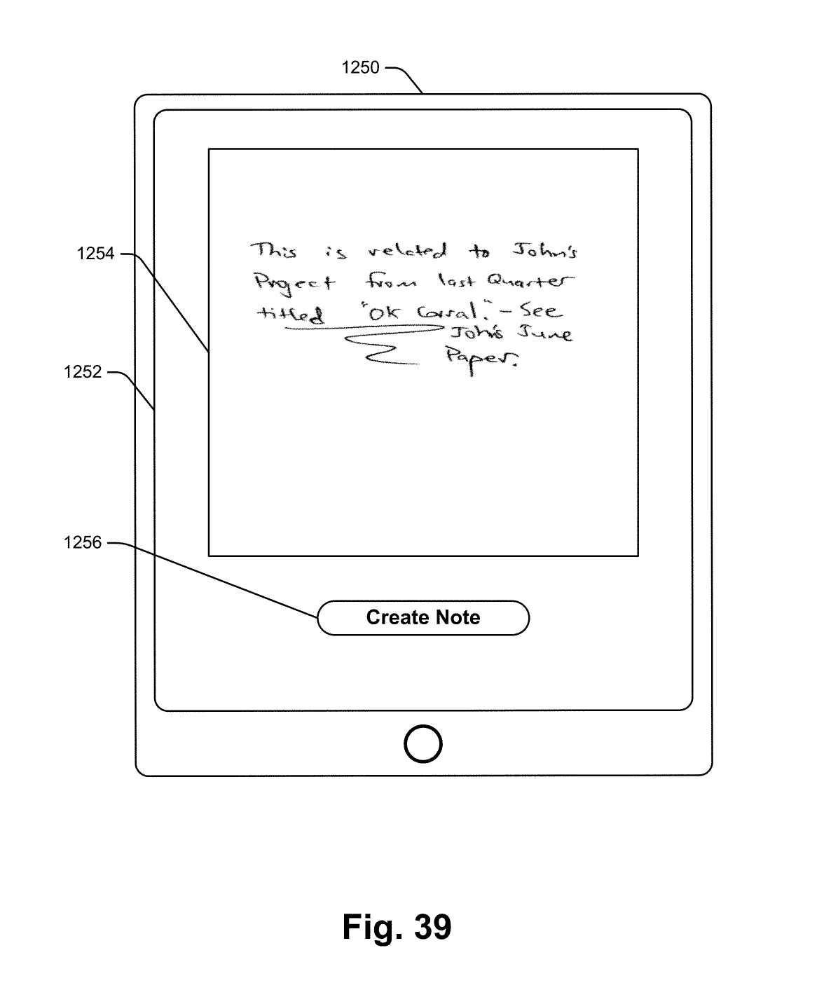

In addition to or instead of using analog devices (e.g., paper and pen) to create initial content during a session, in at least some embodiments some content may be created using one or more digital input devices. For example, a tablet type device (e.g., I-pad, Android pad, etc.) may be used to scribble a note or enter content. Other digital input device types may include an E-ink type device that includes a wireless transmitter, a laptop computer, a desk top computer, a smart phone or personal digital assistant, etc. In these cases, an application may be downloaded onto each device to be used to generate content when the device is brought into space 700 and the application may, for instance, present a virtual post note on the device display screen to receive content via a finger touch, a stylus touch, typing via an on screen or mechanical keyboard, etc. To this end, see device 1250 in FIG. 39 that includes a tablet type computing device having a screen 12252 on which a virtual digital note is presented. Once content is applied to note 1254, a “Create Note” icon may be selected to create a persistent digital note for posting on one of the common display screens 704, 706, etc. In some embodiments persistent notes may be added to a conferee's virtual clip board (see again FIG. 38) to be placed on the common displays when the create note icon 1256 is selected. Then, consistent with the description above, the conferee can subsequently gesture to post a note on a common screen to access the conferee's clip board 1140, retrieve the note created with device 1250 and post the note where desired.

In other cases a conferee may use device 1250 to post a note on a common screen by moving device 1250 to a location at which to post a note and then gesturing in some fashion. For instance, a camera 730c may sense when a conferee is proximate screen 704 and when and where the conferee contacts the screen to post a digital note. When the screen is contacted, server 790 may be programmed to present the note currently on the conferee's device screen 1253 at the contacted location.

In still other cases a conferee's notes and other content may be presented in a clip board type window on the conferee's device display screen 1252 in FIG. 39. In this case, the conferee could generate a plurality of notes and then place the notes where appropriate at any subsequent time. Here, again, the conferee may access one clip board note on screen 1252 and then touch a common screen at a location to post to cause server 790 to present the digital note at the selected location.

While most of the system described above do not include a mechanism for identifying and distinguishing specific conferees, in some embodiments it is contemplated that server 790 may perform some function to ascertain the identity of each conferee in space 700. Where conferee identity can be determined, several other useful features can be facilitated. For instance, if a conferee already has a digital clip board that includes notes and other content (e.g., documents, images, etc.) leaves a space 700 for some purpose, when that conferee returns, if the system cannot ascertain the conferee's identity, the system cannot re-associate the clip board with the conferee. As another instance, where all posted notes are digital, notes applied by one or another or a subset of conferees can be highlighted or otherwise visually distinguished if conferee identity is known. Visually distinguished notes can help conferees understand the development process, which conferees contributed the most content and the most useful content, etc.

Referring again to FIG. 15, in at least some cases a sensor device 750 may be presented within the single exit 710 to space 700 or, where there are more than one exit, a separate sensor device 750 may be provided in each exit 710. Here, sensor 750 may communicate with personal computing devices like a smart phone, a tablet device, etc., that is moved through the exit threshold to identify conferees that enter space 700 and others that leave the space 700. For instance, when a conferee passes through opening 710, sensor 750 may generate a signal that causes a personal device to generate an identifying signal that can be used by server 790 to recognize the conferee. In some cases the signal may be a Bluetooth signal, an RF signal or some other type of beacon or pinging signal. Cameras 730a, etc., can be used to determine when a conferee enters space 700 or exists space 700 based on if an instance of a human is identified moving from the threshold into the space 700. Once a conferee is identified in space 700, the conferee's identity can be associated with the representation of the conferee in video obtained from the room cameras.

Other ways of determining the identity of a conferee are contemplated. For instance, biometrics may be used to identify a conferee such as, for example, face recognition, an iris scan, a finger print reader, etc. In other cases when a user accesses an application on a personal computing device for use in space 700, the application may transmit the user's identity to server 790 which can be associated with the person at the location from which the identity data was transmitted. For instance, see again FIG. 24 where a smart phone 972 is used to obtain a digital image 982 of a post note. In that case, the smart phone will be programmed with the user's identity “e.g., John White in the illustrated example) and an indication of the conferee's identity 1002 may be presented via device 972 during image capture. The identity of the conferee would be provided along with the digital post note to server 790 via wireless transmission.

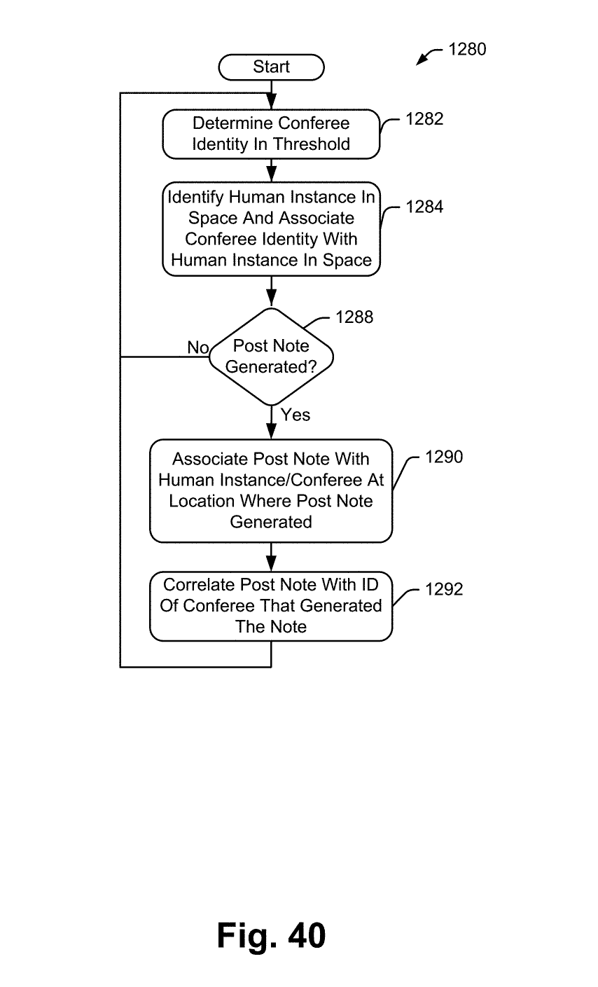

Referring now to FIG. 40, an exemplary process 1280 for identifying conferees and tracking conferees within space 700 is illustrated. At block 1282, server 790 determines the identity of a conferee as the conferee passes through threshold 710 using signals from sensor 750, and/or cameras 730a, 730b, etc. At block 1284, server 790 identifies representations of humans in space 700 that appear in camera video of space 700 and associates a separate user identity with each conferee. For instance, when a conferee's identity is identified in threshold 710, the next representation of a conferee in images generated by camera 730b may be assigned the identity of the conferee most recently in threshold 710.

Referring still to FIG. 40, at block 1288, server 790 monitors to determine when a new digital post note is generated by a conferee. Once a new digital post note is identified at block 1288, control passes to block 1290 where the new note is associated with the representation in obtained video of a conferee that was at the location at which the new post note was generated within space 700. Next, at block 1292, serer 790 correlates the new note with the identification of the conferee associated with the conferee representation. Thereafter, the digital note is associated with the conferee and follows the conferee about within space 700 for posting purposes.

In still other embodiments it is contemplated that cameras may be positioned with respect to the common display screens in a conference space to obtain images of the screens and analog content applied thereto via post notes or other types of analog tools (e.g., tear off flip chart pages, posters, etc.). For instance, referring again to FIG. 15, ceiling mounted cameras 730c, 730d and 730e are trained on screens 704, 708 and 706, respectively, to obtain images of content including analog post notes posted on those screens. In at least some cases each of the cameras will be able to recognize individual post notes placed on the imaged screens and will then focus in on each of the posted notes to obtain high definition images of each posted note where each high definition image is stored as a digital note. Once digital notes are stored for each analog posted note, processes like those described above to present digital notes when analog notes are removed may be facilitated. Thus, for instance, each analog note may be posted for only a few seconds to have the analog note converted to a digital form via the cameras presented at the posted location where the digital note then persists once the analog note is removed.

Thus, in a particularly useful embodiment of the present disclosure, the identity of each conferee within a conference space will be determined immediately upon the conferees entering the conference space and those identities will be associated with representations of conferees within video obtained in the space during the entire session. Conferees will use analog devices including sheets or post notes and pens, pencils or other drawing instruments to general analog content. The analog content generated by each conferee will be converted into digital content that mirrors the analog content and digital content generated by each conferee will be placed on a virtual content clip board for the specific conferee. When a conferee moves to a common display screen within the space to post a post note or other digital content, a gesture will cause a system server to present the conferee's virtual clip board on the common screen proximate a location at which content is to be posted. The conferee can move content from the clip board to the common screen to post. The conferee can also move content from the common screen to the clip board in various ways. This system enables analog content generation and input while still affording conferees all of the benefits of having content presented and moveable in a digital form.

D. Virtual Session Navigator

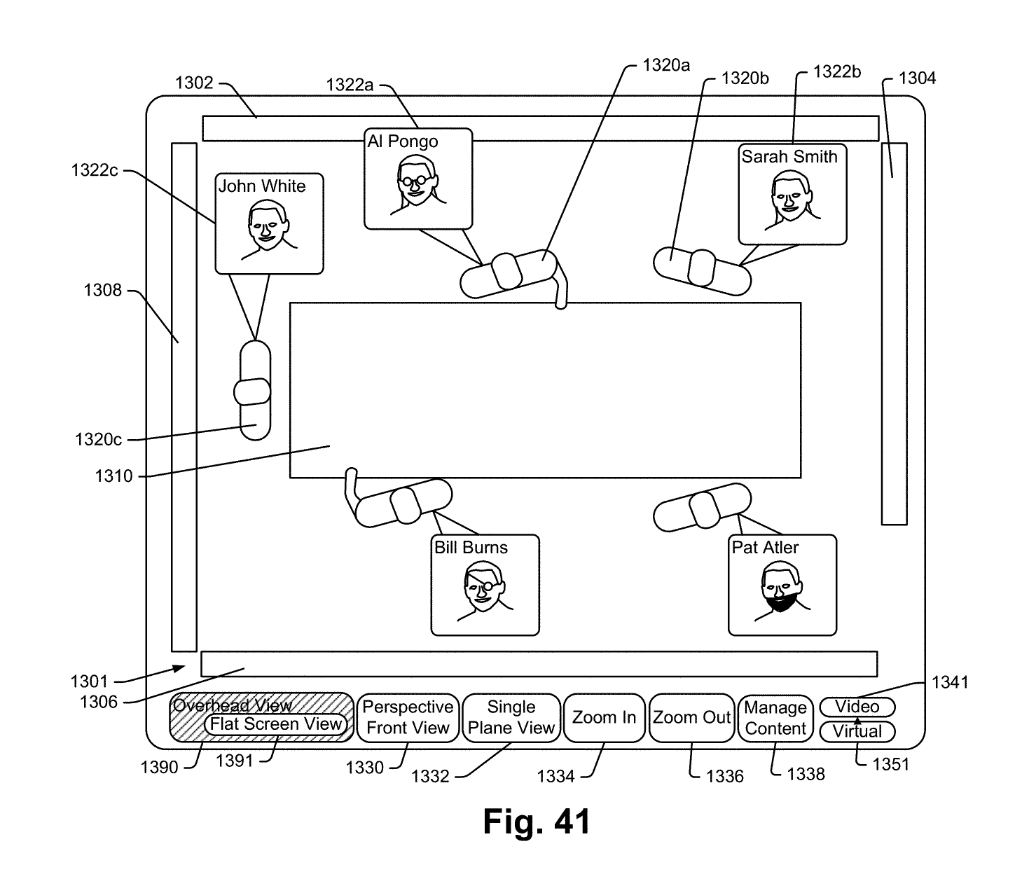

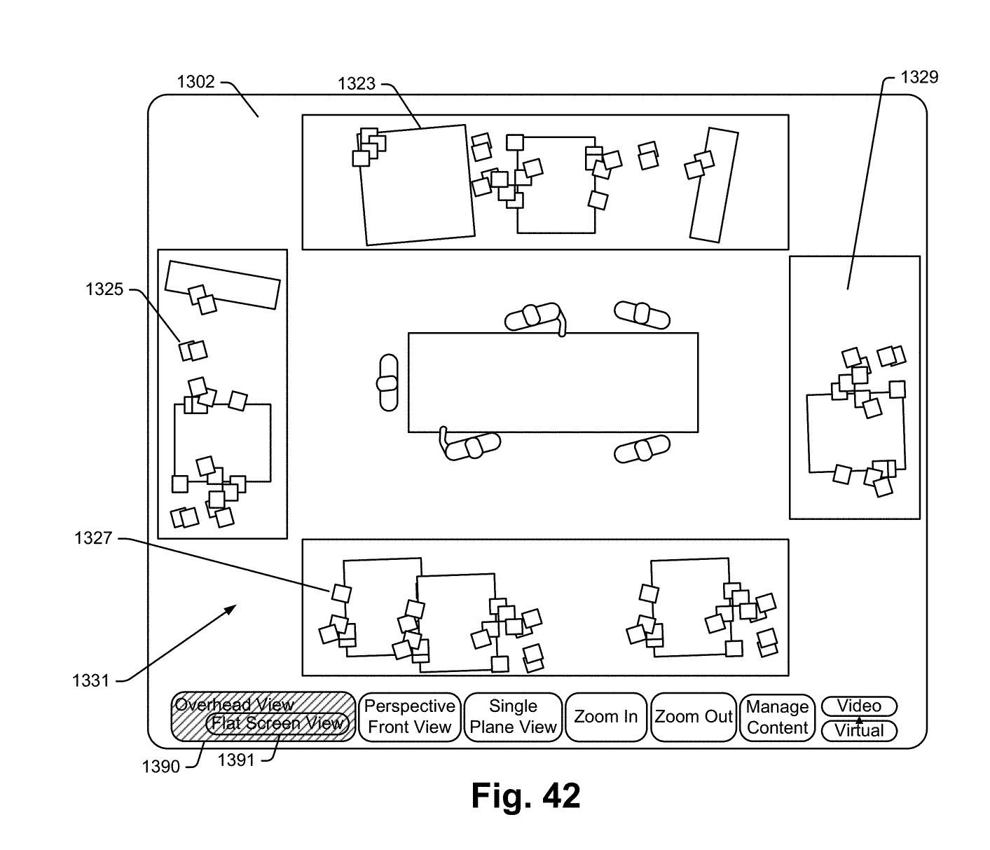

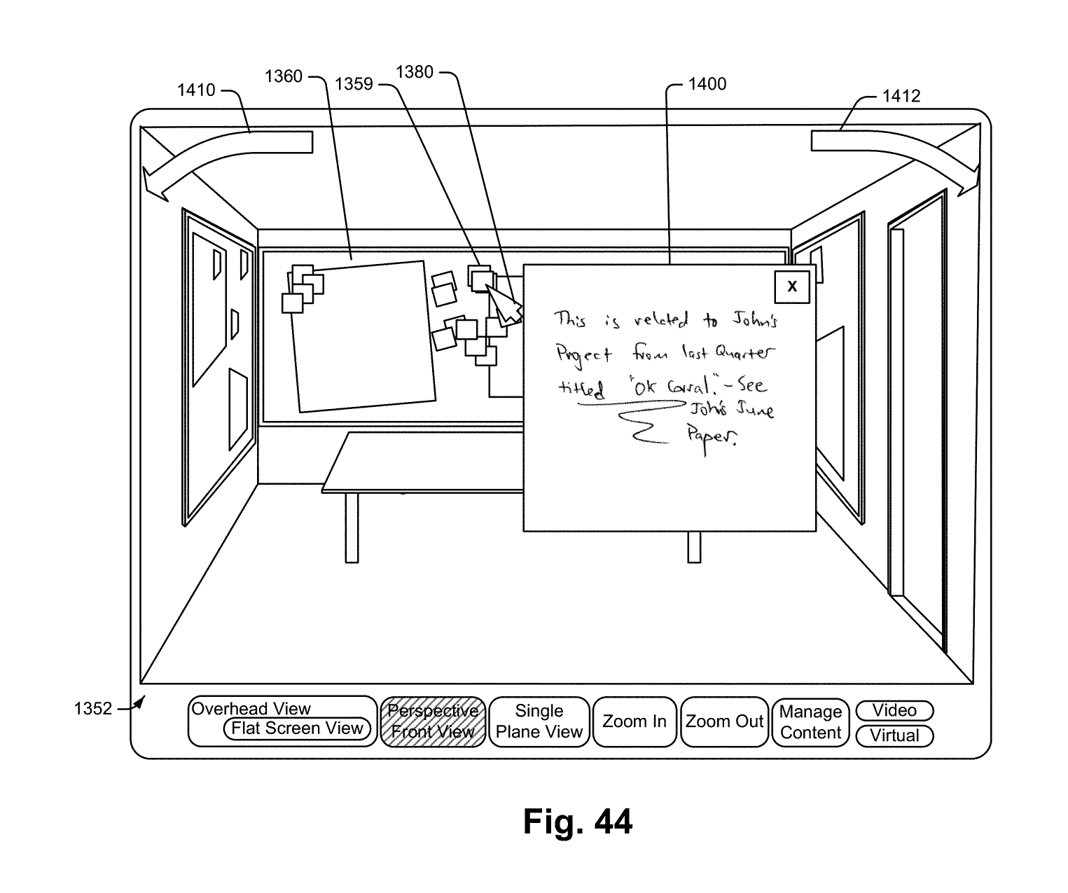

One other advantage associated with presenting all content in a conference space in digital form is that remote conferees can obtain views of all content presented within the conference space so that the remote conferees can more fully participate in local sessions. Full participation may include an ability to view all content generated by others within the local space as well as an ability to remotely generate and post content for others in the local space to view, manipulate, etc. The above system enables analog content to be represented as a digital echo for remote viewing and manipulation. To this end, another concept that is consistent with at least some aspects of the present disclosure is a virtual session navigator that enables remote conferees to choose any of several different views of a local session and session content. In at least some cases view choices include an overhead view (see FIG. 41), a perspective view (see FIG. 42) and a plan space view (see FIG. 44) where any of the views can be zoomed in or out to focus on different parts of a session scene and where different objects within the view can be selected to obtain more detailed information about the object or a better representation of the object.

Objects within a view will include content subsets such as a virtual sheet of paper that includes a drawing, a list of items, etc., a post note, a grouping of content such as a list generated on a virtual whiteboard portion of a common screen, content manually grouped together by a conferee via a lasso type action, etc. In some cases objects will also include representations of conferees within a scene where each representation can be selected to obtain information about the conferee, to focus on or view common content generated by the conferee, etc.

Referring now to FIG. 41, a screen shot 1300 that may be presented to a remotely linked conferee via a computing device display screen is illustrated. The screen shot includes a top or overhead view 1301 of the conference space and a tool bar along a lower edge for manipulating the view and for managing content in the session. A field 1431 is provided to indicate the current view shown in the current screen shot. The exemplary overhead view may be a real time video image of the conference space obtained via one or more overhead cameras (see again 730a in FIG. 15) or may be a virtual view that has a sort of cartoon like appearance based on the layout of the conference space. Buttons 1341 and 1351 can be used to toggle back and forth between the video and virtual views. In either case, the space view is defined by wall structures shown in top plan view at 1302. 1304, 1306 and 1308. Also viewable via the top plan view are large furniture artifacts in the conference space including table 1310. Because vertically aligned displays screens are not viewable from a top plan view, the screens on the walls are not shown.

In a video overhead view, a remote conferee would be able to see local conferees within the conference space and, where a system server 790 identifies and associates an identity with each of the local conferees, an identifier may be presented for each of the conferees. For instance, in FIG. 41, a first identifier window 1322a is linked to a first conferee 1320a in the view and identifies the first conferee as Al Pongo, a second identifier window 1322b is linked to a second conferee 1320b, a third identifying window 1322c is linked to a third conferee, and so on. The identifier windows may be open all the time in the overhead view or may only open when the person in the video is selected via a mouse controlled cursor or the like.

In addition to presenting identifying information, each one of the identifying windows may also include other information about the associated conferee. To this end, see that window 1322c indicates a job title for John White, a brief education summary, two articles recently published by John White, etc. The publications can be selected to hyperlink to the actual published documents. The additional information can be used by a remote conferee to better acquaint the conferee with each of the local conferees in the space.

In a virtual overhead view, conferees within the space are represented by virtual proxies that have a cartoon like appearance. Again, here, identifying windows like window 1322c may be presented either all the time or when requested by a remote conferee. In the virtual view, as local conferees move about within the conference space, their locations are tracked via images generated by system cameras (e.g., 730a in FIG. 15) and the virtual proxies are moved about within the view to reflect locations of the local conferees.

Referring still to FIG. 41, the tool bar along the bottom edge of the screen shot 1300 includes virtual buttons that are selectable via touch, a mouse controlled cursor, or some other known input device or feature. The buttons include an “Overhead View” button 1390, a “Perspective Front View” button 1330, a “Single Plane View” button 1332, a “Zoom In” button 1334, a “Zoom Out” button 1336, a “Manage Content” button 1338 and “Video” and “Virtual” buttons 1341 and 1351, respectively. The perspective front view button 1330 may be selected to switch the space view to a perspective view as shown in FIG. 42. The single plane view button 1332 may be selected to switch the space view to a view of one plane within the space as shown in FIG. 44.

The zoom in and zoom out buttons are selectable to zoom in or out on any current view of the space. Manage content button 1341 is selectable to remotely move content about within a local space and to create and post new content so that a remote conferee can participate in content generation and manipulation in a fashion similar to the way local conferees can participate. Video button 1341 and virtual button 1351 can be selected to toggle back and forth between virtual views and, where available based on camera angles and configurations, video views of the local conference space and content therein.

Referring again to FIG. 41, a sub-button on the overhead view button is a “Flat Screens View” button 1391. When the flat screens view button 1391 is selected, an overhead view 1331 including common screens laid flat is presented as shown in FIG. 42. This view is similar to the FIG. 41 view except that screen content within the conference space can be viewed from a high level. Thus, in a rectangular space including four screens on four walls, all four screens would be represented as shown at 1323, 1325, 1327 and 1329. To allow the screens to be presented in a large format other information from the overhead view in FIG. 41 is eliminated such as the conferee representations in the space and associated conferee identifier windows.

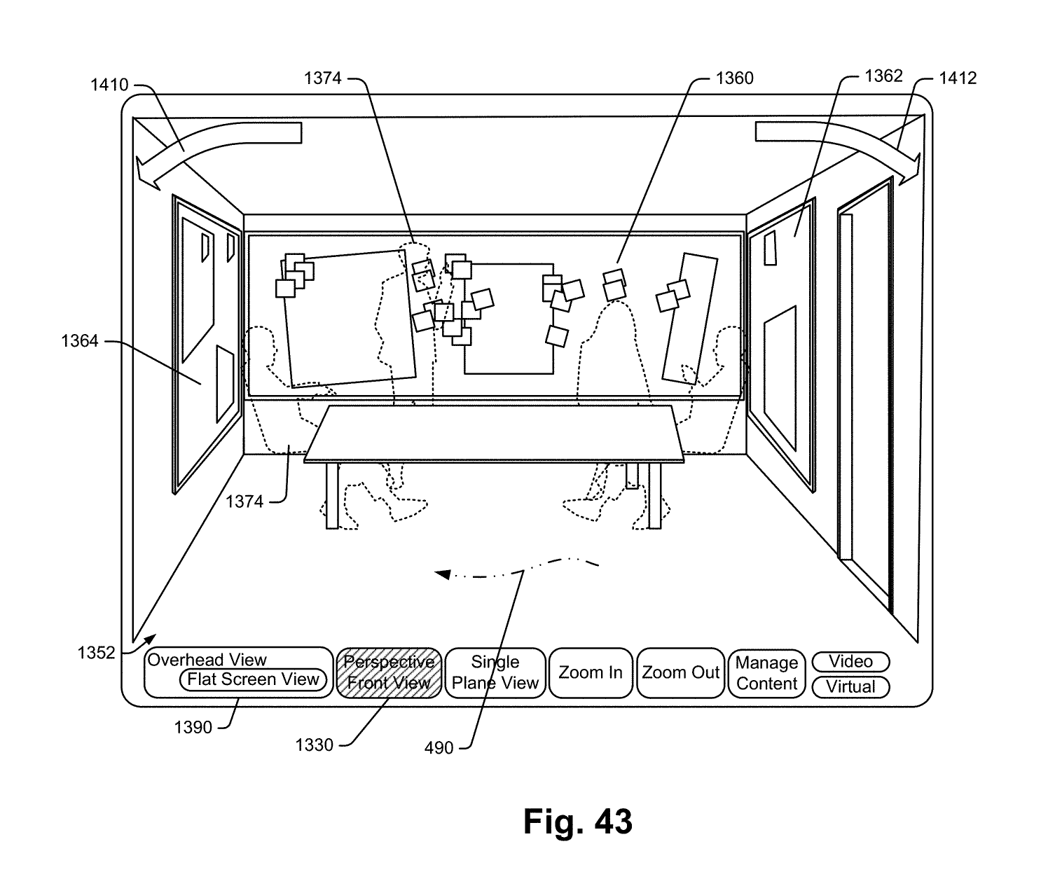

Referring to FIG. 43, a front perspective view 1352 of a conference space that may be presented via a screen shot 1350 when button 1330 is selected is illustrated. Here, a remote conferee can view the conference space from the perspective of a conferee within the space to see all posted content and the relative juxtapositions of the content. In this regard, three of the common screens are shown at 1364, 1370 and 1362 with a front on view of a centered screen and the other screens shown to opposite sides of the central screen at angles.

In FIG. 43, a remote conferee can view content and zoom in and out on the presented content to see different views of the content presented in the conferencing space. In addition, a conferee may be able to select any content within the space to obtain a relatively large version of the content to view. For instance, see also FIG. 44 where a relatively small post note representation 1359 on screen 1370 has been selected via a pointer icon 1380 causing the system server to present a larger version of the post note at 1400 for easy viewing. After viewing a larger version of the note the conferee can simply close the larger version to remove that version from the screen.

Other navigation tools may also be presented. For instance, referring still to FIG. 43, to rotate within the space counterclockwise or clockwise to change the view of the space and screen content, a remote conferee can select rotate buttons 1410 and 1412, respectively. In some cases one click on a rotate button will rotate a remote conferee's view by a preset number of degrees such as, for instance, fifteen degrees. In other cases a single click may cause the remote conferee's view to rotate 90 degrees so that the conferee is viewing a next one of the common display screens head on. In some embodiments a swipe gesture on the face of the conferee's display screen (see 1490 to the left in FIG. 43) may cause the view to rotate in a smooth fashion where the degree of rotation can be reversed and moved forward by moving the conferees finger across the swiping trajectory until a desired view is generated. Similarly, well known zooming action may be facilitated via two finger pinching or expanding gestures on the display screen.

Again, as in the case of the overhead view, the perspective view may be either a real time video view or a virtual cartoon like view and a conferee may be able to toggle back and forth between those views via buttons 1341 and 1351. In the video view conferees would appear all the time. In the virtual view the conferees may or may not be presented in the view. In some cases conferees or representations thereof may be presented in phantom so that a remote conferee can get a sense of how local persons are arranged in the local space. In some embodiments the interface on a remote conferee's display may enable the remote conferee to select whether or not remote conferees are present in a virtual view and in which type of representation (e.g., phantom or filled in) and whether or not conferee identifying windows (see again FIG. 41) are presented along with each local conferee representation.

When in perspective view as shown in FIG. 43, a conferee can zoom in and out of any view to get different perspectives of the content posted within the space.

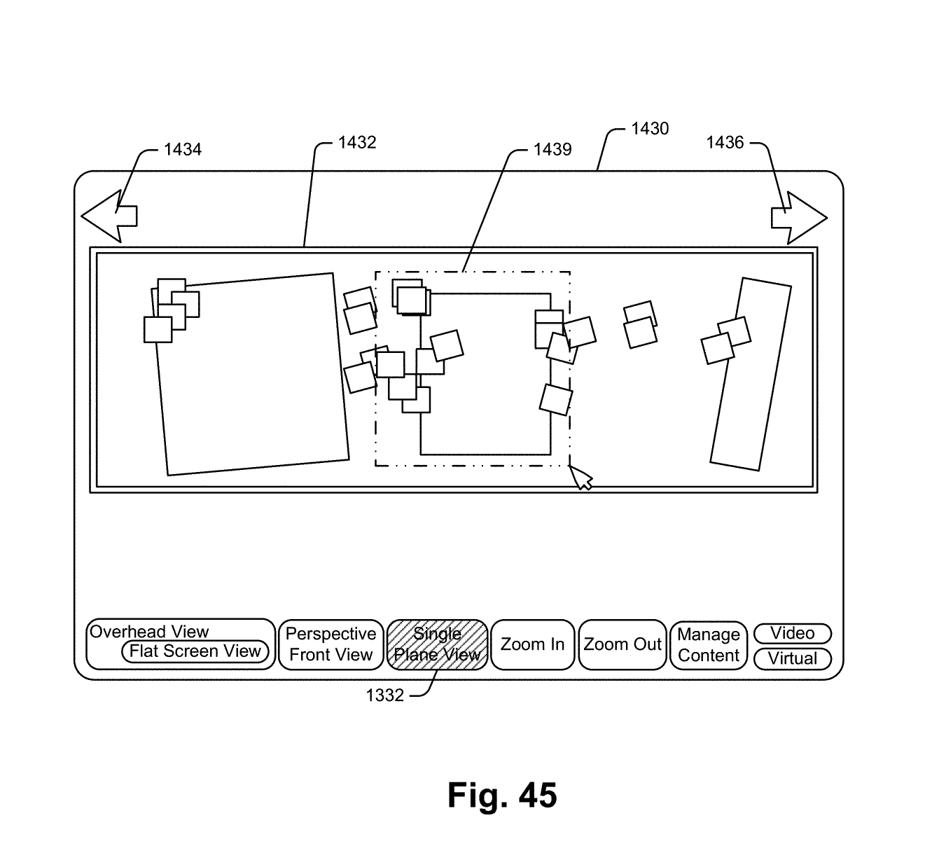

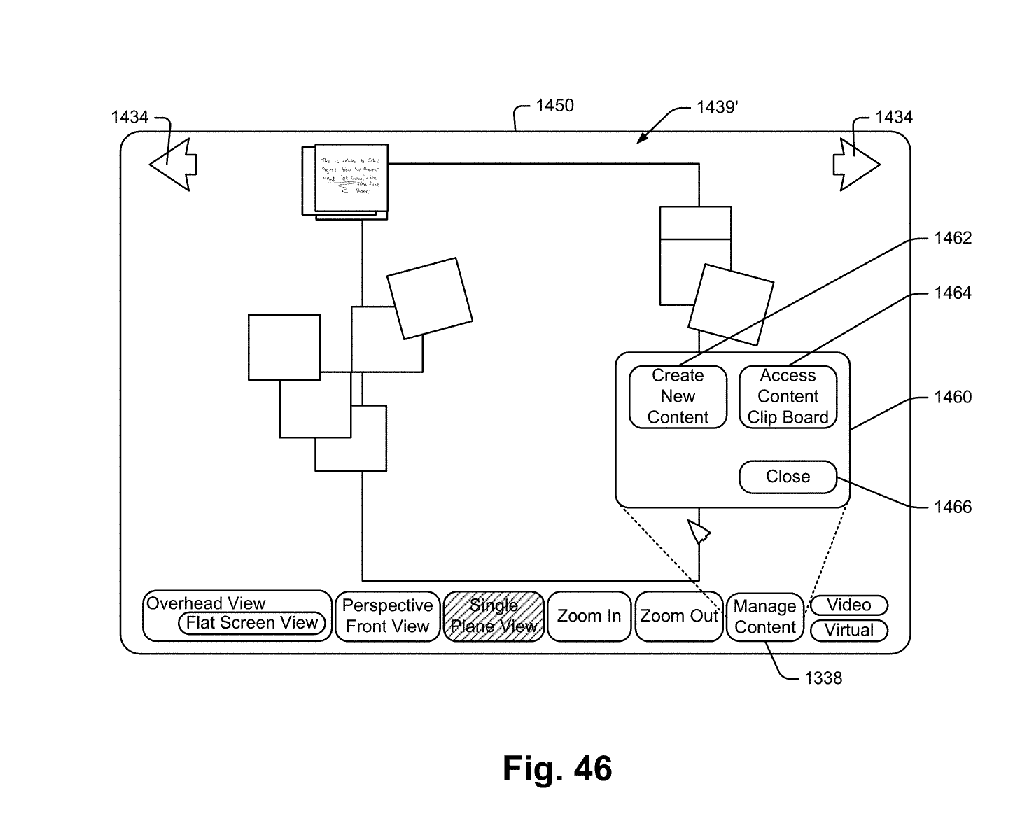

Referring now to FIG. 45, a screen shot 1430 showing a single plane view of a local conference space that is generated when button 1332 is selected is shown. Here, one wall of a conference space is shown in either video view or in a virtual view so that a remote conferee can appreciate the relative juxtapositions between content presented on the wall and the local display screen represented at 1432. Again, separate notes and other content may be selected to generate larger views to examine content more closely. In this regard see that a pointing icon has been used to select an area 1439 including a subset of the content shown in FIG. 45 which is represented in a larger format 1439′ in FIG. 46. Pan icons 1434 and 1436 are provided for moving left and right in the single plane view. Again, on screen gestures may also be used to pan, zoom, etc., in the single plane view.

Referring still to FIG. 46, the “manage content” button 1338 can be selected to create new content or to access a remote conferee's virtual content clip board. To this end, when button 1341 is selected, a content management window 1460 is opened which includes a “Create New Content” icon 1462 and an “Access Content Clip Board” icon 1464. When button 1462 is selected, content generating tools are provided to the remote conferee via the conferee's display screen. For instance, in some cases where the remote conferee's computing device includes a camera, the remote conferee will be able to generate content via a conventional ink pen or pencil on an analog post note which can be digitized by using the camera to take a picture of the face of the note. Once a note image has been generated, the remote conferee's device creates a digital note that mirrors the analog note. It is contemplated that the remote user's device will provide instructions to the remote user for generating a digital note via analog tools and obtaining an image thereof.

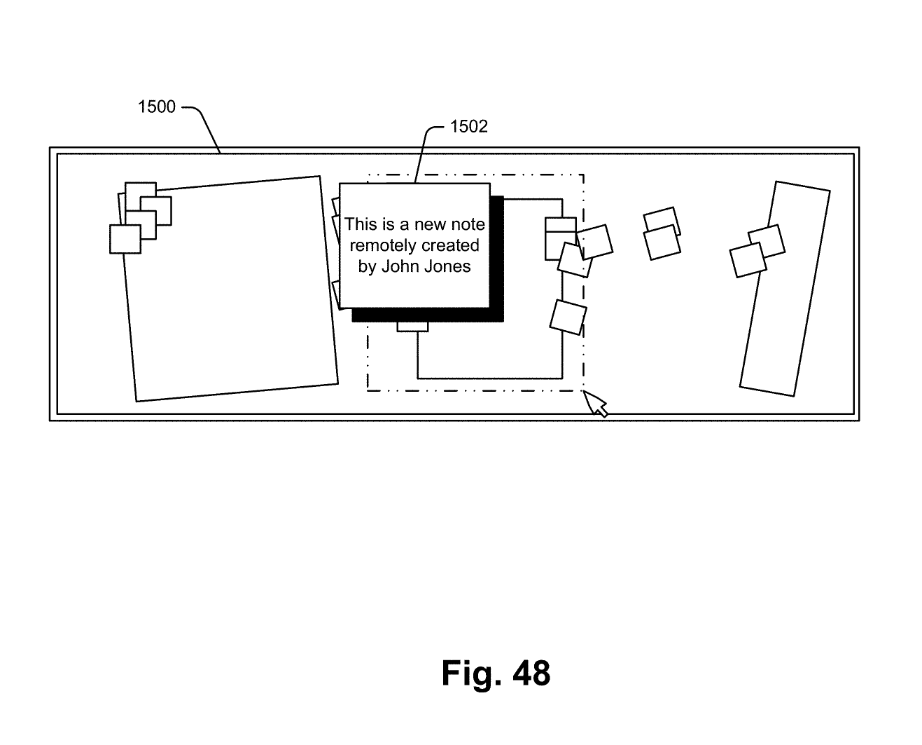

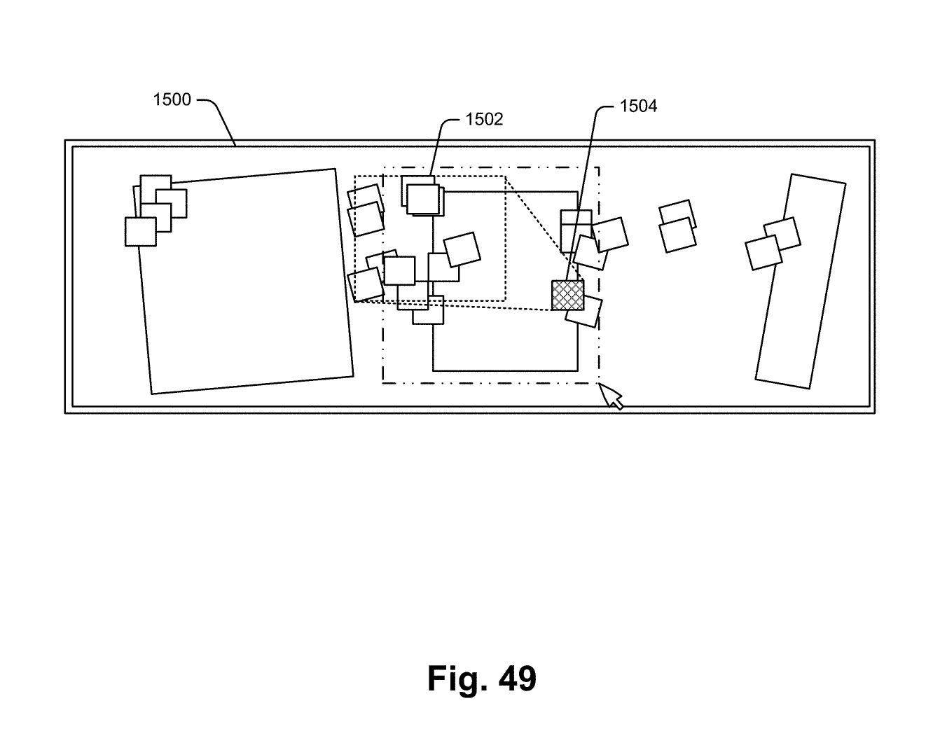

The digital note may be added to the remote conferee's virtual clip board. In the alternative, the new digital note may be presented on the local space view currently presented on the remote conferee's display screen for immediate placement by the remote conferee. In this case, the remote conferee can touch the display screen to select the note and can move the note about on the screen via a dragging action or gesture to a location at which the conferee intends to post the note. When the note is placed remotely, the note is digitally presented in the same location in the local space for local conferees to consider. In at least some cases the local screen on which the new remotely posted note appears may be highlighted or otherwise visually distinguished or called out for at least a short period (e.g., 5-10 seconds) to help local conferees perceive the new note. For instance, see FIG. 48 where a local view 1500 of a local large common display screen is shown with a new note 1502 remotely created by a conferee Jennifer Jones is shown in large scale and with a highlight so that local conferees can see the note and understand the content on the note. The large version of the note 1502 may be presented for ten seconds and then moved to the location selected by the remote conferee in an animated fashion to simulate a manual posting process so that local conferees can immediately comprehend where the note is posted within the larger local space and relative to the locally presented content. In this regard see also FIG. 49 where the new note 1502 is shown in large format in phantom and in a smaller placed and highlighted format at 1504 to represent an animated presentation.

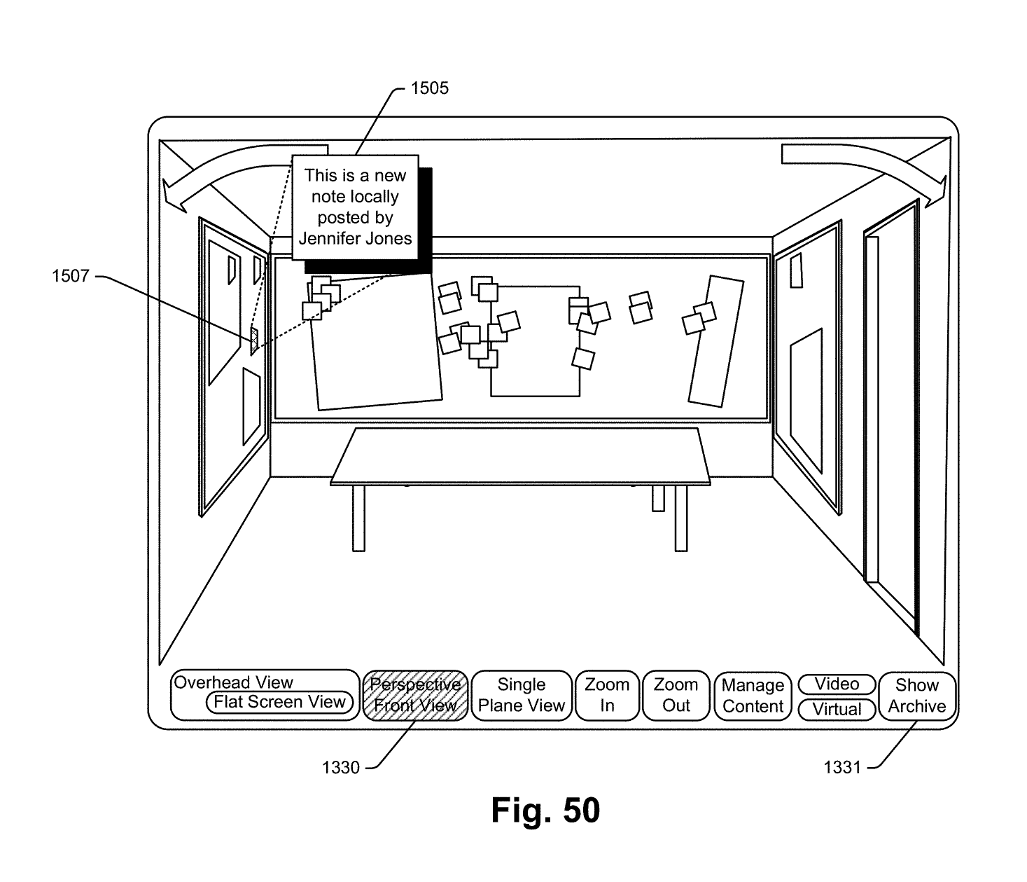

In at least some cases it is also contemplated that when a new note or other content is added to a local common screen, the addition will be announced on remote screens to clearly indicate an addition, show the content of the addition and show the location of the addition. To this end, see the exemplary note 1505 shown with a shadow in FIG. 50 on a perspective front view on a remote screen and the visually distinguished smaller version of the note at 1507 to show placement of the note. The 1505 representation may only be temporary (e.g., a few seconds) or it may be that a remote conferee has to cancel the note to remove the note from the remote screen to ensure that all remote conferees are aware of new notes or other newly added content.

Referring again to FIG. 46, in other cases when button 1462 is selected, the remote user's device may be useable to directly generate a virtual digital note or other content to be posted. For instance, see again FIG. 39 where a digital post note is represented on a user's display screen 1252 for receiving content via touch or a keypad. Here, when a remote conferee selects icon 1256, the note may either be added to the conferee's clip board or may be presented on the conferee's display screen in the current view of the local space on the display for movement to a final posting location.

Referring yet again to FIG. 46, when button 1464 is selected, the remote conferee's device presents the remote conferee's clip board 1520 that the conferee can use to post content at any location on the common screens within the local space. Again, the user can touch and drag notes or other content from the clip board to specific locations in the remote view causing the digital note to also be posted at the same location on one of the local screens. The remote conferee can use the different views of the local space to move about the space looking for the desired places to post notes from the conferee's clip board. Again, placed notes will be highlighted or visually distinguished (see again FIGS. 48 and 49) in some fashion for at least a short period so that local conferees can perceive new postings.

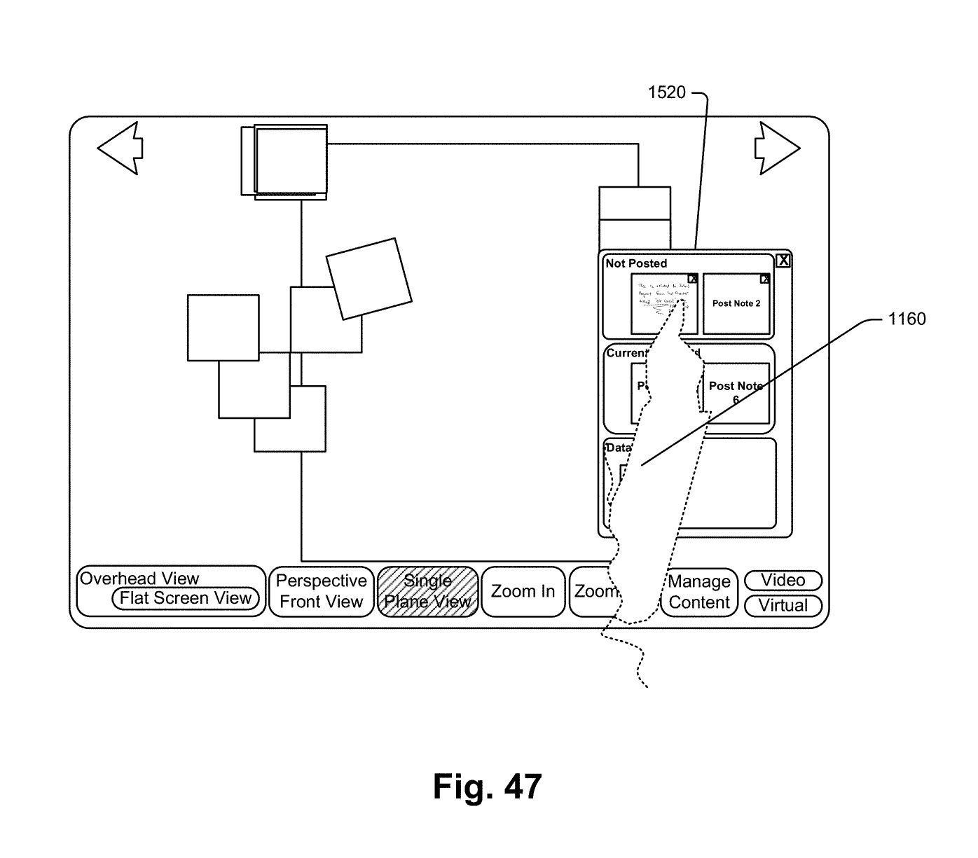

In some cases, instead of using the “manage content” button to access a clip board, a remote conferee may use the same gestures that are locally used by conferees to access their clip boards. For instance, while viewing local content via a remote screen as in FIG. 47, a remote conferee may simply draw a “P” to indicate a desire to post a note at the location causing the conferee's device to present the conferee's clip board 1520 adjacent the location at which the “P” was drawn. Thus, in at least some cases it will be advantageous that gestures for posting content and other processes be identical for local and remote users so that persons that use the system regularly will develop a single sense of how to interact with the system.

In at least some embodiments, remote conferees can also delete local content and move local content. To this end, in some cases a remote conferee can draw an “X” across content on view presented by a remote device to delete that content from the remote device view as well as from a local screen. Here, again, the change may be visually distinguished so that local conferees can clearly see that the deletion is occurring. As another example, the remote conferee's device may allow the remote conferee to double tap on or otherwise select a note or other content to highlight the selected content and then the conferee may be able to navigate to a different location in the virtual remote view to identify a new posting location and a second double tap or other location selection may cause the remote device to move the note to the new location and also cause the local system to move the associated local note in the same fashion. As still one other example, a remote conferee can move an existing posted note to the local conferee's clip board and can subsequently re-post the note at a different location.

In at least some cases it is contemplated that some indication of which local content is being viewed by a remote conferee may be provided to local conferees. To this end, see again FIG. 15 where a phantom box 1202 is presented on screen 704 and is labeled with a remote conferee's name (e.g., “Bill Ehrman”) to show local conferees the subset of content and screen area currently being represented on a remote screen used by the remote conferee. Where multiple remote conferee's patch in to a session, a separate box 1202 may be presented for each of the remote conferees. The boxes 1202 may be able to be turned on and off by local users or a remote user. For instance, a remote user may want to point local users to specific content within the local space.

Although the virtual navigator concept has been described in the context of a remote conferee using a remote device, the virtual navigator may also be presented on one or more local conferee's devices and may be used in a similar fashion to that described above to generate and manipulate content within the conference space.

The digital echo and virtual session navigator concepts described above assume that large common displays screens for posting digital content that echoes analog content are provided in a conference space. In other embodiments it is contemplated that only analog content may be posted in a conference space and that various tools may be useable to generate the digital echo in a fashion similar to that described above. For instance, all analog content may be digitally captured and mimicked to create the virtual session navigator view for remote viewing or viewing after the analog content is removed from the conferencing space. Thus, an analog space can persist digitally after the analog space is disassembled.

In still other cases hybrid systems are contemplated where analog and digital content at a local space is echoed digitally. For instance, digital content and notes may be posted on the large common screens within the conference space 700 and may be supplemented via analog content such as large torn off flip chart sheets and analog notes posted about the space adjacent or partially overlapping the common screens. Here, the analog content on the chart sheets and analog notes can be digitally captured as described above and added to a virtual session navigator in a digital form.

E. Room as Story Teller

In at least some cases it is contemplated that the system server may perform additional functions useful to a conferencing group. For instance, the server may be programmed to store snapshots of session content during a session that can be subsequently accessed in sequence to understand how a session has progressed up to a current time. This feature may be useful when a new conferee joins a group and needs to be brought up to speed on progress of the group up to the current time. This feature would also be useful for an executive that wants to check in on progress of a group of innovators. In addition, even a persistent team of conferees may want to regularly or periodically review the process they followed to develop final or intermediate work product.

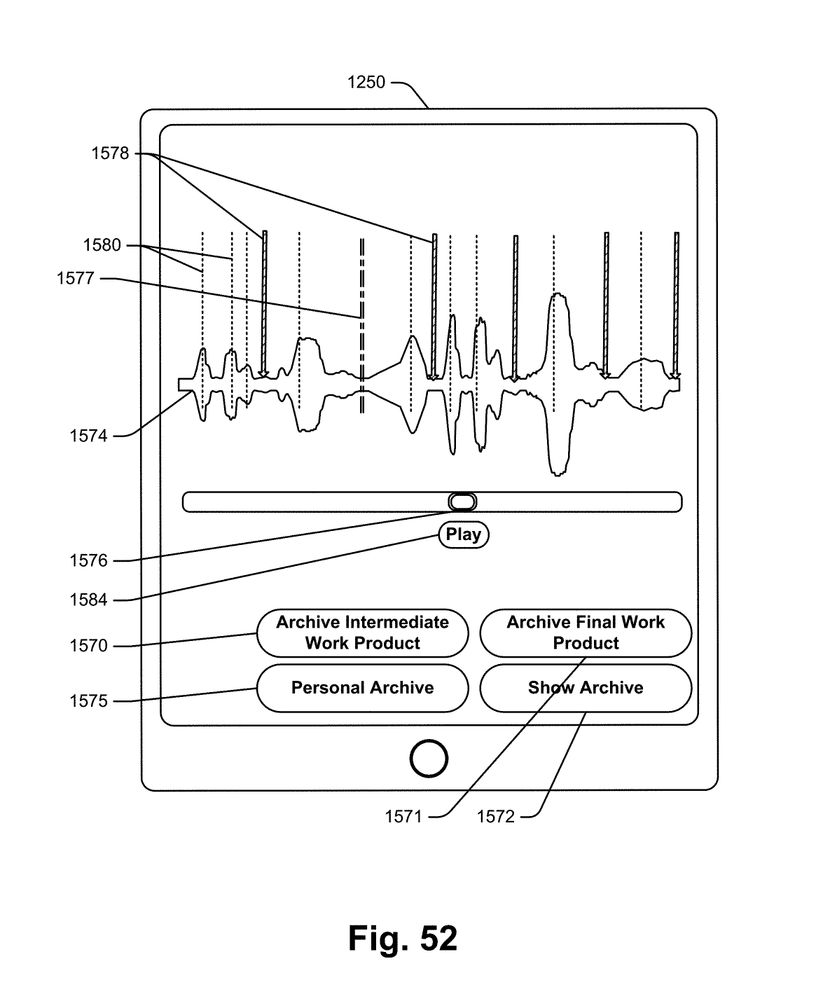

While the system may store all content as it is dynamically developed along with times associated with all developed content, when reviewing the content it would be helpful for important developments in the content or work product to be earmarked for easy identification and subsequent access. Thus, for instance, where a work product breakthrough occurs, it may be useful to earmark the resulting content at that time for subsequent access. Where a group is about to diverge down a new line of thinking it may be a good time for the group to store content for subsequent access. If a new conferee joins a group it may be time to store a content snapshot as the new conferee may redirect the group. In at least some cases it is contemplated that conferees will be able to manually indicate to the system server that a snapshot of content should be stored and earmarked for subsequent access. To this end, see FIG. 52 where a simple archive interface is presented on a conferee device display screen where the interface includes two selectable buttons, a “Show Archive” button 1572 and an “Archive Final Work Product” button 1571. Here, to store a snapshot of a session, button 1571 can be selected to send a wireless signal to the system server causing the server to store an instantaneous snapshot of all the content on all of the display screens within the conference space. Button 1572 can be selected to access the archived session data for subsequent viewing.

In addition to a system where content is archived manually, an automated system where the server monitors for specific actions or circumstances and earmarks content snapshots or specific periods during a session is contemplated. For instance, where there is a rapid large change in content presented in a space, the system may automatically store the content just prior to the change and also just after the change as snapshots in time. As another instance, where content is pared down substantially, the server may be programmed to store snapshots of the content just before the paring down and just after the paring down is completed. For example, where conferees have developed a list of fifteen items on a common display screen to consider and that list is pared down to four, the server may store the list of fifteen items as well as the list of four items.

As another instance, whenever a team stores content as an intermediate or final work product, the system server may use the work product as a starting point and work back through previously stored session content to piece together a story about how the work product was developed. For instance, if a list of four items is stored as work product for a session, the server may start with the list of four items and work back to a larger list of fifteen items that was pared down to four and work back through the development of the original fifteen items searching for particularly active sub-periods of the session when team activity was high and may store video clips, intermediate work product, comments by conferees, etc.

As yet one other instance, if a set of conferees focuses on a specific content set for a prolonged period, the server may store that content for subsequent access as that content is likely interesting to the conferees and may represent a pivotal moment in time for the conferees. Many other triggers for automated content snapshots in time are contemplated.

Whenever a content snapshot is stored, in at least some embodiments, the server may query one or a subset of the conferees for a comment regarding the significance of the content when stored. The comments may be captures as text, audio clips or even video clips. The comments may become part of the session record to be viewable along with the snapshots of content at subsequent times and would provide good reminders to conferees about what they were considering at the time the content snapshots were stored. Specific queries are also contemplated based on circumstances.

For instance, where conferees struggle (as evidenced by time, images, etc.) to make final cuts to a list to get to a set of four items, the system may query one or more conferees for a comment memorializing the final reasoning for cutting the last two or three items on the list to archive thinking. Similarly, when intermediate or final work product is stored by a conferee, the system may query the conferees for comments regarding development of the work product to be stored along with the work product as part of the story of the session.

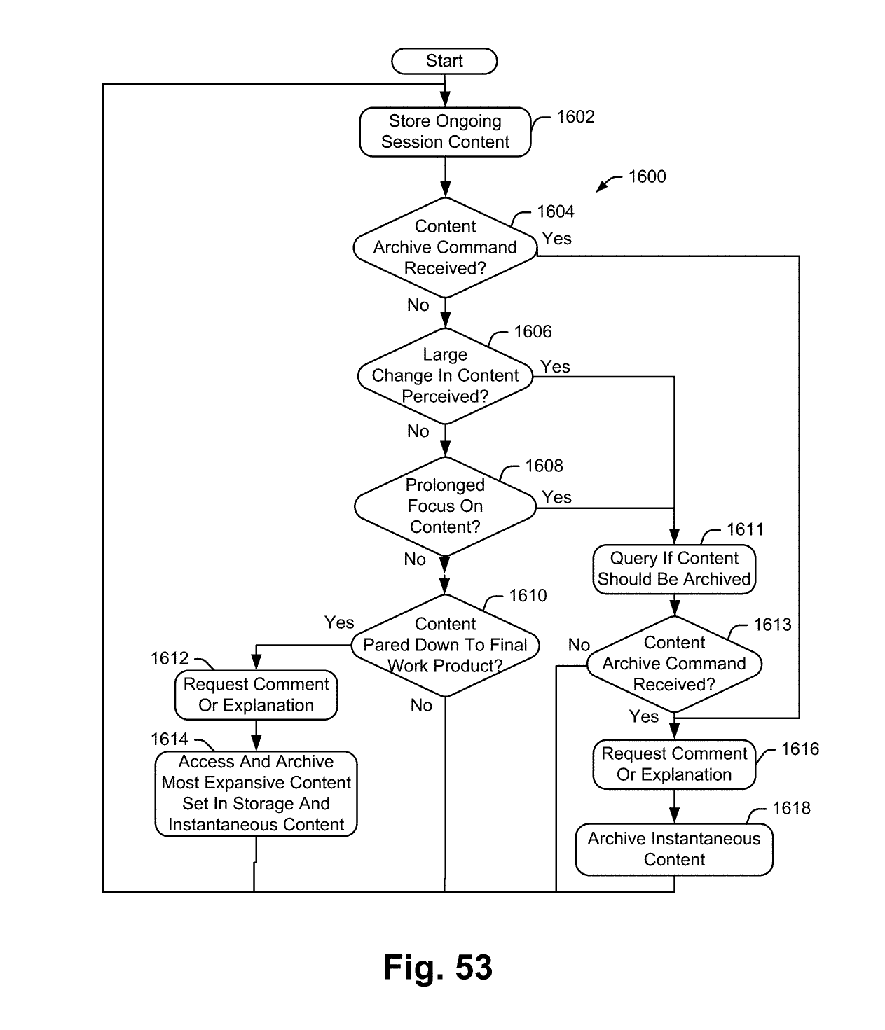

Referring now to FIG. 53, a process 1600 for memorializing content generated during an ongoing session is illustrated. Referring also to FIG. 15, at block 1602, a system server 790 time stamps and stores session content for subsequent access. At block 1604, server 790 determines if an archive command has been received from one of the conferees (see again button 1570 in FIG. 52). Where an archive command is received control passes to block 1616 where server 790 queries one or more conferees for a comment regarding the state of the content at the time the archive command was received. Again, the comment may be captured via content applied to one of the display screens, via an audio recording on a conferee, via a video recording of a conferee, etc. The option to forego comments would also be presented at block 1616. After block 1616, any comments provided by a conferee are archived along with the instantaneous content presented in the space for subsequent viewing after which control passes back up to block 1602 where the process described above continues to loop.

At block 1604, if no archive command has been received, control passes down to blocks 1606, 1608, 1610, etc., to assess if some trigger within the space has been perceived that may signal a useful time to archive or earmark a snapshot of the session content. For instance, at block 1606 the server 790 determines if a large content change has been perceived while at block 1608 the server 790 determines if there has been a prolonged focus on specific content within the space. If either of the conditions at blocks 1606 or 1608 occurs, control passes to block 1611 where server 790 queries at least one and perhaps all conferees requesting a command to archive the content. If an archive command is not received at block 1613, control passes back up to block 1602 where the process continues to cycle. If an archive command is received at block 1613, control passes to block 1616 where server 790 requests a comment to be stored along with the content at block 1618.

If neither of the conditions at block 1606 or 1608 are satisfied, control passes down to block 1610 where server 790 monitors session content to perceive when final work product is stored after a substantial paring down of a larger body of content (e.g., from 15 to 4 items on a list). Where substantial paring has occurred, server 790 control drops to block 1612 where the server 790 requests a comment from one or all conferees and then at block 1614 server 790 archives any received comments with the instantaneous content as well as works back through the stored content to identify a most expansive set of the content that resulted in the final smaller work product to be archived as part of the historical story associated with the final product.

Thus, there are three ways to archive content represented in the FIG. 53 process. First, a conferee can manually indicate that content should be archived at any time (see block 1604). Second, the system server can identify possible interesting conditions that may trigger archiving and may present the option to archive to one or more conferees (see blocks 1606, 1608 and 1611). Third, the system server may identify conditions that trigger the server to automatically archive content without requiring a conferee to request archiving (see blocks 1610 through 1614. In addition, content to be archived may be a snapshot in time of content presented on common screens within a space or may also include other content associated with the snapshot in time content leading up to the snapshot as part of the development story.

It is contemplated that in many cases conferees may be unsure about when content should be earmarked to memorialize a significant change the in conference activities until sometime after an activity occurs. For instance, when a list grows to nine items, is that the end of the list or will the list grow to fifteen? Is a particular discussion among conferees important or will a subsequent discussion better capture the essence of a particular topic? Often times these types of questions can only be answered in hind sight. For this reason, in at least some embodiments it is contemplated that an interface may be provided to enable conferees to move through the time line of a conference session reviewing and re-listening to content and conference activities so that particular points in time or periods of a session can be marked as relevant to telling a streamlined story of the session. To this end, see again FIG. 52 where an exemplary interface includes an activity histogram 1574 and a sliding button 1576 that may be presented via device 1250 when the “Show Archive” button 1572 is selected.

In FIG. 52, histogram 1574 shows a representation of a conference session that has occurred over a subsequent time period (e.g., the prior few hours, a prior few days, etc.). The histogram graphically illustrates times of divergence and times of convergence as discerned by a system server based on information sensed within a conference space. For instance, where content (e.g., verbal, on displays, etc.) generated within a space has many themes in a short period a time of divergence may be detected and where themes narrow during some time period so that a consensus is being reached a time of convergence may be detected. Divergent times are represented by wide portions of the histogram while convergent times are represented by narrowing portions of the graphic. Thus, viewing the histogram a conferee can obtain a general understanding of how a session has progressed and an appreciation for the ebb and flow of ideas during a session.

Referring still to FIG. 52, sliding button 1576 may be moved along the illustrated slide range to move to different times along the histogram 1574 and change the content presented within a conference space (see again FIG. 15) so that the content reflects the content that was presented in the space at the time corresponding to the time selected on the histogram. The presented information may represent a snap shot in time. Where the system stores all content including audio and video associated with a session, once a time is selected on the histogram, the system may present a “play” button 1584 on the interface that can be selected to play the archived session from the selected time forward. Here, play may mean stepping through content development as the content occurred and playing back audio in the conference space as the audio occurred. In other cases video may also be presented on some secondary screen (e.g., the interface device 1250 in FIG. 52) to show actual activity within the space as the information on the common display screens steps through the session content.

It has been recognized that some work product represented by content presented at a specific time in a session will be considered more important than other content presented in the space at other times but that the other content may be important for understanding how the more important content is developed. For instance, an intermediate list of fifteen items may be important supporting information for an understanding of how a final list of five items was developed. Here, however, while the list of fifteen items may be important for an understanding of the final list of five, the list of fifteen may be relatively unimportant to a subsequent list of ten other items that is developed. Thus, there is a need for some way to associate intermediate session content or work product with final work product so that a series of stories about session content can be memorialized for subsequent access.

To this end, see again FIG. 52 where the interface includes an “Archive Intermediate Work Product” button 1570 in addition to the “Archive Final Work Product” button 1571. Here, it is contemplated that while a conferee or a set of conferees are reviewing prior session activities, a conferee may select the final product button 1571 to indicate final work product (e.g., a final list) during a portion of a session and may then select other points in time or periods of a session as intermediate work product via selection of button 1570. Here, any selected intermediate work product would be associated with the most recent final work product. In FIG. 52, the interface indicates several instances of final work product via arrows 1578 and several instances of intermediate work product via lines 1580.

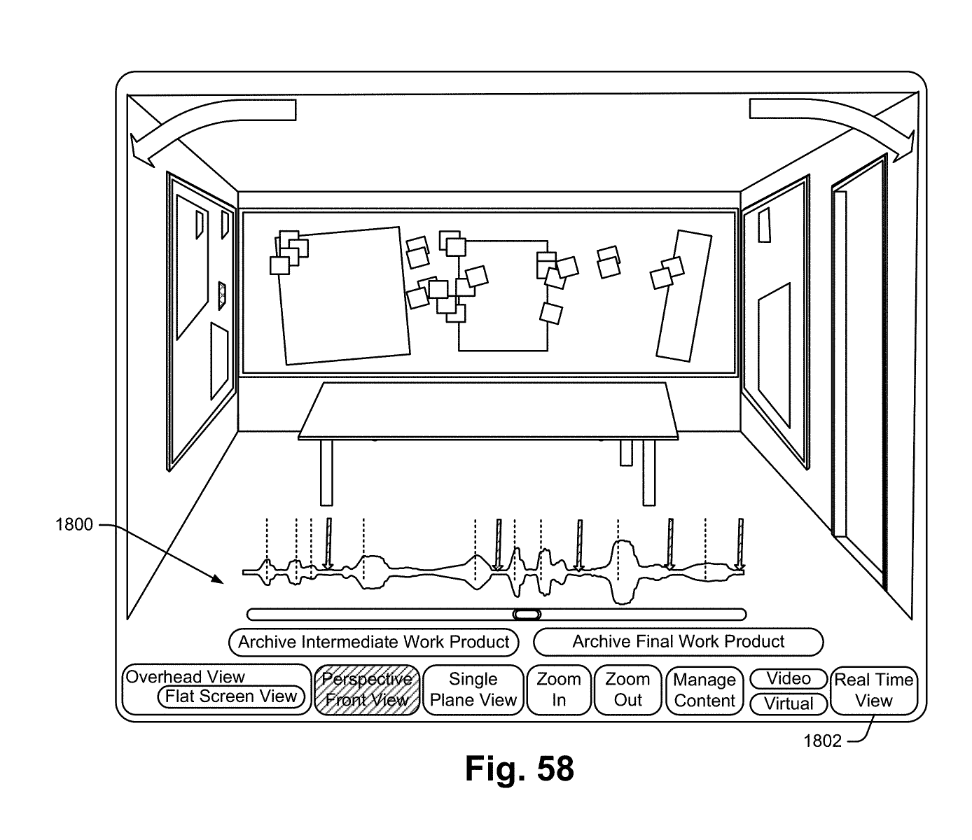

In some embodiments a remote conferee may also be able to move through a stored session in a fashion similar to that described above with respect to FIG. 52 to view session activities and content as well as to earmark content to memorialize a story. To this end, see that the interface in FIG. 50 includes a “Show Archive” icon 1331 akin to the show archive icon 1572 in FIG. 52. When icon 1331 is selected an interface like the interface in FIG. 58 may be presented that includes a histogram and sliding button tool as well as the work product archive buttons collectively labeled 1800 that are akin to the histogram, sliding button and archive buttons shown in FIG. 52. In FIG. 58 the difference is that the archived content is presented on the top portion of the device display. Here, the zooming tools and view selection tools described above may be presented to enable a conferee to move about within the virtual space and within time to view content and to mark specific content for archival purposes. A real time view button 1802 can be selected to access a real time virtual view of a session as the session is ongoing.

In still other embodiments it is contemplated that different conferees may want to archive different information from a session for their own purposes. For instance, a first conferee may identify specific session content as likely valuable to another ongoing conference discussion in which the first conferee is a participant. As another instance, a second conferee may want to memorialize and store a different development story than the one being archived by a larger group. In these cases, it is contemplated that any conferee may be able to earmark conference content or activities at any time including in real time or historically via an interface like the one shown in FIG. 52 by selecting a “Personal Archive” button 1575. When content is personally archived, the personally archived content may be indicated via a visually distinguished line or the like on the histogram 1574 as shown at 1577. Personal archive indicators may only appear on a specific conferee's interface and may not be presented to other conferees viewing a histogram.

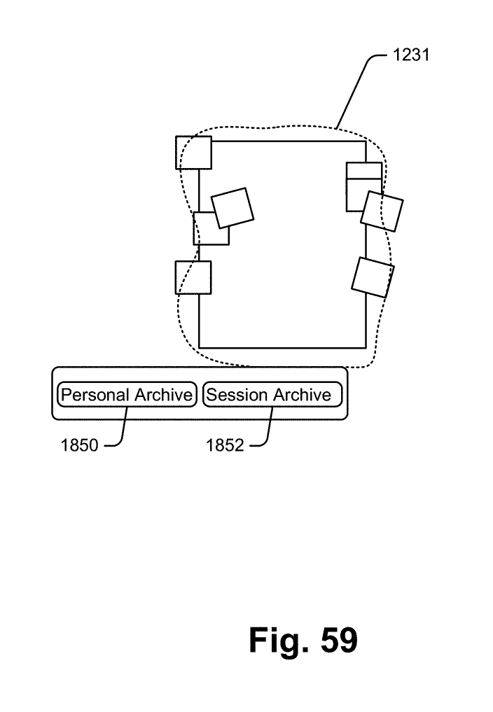

In at least some embodiments it is contemplated that a conferee may be able to archive subsets of content presented at any time within a conference space for either a session archive or a personal archive. For instance, referring again to FIG. 34, a conferee may use a finger or an on screen drawing tool to lasso a subset of content presented within a conference space to be archived. Once content is selected, one option may be to archive the content. To this end see FIG. 59 where a pop up window is shown that includes both a “Personal Archive” button 1850 and a “Session Archive” button 1852. The buttons 1850 and 1852 can be selected to archive the lassoed content in a selected database. In at least some cases any time content is archived by a conferee, a line will be added to a session histogram to show the time when the content is archived.

In some embodiments, in addition to or instead of archiving historical content that can be used to tell a development story, server 790 may also be programmed to perform some analysis on or synthesis of content in a conference space and provide alternative perspectives as part of a prospective story for a team of conferees. For instance, in a simple example, a group of conferees in a space may be discussing innovation practices without generating any actual content on common display screens. The system server 790 may obtain voice annunciations from each of the conferees, convert the voice annunciations into text, use frequent terms to generate and perform internet search queries and return content in the form of text messages on the common display screens within the conference space. In addition to returning content, the server 790 may analyze the obtained content to synthesize some concepts. For instance, where conferees are talking about the main sub-processes to perform during an innovation workshop, the server 790 may search for articles on innovation and, in addition to reporting the articles, may search the articles for lists of innovation sub-processes. If twenty articles have lists of sub-processes, the server 790 may look for common similarities in all or a majority of the lists and may synthesize a generally accepted list of sub-processes as well as a second list of sub-processes including all sub-processes that appear on any of the 20 lists at least once and that do not appear on the common list. Here, the server 790 may present the common list as well as the second list for conferee's to consider as an automated synthesized work product.

As another simple example, a group of conferees may be using a common display screen in a conference space to generate a list of the top ten NFL quarterbacks of all time. Based on the beginning of the list and voice annunciations by conferees within the space, the server 790 may recognize the task that the conferees are performing and may, in addition to locating one or more top ten quarterback lists, search for criteria for measuring quarterback excellence as well as databases that rank quarterbacks based on each of the separate possible criteria. Then, the server 790 may synthesize a list of criteria that has quarterback rankings and present a list of criteria for the conferees to consider as well as to use as filters for identifying a best ten list.

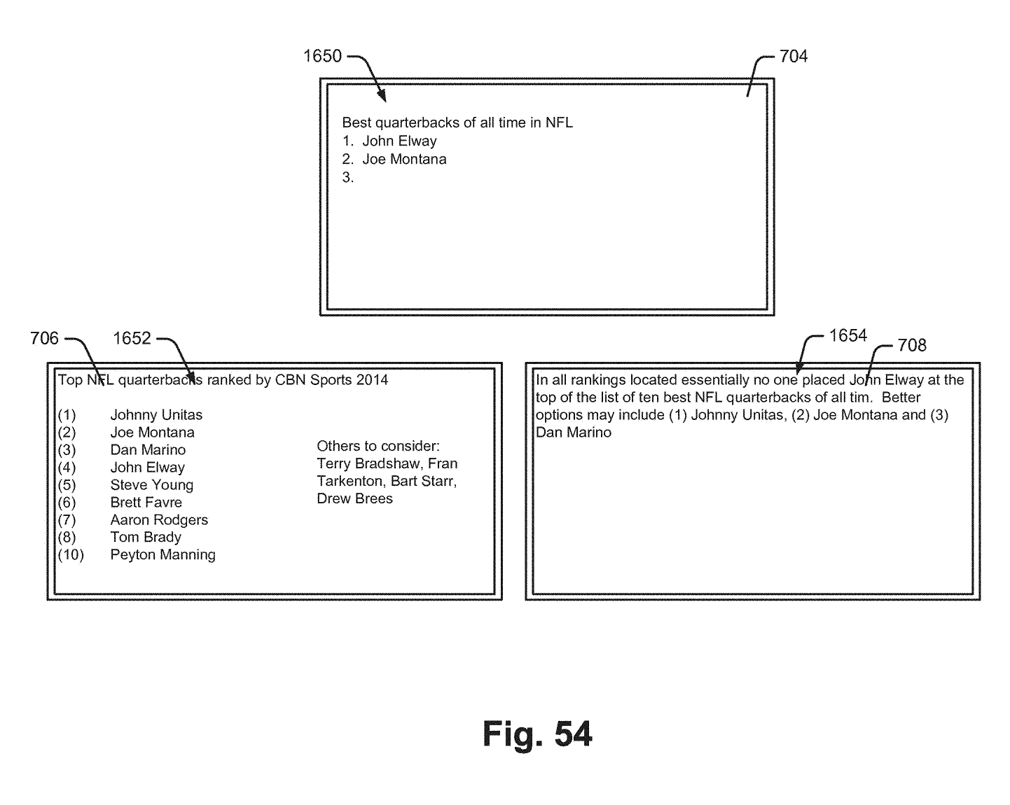

Consistent with the quarterbacks example above, see FIG. 54 where three large common display screens 704, 706 and 708 from a conference space are illustrated. On screen 704, a conferee is making a list 1650 of top ten NFL quarterbacks that may be used by server 790 to recognize the task that the conferees are performing. Based on the task, server 790 searches for a recent quarterback ranking and generates a ranking on screen 706 at 1652 from CBN Sports. In addition, server 790 may review a set of twenty recent lists and determine that John Elway, at the top of the conferee's list, is not at the top of any of the twenty lists identified. Based on this simple analysis, server 790 may formulate a message that indicates that Elway is not at the top of any published list located and present that synthesized feedback on screen 708 as shown at 1654. This is a very simple example of analysis and synthesis of a story to help conferees work through a task.

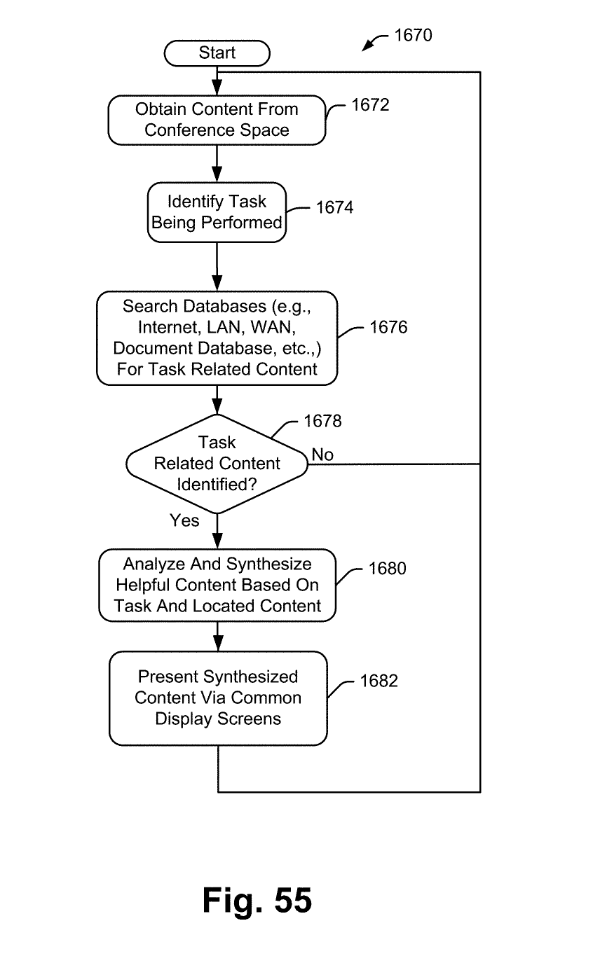

Referring now to FIG. 55, a process 1670 for analyzing space content and synthesizing a prospective story or content to help conferees work through a task is illustrated. At block 1672 server 790 obtains content from the conference space. At block 1674, server 790 analyzes the content from the space to attempt to identify a task being performed. Here, the server may run through many possible tasks based on content and assign a confidence factor to each one as additional content is generated in and obtained from the space that can be used to adjust the confidence factors until one or more factors are above some threshold indicating highly likely tasks that the team may be performing. Once at least one highly likely task is identified, at block 1676, server 1676 formulates one or more search queries to locate task related content.

At decision block 1678, server 790 analyzes returned content from the searches to identify any likely task related content that was identified. If task related content is identified, control passes to block 1680 where server 790 analyzes and synthesizes helpful content based on the task and the located content. At block 1680 the synthesized content is presented to the conferees.

The action of presenting content to conferees may be direct via the common display screens or there may be an intermediate step whereby synthesized content is independently and non-publically provided to one or more of the conferees to consider prior to presentation to the larger team. For instance, one conferee may be designated as a prospective story gate keeper to consider automated synthesized content prior to group consideration. In at least some cases which conferee receives synthesized content may be based on the personas of the conferees in a space. For instance, synthesized content may be presented to an anthropologist persona if that persona exists on a team.

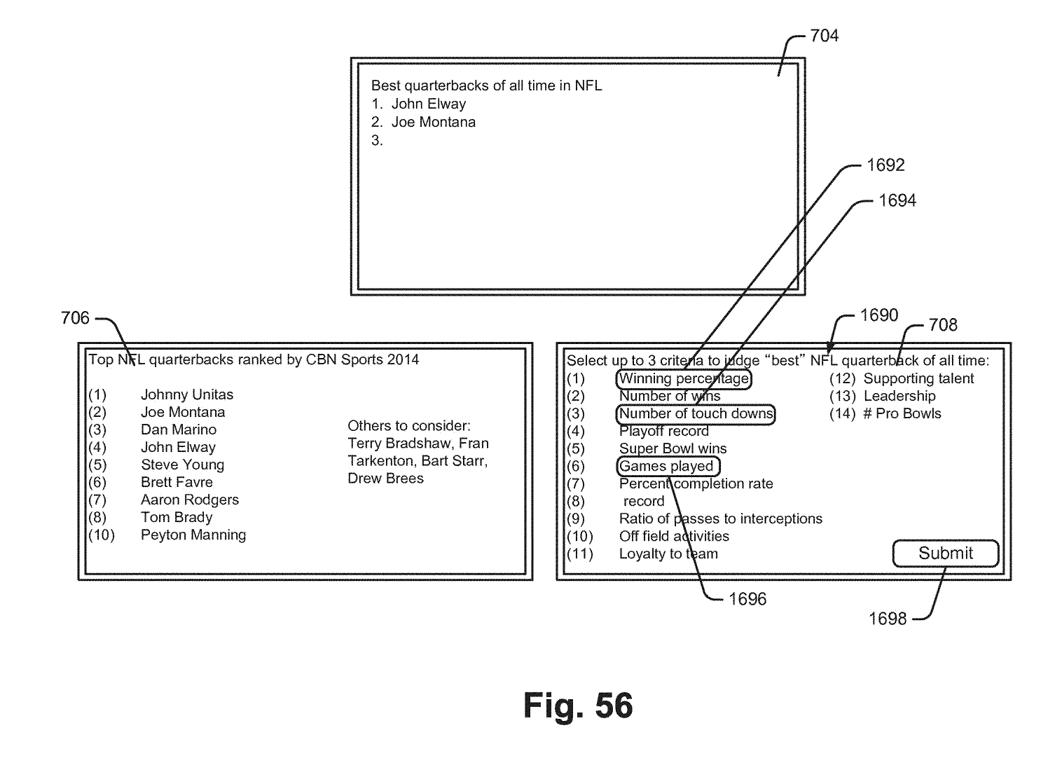

Referring now to FIG. 56, another exemplary set of common screens is shown where more complex synthesized content 1690 related to the top ten quarterback task is presented. Here, it is assumed that the server 790, recognizing the task of listing top ten NFL quarterbacks searches for lists and, upon examining the lists, recognizes that the lists are different. Many top ten lists of quarterbacks will prominently include a list of criteria used to generate the top ten list. Server 790 may access the criteria on each list and generate a combined list of criteria considered on all of the lists. Then, server 790 may search for statistics based on each of the criteria and reduce the size of the list based on which criteria have related statistics. The server 790 may then present the pared down list to the conferees and query the conferees for a subset of the list criteria on which to base a ranking of top quarterbacks. In this regard see the list at 1690 that includes 14 criteria that may be selected via touch or some other input device and where three of the criteria are highlighted to indicate selection at 1692, 1694 and 1696. Screen 708 also includes a “Submit” icon 1698 that can be selected to have the processor 790 use the highlighted selections as a filter to generate a top ten list.

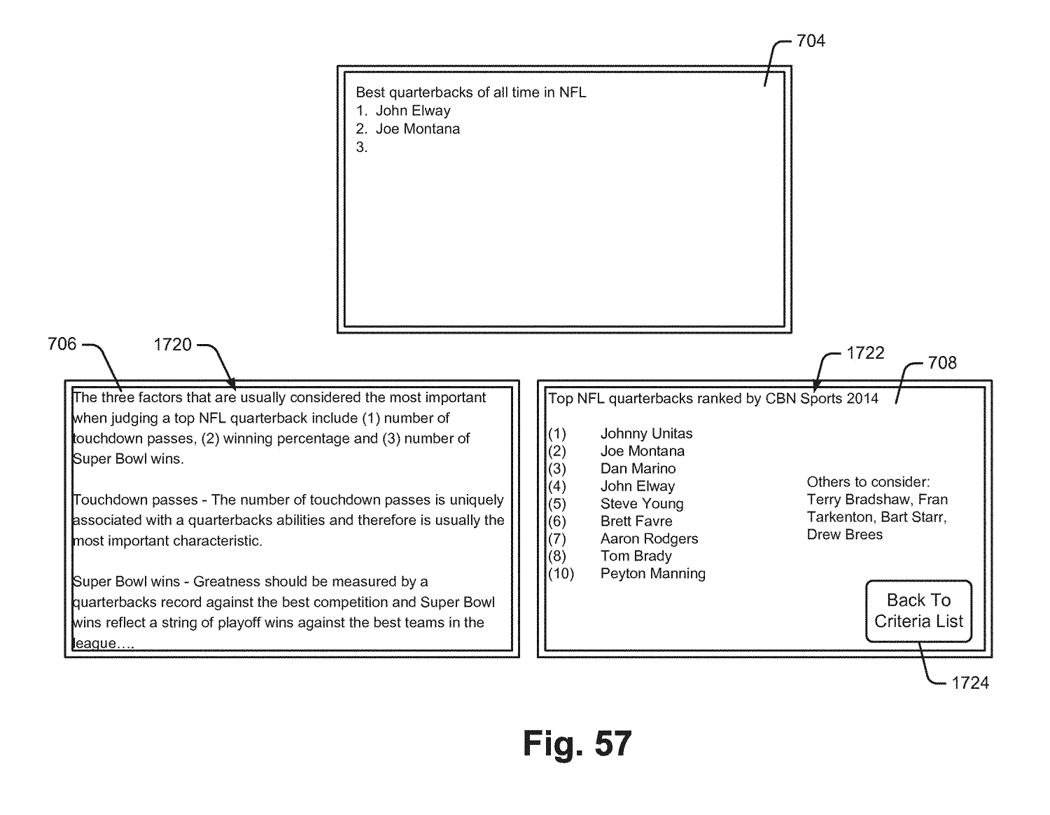

FIG. 57 shows common screens including a top ten list 1722 generated using the filter criteria selected in FIG. 56 on screen 708. In addition, server 790 may locate and present content on screen 706 that describes why the three filter criteria selected are important. This information 1720 may be obtained from a single source or obtained from multiple sources and synthesized by the server 790.

In at least some embodiments the session server may be programmed to recognize different activities occurring at different times during a session and to dial up or down the room as story teller activities. For instance, referring again to FIG. 52, during periods of divergence in thought (e.g., the wide portions of a histogram 1574), the server may automatically provide more content to conferees in session and during periods of convergent thought, the server may provide less content and less out of the box information to help guide conferees to reach a consensus about information being considered.

Thus, a more general process for synthesizing content based on the beginning of a list may include the following steps. First, identify that a list is being made. Second, determine, if possible, the topic associated with the list. Third, generate search queries for the topic and perform searches to generate other lists associated with the topic. Fourth, examine the lists to identify common elements and examine information associated with the list to identify criteria used to form the lists. Fifth, locate statistics associated with the criteria and use the statistics to pare down the criteria list. Sixth, present the criteria list to conferees as a set of filters that can be used to generate a final list. Seventh, apply conferee selected criteria to the statistics to generate a final list and present the final list to the conferees.

While the above process is simple, it is contemplated that other more complex synthesizing processes may be developed and used to program server 790. For instance, in some cases there may be ten or even 100 different processes supported by the server 790 for recognizing tasks being performed, obtaining information in addition to the information presented in a space that is related to the task and processing the other information and/or the information in the space to synthesize new content, new ways of considering existing content, etc.

While various interfaces for generating notes and other content are described above, others are also contemplated. For instance, a system may include microphones that can pick up voice annunciations by conferees within a space and that can associate voice annunciations with specific conferees in a space based on triangulation of the voice that generates an annunciation. Voice messages may be changed to digital text and placed on digital notes. For instance, a conferee may utter the phrase “Generate a note” followed by the phrase “This chart does not compare to the chart from last quarter” causing the server 790 to generate a digital note with the second phrase represented as text thereon. In at least some cases the new digital note would be added to a digital clip board for the conferee that uttered the phrases and generated the note. In other cases, if the conferee immediately approaches a location on a common screen, the system may track the conferee's location and automatically provide a highlighted or otherwise visually distinguished instance of the created note to be selected and moved to a final posting location by the conferee.

While embodiments have been described above where notes of predefined sizes are used with systems, other embodiments are contemplated where conferees can designate any size paper as a note where digital versions of the note can be generated using any note size. For instance, in at least some cases it is contemplated that a server 790 may be programmed to recognize content on a sheet of paper designating the paper as a new note size. For example, a conferee may write the word “Note Size” on an 8½ by 11 inch sheet of paper and gesture for one of the system cameras to take an image of the note and determine the dimensions of the new note. Thereafter, when an 8½ by 11 sheet of paper includes content and a conferee gestures to create a new note using the sheet, the system may image the note to create a digital version and add the new digital version to the conferee's clip board or present the new digital note on a common screen proximate the conferee for placement.

While the invention may be susceptible to various modifications and alternative forms, specific embodiments have been shown by way of example in the drawings and have been described in detail herein. However, it should be understood that the invention is not intended to be limited to the particular forms disclosed. Thus, the invention is to cover all modifications, equivalents, and alternatives falling within the spirit and scope of the invention as defined by the following appended claims.

To apprise the public of the scope of this invention, the following claims are made:

What is claimed is:

1. A system for providing guidance to collaboration participants in a plurality of collaboration spaces from a facilitator workspace, the system comprising:
a facilitator database storing characterizing rules for assessing one or more conditions of a collaborative activity;
a plurality of sensors associated with the corresponding plurality of collaboration spaces, each of the plurality of sensors configured to obtain information associated with the corresponding collaboration space that is indicative of the one or more conditions related to the collaborative activity performed within the collaborative space;
a display in the facilitator workspace;
a processor linked to the facilitator database, the plurality of sensors and the display, wherein the processor is programmed to:
obtain the information from the plurality of sensors;
access the characterizing rules;
compare the obtained information to the characterizing rules to assess the one or more conditions related to the collaborative activity in each of the collaborative workspaces; and
based on the comparison, providing a dashboard on the display in the facilitator workspace, the dashboard displaying a plurality of problems identified by the characterizing rules, the collaborative workspace corresponding to each identified problem, and characterizing information characterizing an acuteness of the identified problem.

2. The system of claim 1 wherein collaborative activity results in generation of digital content and wherein the characterizing rules relate to the quantity of digital content generated during the collaborative activity.

3. The system of claim 2 wherein at least one display screen is located within the collaboration space for developing digital content related to the collaborative activity, the monitor monitoring content presented via the display screen.

4. The system of claim 1 wherein collaborative activity results in verbal communication within the conference space and wherein the characterizing rules relate to the quantity of verbal communication generated during the collaborative activity.

5. The system of claim 1 wherein the collaborative activity includes a sequence of sub-processes, at least a subset of the sub-processes resulting in deliverable digital content storable in files of a collaborative activity folder, the monitor tracking information in the files to assess status of the collaborative activity.

6. The system of claim 1 further comprising a display screen located in the conference space.

7. The system of claim 6 wherein the processor indicates conditions via the display by providing a message to speed up the activity upon a determination that the activity progress has been slower than optimal.

8. The system of claim 6 wherein the facilitator database also stores a plurality of collaboration specifications designed to guide the collaborative activity at different points along a collaborative process, the processor further programmed to present collaboration specifications information at different times during the collaborative activity to direct activity progress.

9. The system of claim 8 wherein at least one of the facilitation content subsets is designed to be presented upon the occurrence of a specific problem condition assessed by the processor.

10. The system of claim 1 wherein the facilitator workspace is located at a site remote from the collaboration space.

11. The system of claim 10 wherein the display device comprises a computer interface used by a collaboration facilitator.

12. The system of claim 1 wherein the processor is programmed to present a summary report of the collaboration process via the display for consideration by the facilitator.

13. The system of claim 12 wherein the processor gathers the information obtained from the sensor and periodically generates the summary report of the collaboration process.

14. The system of claim 13 wherein the sensor comprises at least one camera and at least one microphone located in the collaboration space, and wherein the processor is further programmed to enable the facilitator to observe and listen to the collaboration activity.

15. The system of claim 1, wherein the problems identified on the dashboard include at least one of an unaddressed perceived condition, an unresolved automatically addressed condition, and an unresolved facilitator addressed condition

16. The system of claim 15 wherein the dashboard comprises three separate sections, the three sections corresponding to the identified unaddressed perceived condition, the unresolved automatically addressed condition, and the unresolved facilitator addressed condition.

17. A system for providing guidance to collaboration participants in collaborative spaces, the system comprising:
a facilitator database storing characterizing rules for assessing success of collaborative activities;
a plurality of sensors, at least one sensor associated with each of the collaborative spaces, each sensor configured to obtain information associated with an associated collaborative space that is indicative of progress related to a collaborative activity performed within the collaborative space;
at least one computer interface and a corresponding display located outside the collaborative space for use by a collaboration facilitator; and
a processor linked to the facilitator database, the sensors and the at least one computer interface, the processor programmed to:
obtain information from each of the sensors;
access the characterizing rules;
compare the obtained information to the characterizing rules to assess progress related to each of the collaborative activities; and
based on the comparison, provide activity status information to the collaboration facilitator on the display via the computer interface.

18. The system of claim 17 wherein the activity status information is periodically updated for each of the collaborative spaces.

19. The system of claim 18 wherein the processor ranks simultaneous collaborative activities according to assessed progress and presents the ranking information via the computer interface.
